(19) United States
(12) Patent Application Publication
(10) Pub. No.: US 2012/0309415 A1
(43) Pub. Date: Dec. 6, 2012

(54) MULTIPATH COMPENSATION WITHIN GEOLOCATION OF MOBILE DEVICES

(75) Inventor: Geoffrey B. Rhoads, West Linn, OR (US)

(73) Assignee: ZULUTIME, LLC, Wilsonville, OR (US)

(21) Appl. No.: 13/187,723

(22) Filed: Jul. 21, 2011

Related U.S. Application Data
(60) Provisional application No. 61/366,413, filed on Jul. 21, 2010.

(51) Int. Cl. H04W 64/00; H04W 24/00

(52) U.S. Cl. 455/456.1; 455/501

(57) ABSTRACT

A location of a mobile device within a network is determined. The network includes a plurality of fixed nodes. A method includes receiving, at the plurality of fixed nodes, receive messages transmitted from the mobile communication device. Each of the plurality of fixed nodes generates a receive count stamp for each receive message corresponding to a local counter value at the receipt of the receive message. At each of the plurality of fixed nodes, the method includes processing the receive count stamps to calculate a set of pseudo-ranges between the respective fixed node and the mobile device, and measuring multipath delay included within the set of pseudo-ranges. Based on the measurement, the multipath delay is removed from the set of pseudo-ranges to determine a range estimate between the mobile device and each of the fixed nodes. Based on the range estimates, a location of the mobile device is calculated.

### RELATED APPLICATION

This application claims the benefit under 35 U.S.C. §119(e) of U.S. Provisional Application No. 61/366,413, filed Jul. 21, 2010, which is hereby incorporated by reference herein in its entirety.

### TECHNICAL FIELD

This disclosure is related to object positioning systems. More particularly, this disclosure is related to compensating for multiple signal paths in an object positioning system.

### BACKGROUND INFORMATION

GPS-based geolocation as well as almost all forms of ranging and pseudo-ranging instrumentation are designed around the concept of “line-of-sight”, itself relying on the constant speed of light being used as a yardstick. One well-known error source to this approach has largely been summed up in the term “multi-path”, referring to the notion that a signal transmitted from one device and received by another can follow more than one path. This gives rise to errors in ranging. A variety of methods and instrumentation have been designed to explicitly mitigate this error source. Those persons practiced in this general art are well aware that the situation is much more complicated than the term multi-path implies. Indeed, an ideal electromagnetic (EM) pulse sent by one device will be received by a second device as an omnipath environmental response function, represented as the function at the bottom of FIG. 1. The first non-zero point-in-time of the environmental response function is usually based on the line-of-sight, provided there are no obstructions between sender and receiver. FIGS. 2, 3 and 4 quickly summarize a good line-of-sight pair, a classic two-path pair that many global positioning system (GPS) receivers deal with due to ground bounce, and an obstructed and echo-rich pair, respectively.

### SUMMARY OF THE DISCLOSURE

This disclosure outlines instrumentation and data processing approaches to measure and mitigate various classes of omnipath situations in network.

In one embodiment, systems and methods determine a location of a mobile device in a network. The network includes a plurality of fixed nodes. A method includes receiving, at the plurality of fixed nodes, receive messages transmitted from the mobile communication device. Each of the plurality of fixed nodes generates a receive count stamp for each receive message corresponding to a local counter value at the receipt of the receive message. At each of the plurality of fixed nodes, the method includes processing the receive count stamps to calculate a set of pseudo-ranges between the respective fixed node and the mobile device, and measuring multipath delay included within the set of pseudo-ranges. Based on the measurement, the multipath delay is removed from the set of pseudo-ranges to determine a range estimate between the mobile device and each of the fixed nodes. Based on the range estimates, a location of the mobile device is calculated.

In certain embodiments, the method further includes sending and receiving messages between the plurality of fixed nodes. Each of the fixed nodes generates local receive count stamps based on the messages received from the other fixed nodes.

In one embodiment, a method for multipath mitigation and evaluation within a network comprising a plurality of nodes includes receiving, at a plurality of first nodes, receive messages transmitted from a second node. Each of the plurality of first nodes generates a receive count stamp for each receive message corresponding to a local counter value at the receipt of the receive message. The method also includes processing the receive count stamps to determine range errors in at least one of an x-axis direction, a y-axis direction, and a z-axis direction with respect to a distance between at least one of the first nodes and the second node.

Additional aspects and advantages will be apparent from the following detailed description of preferred embodiments, which proceeds with reference to the accompanying drawings.

### BRIEF DESCRIPTION OF THE DRAWINGS

FIG. 1 is a schematic diagram graphically illustrating a radio frequency (RF) pulse transmitted by a transmitter (TX) and received by a receiver (RX) and a corresponding impulse function of the RF pulse.

FIG. 2 is a schematic diagram graphically illustrating a line-of-sight pair (TX and RX) and a corresponding impulse function of an RF pulse.

FIG. 3 is a schematic diagram graphically illustrating a classic two-path pair (TX and RX) including ground bounce and a corresponding impulse function of an RF pulse.

FIG. 4 is a schematic diagram graphically illustrating an obstructed and echo-rich pair (TX and RX) and a corresponding impulse function of an RF pulse.

FIG. 5 is a schematic diagram graphically illustrating that impulse power can come from everywhere in an environment, including some forms of attenuation on the line-of-sight path.

FIG. 6 is a schematic diagram graphically illustrating a situation where the broadcast impulse is replaced with a carrier frequency, and even more specifically to a very short symbol-modulation of that carrier frequency.

FIG. 7 is a schematic diagram graphically illustrating the basic notion shown in FIG. 5 that “signals bounce from everywhere,” and also illustrates a number of discrete scattering elements referred to herein as “speckly bits.”

FIG. 8 is a schematic diagram graphically illustrating FIG. 7 with overlays corresponding to omnipath analysis according to certain embodiments.

FIG. 9 is a schematic diagram graphically illustrating a power level value at a time point los+d and how it can be objectively measured as summation of components in terms of a single RF re-direction according to one embodiment.

FIG. 10 is a schematic diagram graphically illustrating an integral formula that provides a simple spatial integration formulation according to certain embodiments.

FIG. 11 is a schematic diagram graphically illustrating analysis that includes environmental and reflectance delays according to certain embodiments.

FIG. 12 is a schematic diagram graphically illustrating multiple bounces between a transmitter and a receiver.

FIG. 13 is a schematic diagram graphically illustrating analysis of the multiple bounces shown in FIG. 12 according to certain embodiments.

FIG. 14 is a schematic diagram graphically illustrating a simplified version of a double-bounce environmental integration model according to certain embodiments.

FIG. 15 is a schematic diagram graphically illustrating a random five-bounce example in a five-bounce two-dimensional universe according to certain embodiments.

FIG. 16 is a schematic diagram graphically illustrating an infinite-bounce, all-path model according to certain embodiments.

FIG. 17 is a schematic diagram graphically illustrating a curved path analysis according to certain embodiments.

FIG. 18 is a schematic diagram graphically illustrating a full integration model behind the impulse response function shown in FIG. 1 according to one embodiment.

FIG. 19 is a schematic diagram graphically illustrating a full three-bounce integration in a two-dimensional universe according to certain embodiments.

FIG. 20 is a schematic diagram graphically illustrating an example single-bounce analysis in three dimensions according to certain embodiments.

FIG. 21 is a schematic diagram graphically illustrating a general three-dimensional n-bounce integration formula according to one embodiment.

FIG. 22 is a schematic diagram graphically illustrating a dynamic network schematic viewpoint for analyzing omnipath solutions according to certain embodiments.

FIG. 23 is a schematic diagram graphically illustrating dynamic knowns, partially knowns, and unknowns for the example in FIG. 22 according to certain embodiments.

FIG. 24 is a schematic diagram graphically illustrating timing analysis according to certain embodiments.

FIG. 25 is a schematic diagram graphically illustrating a first-pass Zulutime-based multi-path problem formulation according to certain embodiments.

FIG. 26 is a schematic diagram graphically illustrating harmonic block organization of unknowns according to certain embodiments.

FIG. 27 is a schematic diagram graphically illustrating coarse direction vectors of detailed implementation algorithms according to certain embodiments.

FIG. 28 is a schematic diagram graphically illustrating a first-pass Zulutime solution according to certain embodiments.

FIG. 29 illustrates graphs of relative correlation value vs. relative propagation delay for GPS using a 2 MHz bandwidth for an in-phase secondary path.

FIG. 30 illustrates graphs of relative correlation value vs. relative propagation delay for GPS using a 2 MHz bandwidth for an out-of-phase secondary path.

FIG. 31 illustrates graphs of relative correlation value vs. relative propagation delay for GPS using an 8 MHz bandwidth.

FIG. 32 illustrates various waveforms corresponding to GPS applications.

FIG. 33 illustrates graphs of C/A code range error vs. multipath delay for certain GPS applications.

FIG. 34 illustrates waveforms that provide visualization of signal compression.

FIG. 35 illustrates waveforms for a first portion of a leading edge of a received pulse, as well as its first and second derivatives.

FIG. 36 is a schematic diagram graphically illustrating pseudo-ranging in the presence of omnipath distortion and an omnipath extension (OE) according to certain embodiments.

FIG. 37 is a schematic diagram graphically illustrating a mobile node receiving a plurality of pseudo-range estimates based on other nodes according to certain embodiments.

FIG. 38 is a schematic diagram graphically illustrating creation of fixed-node known omnipath delay maps according to certain embodiments.

FIG. 39 is a schematic diagram graphically illustrating a way to view a resulting delay map for node H according to certain embodiments.

FIG. 40 is a schematic diagram graphically illustrating basic notions and context for lower bound clumping according to certain embodiments.

FIG. 41 is a schematic diagram graphically illustrating analysis in a harsh omnipath environment with additional fixed nodes according to certain embodiments.

FIG. 42 is a schematic diagram graphically illustrating analysis of three basic types of delay encountered in arbitrary networks according to certain embodiments.

FIG. 43 is a schematic diagram graphically illustrating an over-simplified view of how pseudo-range lines can determine a correct positional solution even in the presence of modest omnipath distortion according to certain embodiments.

FIG. 44 is a schematic diagram graphically illustrating utilizing node-motion measurements alongside range-clumping methods according to certain embodiments.

FIG. 45 is a schematic diagram graphically illustrating automatic generation of delay maps for new fixed nodes according to certain embodiments.

FIG. 46 is a schematic diagram graphically illustrating analysis of omnipath-induced delay symmetries and asymmetries according to certain embodiments.

FIG. 47 is a schematic diagram graphically illustrating other embodiments of range-value based omnipath distortion mitigation.

FIG. 48 illustrates graphs of residual error and average residual error used according to certain embodiments.

FIG. 49 is a schematic diagram graphically illustrating two consecutive mobile position estimates for a multipath example according to certain embodiments.

FIG. 50 is a schematic diagram illustrating an example embodiment within a medium sized shopping store.

FIG. 51 is a schematic diagram illustrating effectively the same store layout as that shown in FIG. 50, but with a total of 30 additional WiFi devices strewn throughout the store.

FIG. 52 is a schematic diagram illustrating the shopping store of FIG. 51 with a newly introduced mobile WiFi device somewhere near the entrance of the store.

FIG. 53 is a schematic diagram illustrating a packet transmitted from newly introduced mobile WiFi device 308 shown in FIG. 52 according to one embodiment.

FIG. 54 is a schematic diagram illustrating a more typical but more complicated situation, according to certain embodiments, where there are now dozens of mobile devices in the store all transmitting packets every now and then.

FIG. 55 is a schematic diagram illustrating three instances in time of a single mobile device as it moves among different areas of the store according to one embodiment.

FIG. 56 is a schematic diagram illustrating an advanced variant, according to one embodiment, on the baseline description for the examples shown in FIGS. 50, 51, 52, 53, 54, and 55.

### DETAILED DESCRIPTION OF PREFERRED EMBODIMENTS

This disclosure outlines instrumentation and data processing approaches that measure and mitigate various classes of omnipath situations in highly generalized network situations. A “mantra” of this disclosure is “first and foremost, get the clocks right.” Through a greatly improved approach to monitoring clock deviations, a new suite of ongoing measurements and models become operable to better tackle multi-path situations of many kinds. Pseudo-range network consistency (static, dynamic and both) as well as “delay maps” are used in this suite of approaches. Advanced approaches then break down into “code ping” versus “RF waveform” approaches, where the former uses countstamp (timestamp) data derived from post-decoded RF signals, while the latter can dig down into the RF waveforms themselves. In certain embodiments, ongoing software structures and loop instructions are constantly assessing the forms of omnipath being encountered and adjusting algorithmic processing accordingly. One under-the-hood component to the structures are what has been dubbed “Riccian-Rayleigh-Quality” Tables, which keep track of all communication links in a group-solution network and qualify each in terms of its general omnipath characteristics. The end result is greatly improved location-determination even in very complicated EM environments, along with ongoing estimations of residual errors.

Aspects of certain embodiments are described in (referred to collectively herein as the “related disclosures” or the “companion disclosures”) U.S. Pat. No. 7,876,266, titled “Harmonic Block Technique for Computing Space-Time Solutions for Communication System Network Nodes,” issued Jan. 25, 2011 to Geoffrey Rhoads, U.S. Pat. No. 7,983,185, titled “Systems and Methods for Space-Time Determinations with Reduced Network Traffic,” issued Jul. 19, 2011 to Geoffrey Rhoads et al., U.S. Patent Application Publication No. 2009/0213828, titled “Wireless Local Area Network-Based Position Locating Systems and Methods,” filed Apr. 23, 2009 by Trent J. Brundage et al., U.S. Patent Application Publication No. 2009/0233621, titled “Systems and Methods for Locating a Mobile Device within a Cellular System,” filed Apr. 20, 2009 by Geoffrey B. Rhoads et al., and U.S. patent application Ser. No. 13/179,807, titled “Location Aware Intelligent Transportation Systems,” filed Jul. 11, 2011 by Geoffrey B. Rhoads, each of which is assigned to the assignee of the present application and is hereby incorporated by reference herein in its entirety for all purposes.

This disclosure outlines a family of specific instrumentation and software approaches to the detection of, and subsequent mitigation of, multi-path errors in timing and positioning networks. An aspect of the disclosed embodiments includes splitting the basic problem into two parts (at least as one embodiment and not as a requirement)—by isolating clock error and device delay correction as a more tractable first stage set of procedures, giving rise to a second set of procedures offering a cleaner and more geometric-oriented attack on multipath mitigation itself. Such embodiments provide an efficient long term framework for tackling multipath in highly complicated and mobile applications.

A series of figures attempts to metaphorically encapsulate this basic philosophy while the accompanying text explains the details of its implementation.

The disclosure is organized by having the first few sections give a general summary and deep framework of the problem. A variety of specific approaches are then described, including how these approaches can inter-operate. RRQ (Riccian-Rayleigh-Quality) Tables are then discussed, in parallel to similar descriptions in the related disclosures but here targeting multipath in particular. The disclosure then explores the generic multipath mitigation that this systematic framework-based approach can produce.

One conclusion derivable from the early sections which generalize multipath, and which certainly any practitioner in the multipath art may concur with, is that multipath is generally not something which can be “solved.” Typically, the best designers can do would be to beat down its distorting influences such that instrumentation will meet their empirical positioning performance specifications “almost all of the time,” or at least within some specific prescription of the extent of innate multipath distortions. Furthermore, for those times where multipath may be so severe that an instrument's position estimations do wander outside its stated specifications, the instrument should be smart enough to know so. Another way to put this might be: for the operational situation where, say, a person holding a wireless device walks from a city street deep inside an urban core, through a revolving door and into a complicated interior space, and company X claims they have “solved” multipath and fully eliminated its effects for this most general of situations—throw them out the door. What can be solved, however, is providing a stable implementation framework for mitigating many if not most or all forms of multipath. Cocktails of mitigation methods can be placed within this framework, instrumentation outfitted with such, and then ever-evolving empirical testing programs can iterate on what new plateaus the latest cocktails have achieved, leading inevitably to tweaking the cocktail ingredients or adding new ones. The existence of the cocktail glass itself, with a few promising classic drinks inside, is what certain disclosed embodiment are all about.

Background on “Multipath” and Relationship to this Disclosure

The commonly used term “multipath” is a convenient over-simplification of a very complicated general situation. Its use pre-dates GPS but its popular emergence certainly coincided with the growth in the GPS, where most basic textbooks technically describing the GPS give this issue a prominent role in the analysis of the common errors in timing and location determination. Many individuals, companies and universities have developed a variety of instrumentation and software approaches to measuring and mitigating the errors associated with multipath.

This disclosure largely focuses on the kinds of multi-path applicable to a network of mobile devices in constant communication with each other, as opposed to instruments that essentially listen for satellite signals or fixed pseudolite signals. Deep inside “urban canyons”, and certainly inside buildings or tunnels, become the locations for the headliner applications that see a great deal of multipath errors requiring redress.

A distinction of this disclosure from prior systems is that even prior to applying specific multipath methods, software structures need to be created that constantly monitor and adapt to ever-changing network configurations and environmental conditions between communicating nodes in the network. These new structures may often be tied to the word “framework,” where one general idea is that once such a framework is defined and enabled, itself already mitigating difficult error sources associated with clock errors and device delays, then many of these past fine examples of specific multipath mitigation can potentially be “plugged in” to that framework, and thereby enhance the overall resiliency of an instrument to multipath effects. Implementers would be free to pick and choose specific “real world hardened” components from existing GPS instrumentation, whilst following standard commercial practices of licensing and/or attribution for such. This disclosure highlights implementation details for how such clear prior methods might be so plugged in.

Omnipath: Generalizing Multipath for Arbitrary Networks

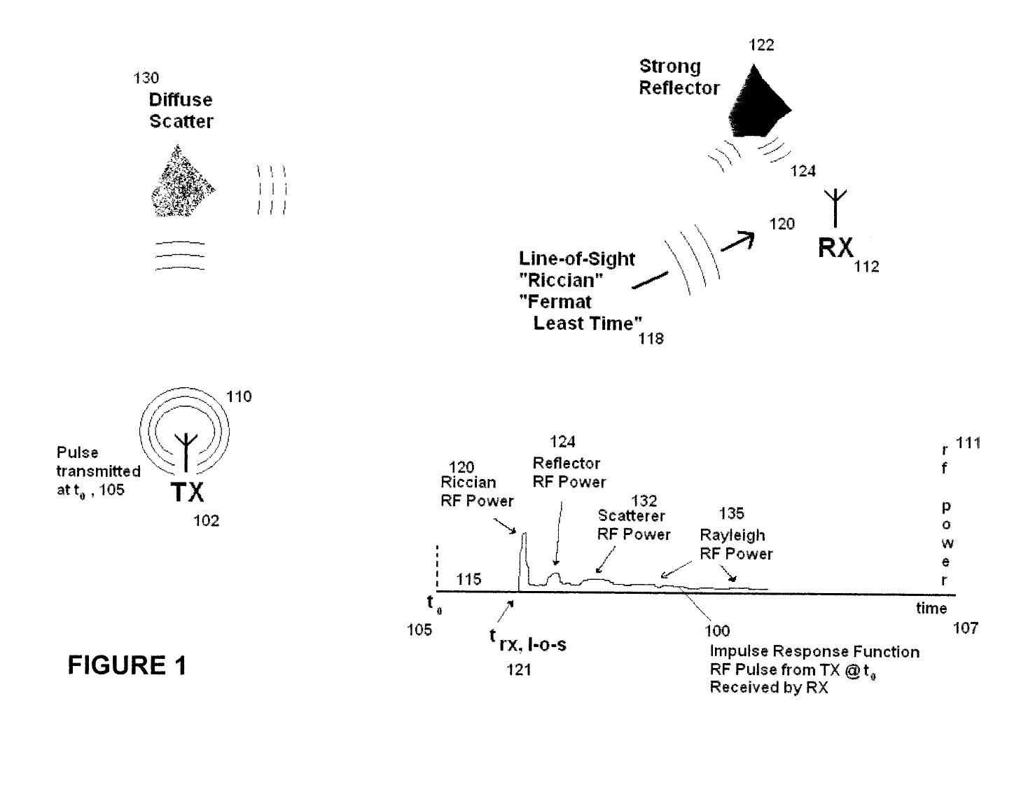

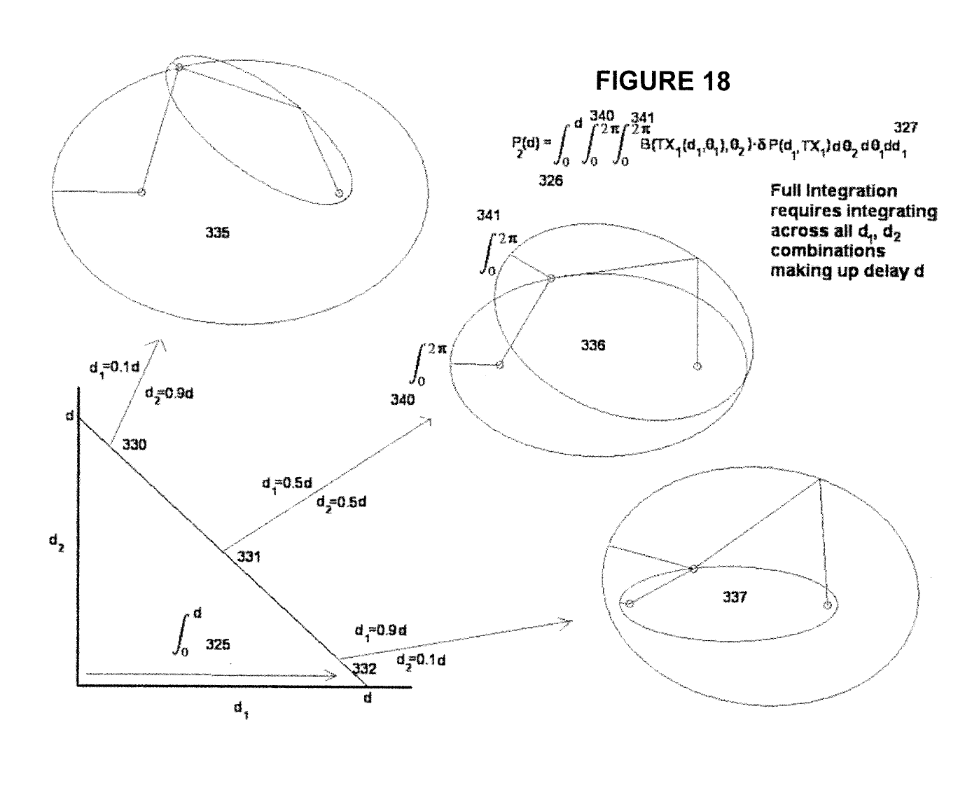

FIG. 1 in conjunction with FIG. 18 graphically summarizes how multipath generalizes to an omnipath definition. The impulse response function 100, graphically depicted on the bottom of FIG. 1 is composed of quite complicated multi-bounce elliptical integrations of the “instantaneous” environment between a transmitter TX 102 and a receiver RX 112, where FIG. 18 has a two dimensional, “only two bounces”—and grossly oversimplified—graphic view of these integrations. Figures leading up to FIG. 18, and following FIG. 18, along with textual descriptions, attempt to parse out this introductory oversimplification.

One of the points of the rather lengthy exploration of omnipath herein is to help understand the extent of the requirements that may be placed upon any arbitrary network hoping to generically deal with multipath mitigation. This exploration will have ancillary tutorial benefits and will also lead nicely toward both the generation of specific multipath mitigation techniques as well as a back-end analysis viewpoint on why and how all specific techniques reach certain limitations in effectiveness as a function of network dynamics within ever more complicated environments (where the environments themselves become ever more dynamic).

Indeed, analysis in its formal mathematical sense is also the point here. Getting one's arms around both the theoretical as well as the applied aspects of both integration and differentiation can be argued as a justifiable end in itself. The integration operation is ultimately the more tractable side of the applied problem conceptually; though taken to its extreme, it becomes a run-away computational problem. In certain embodiments, the differentiation operation may be the more useful, however. The simple reason for this distinction is that the very application of all of this to “dynamic networks” highlights the data processing role of “changes” in collected data characteristics, which is virtually the definition of “differentiation.” Of thousands of potential exemplar applications here, one can imagine a person with a personal digital assistant (PDA) device rounding a corner in a building and a previously established reflective channel which was not line-of-sight instantly changes to a highly dominant line-of-sight condition. These channel characteristics and the multipath mitigation techniques aimed at addressing them are fundamentally derivative-based phenomena from a data collection standpoint (where one is given, say, the last five seconds of collected data and no external knowledge, and ones job is to mitigate the multipath effects).

The approach taken, according to certain embodiments, starts simply by positing a perfect electromagnetic impulse that emanates from a transmitter to a receiver, as opposed to the long tradition of positing an oscillator driving a transmission. The discussion will eventually get back to oscillatory transmission models and its clear relationship to Feynman all-path integration. In certain embodiments, the impulse model may be more fundamental than the oscillation model from an applied point of view, and besides, a sinusoidal sequence of impulses can easily derive the latter model including a symbol modulated sinusoidal sequence resembling any communication method can likewise be derived from the purely impulse model.

The following discussion explores both the integration and differentiation operations based on the impulse model, always with an eye toward applying them to dynamic networks. As stated, this may also imply a requirements overlay on software structures and data-sharing protocols for any framework hoping to provide a long term infrastructure for evolving the multipath mitigation art.

Omnipath Analysis

Turning back to FIG. 1, the impulse response function 100 is conceptually sketched in the lower part of FIG. 1. A sequence of events over time is graphically depicted above the function, where we now step through these events.

The transmitting node TX 102 emits a delta-function EM pulse at some time t-naught (t₀). This emitting of the pulse is labeled 105, where 105 is found in two locations in FIG. 1, once where it points out the emission of the pulse from TX and the other time showing that it becomes the origin of the time axis 107 of the impulse function 100. Physicist and other readers will recognize that an ideal EM impulse is not truly obtainable in practice, it necessarily giving rise to all frequencies in the electromagnetic spectrum if it were possible. This disclosure has numerous junctures where it discusses the application of all of this analysis to common constrained bandwidth carrier frequency regions and the unique material reflection and refraction properties of those regions.

The three near-full circles 110 surrounding TX 102 simply indicate that the energy from the pulse emanates uniformly in all directions (if it were indeed an impulse, this would dictate only a single circle). This broadcasting of the pulse power would be in all three dimensions, of course.

Due to the speed of light, the impulse response function 100, representing received power 111 by RX 112 registers a zero value over the period of time it takes light to travel from TX to RX, where this zero received power is labeled 115. FIG. 1 includes the letters “rf,” the historic acronym for “radio frequency,” but clearly this disclosure and this very discussion applies to any and all electromagnetic waves (and impulses). The “rf” could easily have been “EM” for that matter.

Label 118 in FIG. 1 indicates that various science and engineering arts have many different ways to conceive of this power being directly transmitted between TX and RX, with the phrase “line-of-sight” (also referred to herein as “l-o-s” or “los”) being very common and intuitive. The word “Riccian” is also commonly used by the communications industry, where one or more of the related disclosures delves into this usage a bit more completely. “Fermat least path” harkens back to some original work in the study of light in particular. A little digging will find yet more ways to refer to this direct path notion of light (or an EM pulse in our case) traveling conceptually along a straight line from one point to another.

Label 120 attempts to point out the instance in time when RX first receives the rf power of the pulse. It too is doubly presented both in the graphics and in the function. Conceptual representation allows for giving this impulse a small amount of breadth in time rather than being a pure spike (Dirac) impulse in the function. This disclosure is aimed at implementing various approaches to mitigating multipath in real instrumentation, and real instrumentation does not have pure Dirac delta functions as received signals. Label 121 indicates that there is some particular instance in time, tᵣₓ, l-o-s, where the first measurable rf power is received and the period in time labeled 115 ends. All “ideal” and classic notions of “ranging” key in on this particular instant in time. This point in time of the function, multiplied by the speed of light, ideally delivers the distance between TX and RX. This provides “EM ranging.”

Label 122 introduces a new object into the TX-RX world. The notion with object 122 is that it represents some “strong reflector” that redirects the energy of the pulse toward RX. This may, for example, be a simple mirror for the case of a light impulse. The notional moment in time when this energy is received by RX is labeled 124. Its received power is also noticeably lower than the line-of-sight received power, as a general matter. Two primary components of this power reduction is the square-law of EM power reduction as a function of distance, and the common reflective dissipation introduced during normal reflections.

Label 130 introduces another new object which is qualitatively different from object 122. The notion here is that it is not always clean reflective objects that redirect energy toward RX but also extended objects as well, and that the redirection of energy itself can be rather weak and barely measureable. Both objects 122 and 130 are very high level summaries and the more general case of all objects will be discussed further on. Label 132 is singly represented in FIG. 1 on the function. Here we find a broader lifting of the rf received power values and at a later time than the line-of-sight peak 120 and the strong reflector peak 124 where this broader peak 132 is hypothetically coming from the weak, diffuse reflector 130.

Label 135 in FIG. 1 includes the phrase “Rayleigh RF Power.” “Rayleigh” both refers to its use in the communications industry as well as harkening back to the studies of the man himself. The basic idea is that the world is composed of (primarily) gaseous molecules as well as larger species of all manner of particulate matter. All of these bits of matter redirect some very small amount of energy toward RX, where their overall accumulation is represented as a non-zero power value in the function.

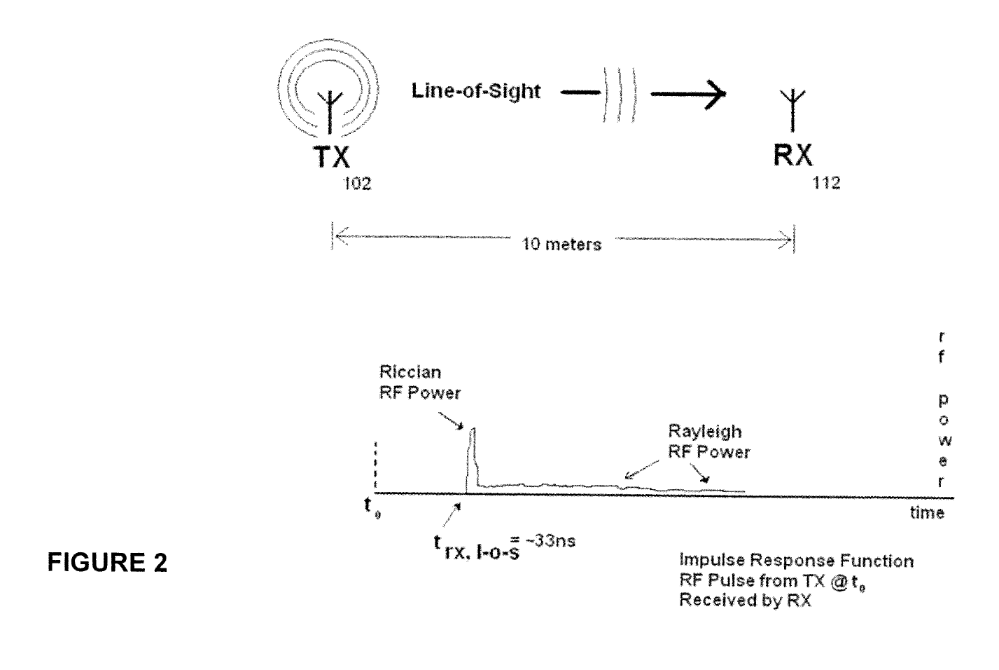

FIG. 2 isolates the ideal line-of-sight situation. A simple physical example is depicted, where a 10 meter physical distance between TX and RX produces a 33 nanosecond delay in initiation of the power received at RX.

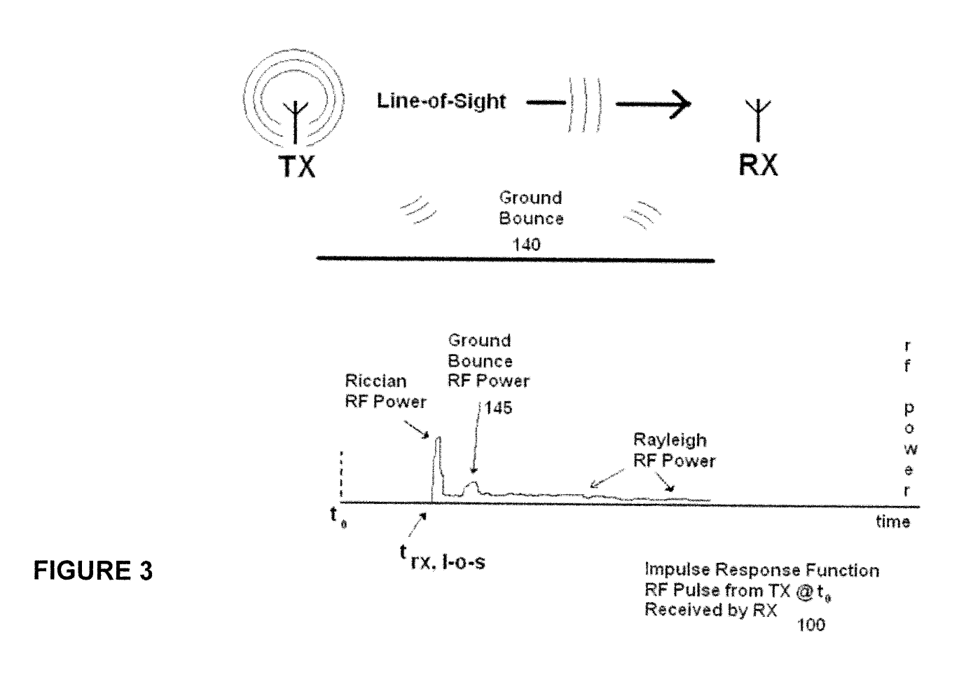

FIG. 3 introduces what might be the most commonly studied type of multipath in the GPS industry: “ground bounce” 140. Also depicted in FIG. 3 is a slightly delayed hump 145 of received signal power in the impulse response function. The ground bounce power is depicted as lower than the line-of-sight power as the general case but not the only case. It can be appreciated that when the transmitter switches from broadcasting impulses to instead broadcasting over a common sinusoidal carrier frequency, then this single bounce produces a delayed and phase shifted version of the sinusoid (and any modulation of the sinusoid by an encoded signal). Later we will dive in much more deeply on the use of sinusoidal carrier frequencies at the transmitter. In this carrier frequency case, the term “fading” has been used in the communication industry to describe what is effectively an integration of the impulse response function 100 where each point in time on the function is a phase-shifted version of the transmitted sinusoid having the power associated with its function value, and the received synthesized signal is the result of the integration across all points in time. One of the larger challenges with multipath can be seen in the carrier frequency situation. Therefore, where even a small amount of ground bounce as well as general Rayleigh scattering cause unavoidable phase shifting of the received carrier signal, relative to the ideal line-of-sight condition without an atmosphere (e.g., substantially no Rayleigh scatter). Another way to put this is, even though the line-of-sight path may dominate in terms of total power received, even a small amount of omnipath-delayed power shifts the phase of a carrier wave in non-trivial ways, hence introducing measurable omnipath delays.

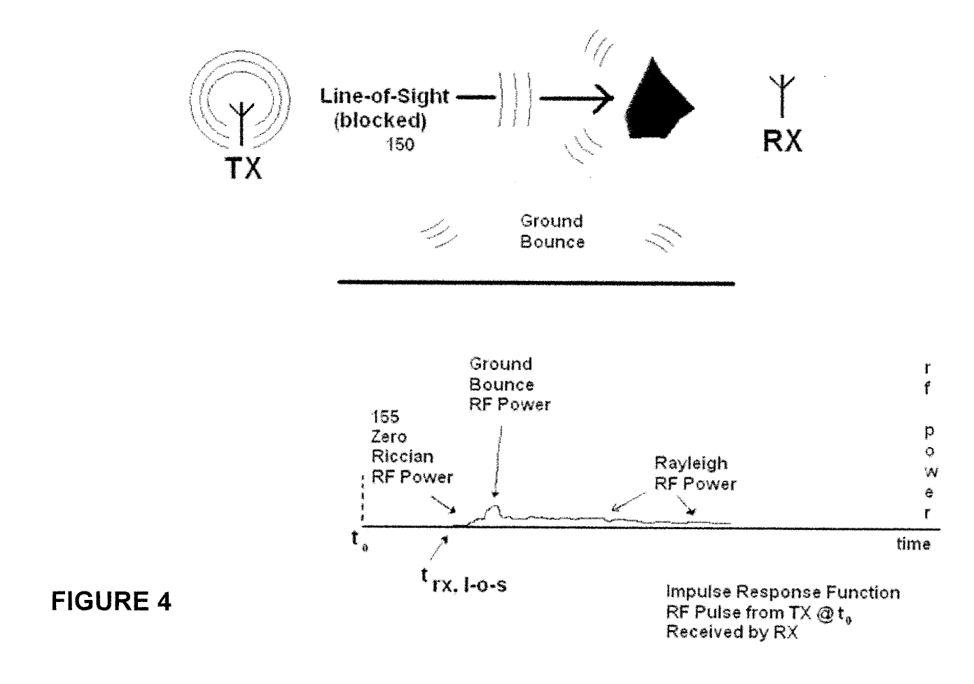

FIG. 4 depicts an arbitrary version of another common situation, where the direct line-of-sight is blocked 150, and the only power received by RX is re-directed power, where in this example most of the power is coming from ground bounce discussed surrounding FIG. 3. FIG. 4 also makes explicit the notion that no power is being received at what should have been the line-of-sight arrival time, labeled together as 155.

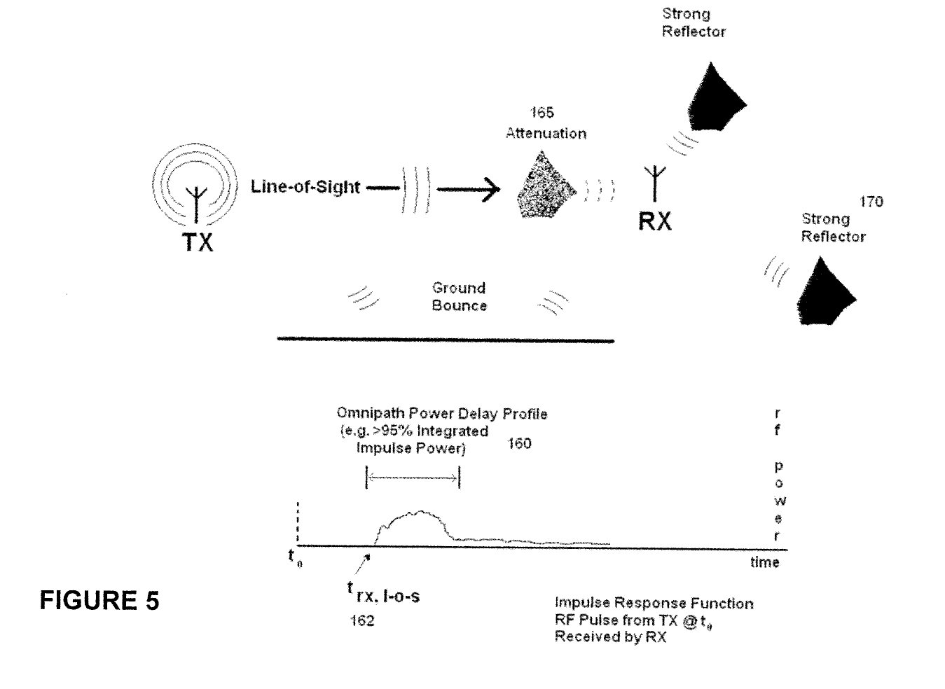

FIG. 5 is a largely conceptual graphic simply attempting to illustrate that impulse power can come from everywhere in an environment, including some forms of attenuation on the line-of-sight path 165. Effectively arbitrary accumulated power points can be defined whereby some percentage of the total received power from an impulse has been received, e.g., in FIG. 5 we chose 95% as that arbitrary point in time, labeled 160. For urban or indoor situations, this point in time can fairly easily be up to 10 or 20 nanoseconds or even longer between the onset of power reception, tᵣₓ₋ₗ₋ₒ₋ₛ, 162, to the 95% point. The strong reflector labeled 170 is typical of something that might be five or ten meters behind a receiver RX and still contributing meaningful amounts of re-directed power to RX. Specific applications may wish to consider their own unique time durations based on typical environments expected. The word “omnipath” is explicitly introduced in FIG. 5 as well, in a deliberate attempt to separate more straightforward approaches to multipath mitigation such as the maturing ground bounce compensation in GPS receivers, to some of the more convoluted approaches that are often required in echo-rich building interiors and/or metal-rich urban canyons. FIG. 5 is thus taking a few first steps toward any and all forms of echo-rich RF, microwave and optical environments.

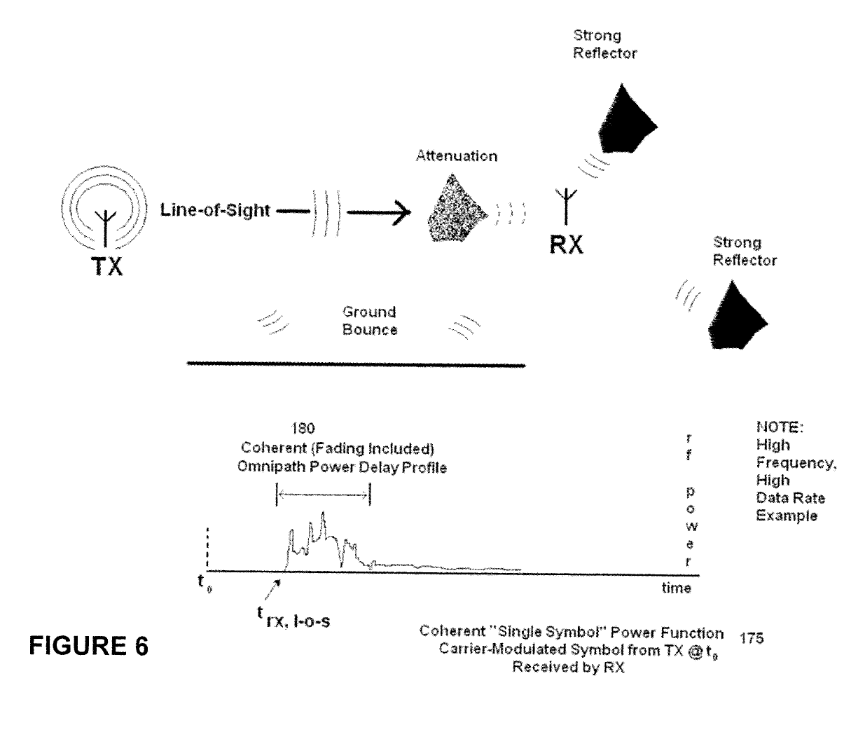

FIG. 6 is an attempt to summarize what later figures and text will attempt to elucidate in more detail, also referring to the situation where one replaces the broadcast impulse with a carrier frequency, and even more specifically to a very short symbol-modulation of that carrier frequency. For example, take any particular method of modulating a carrier frequency with a specific singular symbol, where the simplest case might simply be a “1” in a binary symbol phase-shift approach. What one will find after the process of deconvolving the symbol modulation itself out of a received signal waveform is a “single symbol” response function 175 that resembles the earlier impulse response function (for the same environment presented in FIG. 5), but seems to be more spiky or simply having higher frequency time-based characteristics, labeled 180. Since much of the communications world lives and breathes symbol-modulated carrier frequencies, these subtleties are not swept under the rug. This disclosure will return to this interesting phenomenon much later, focusing in separately on how to understand proper mitigation of the effects, while also discussing the exploitation potential of the effects.

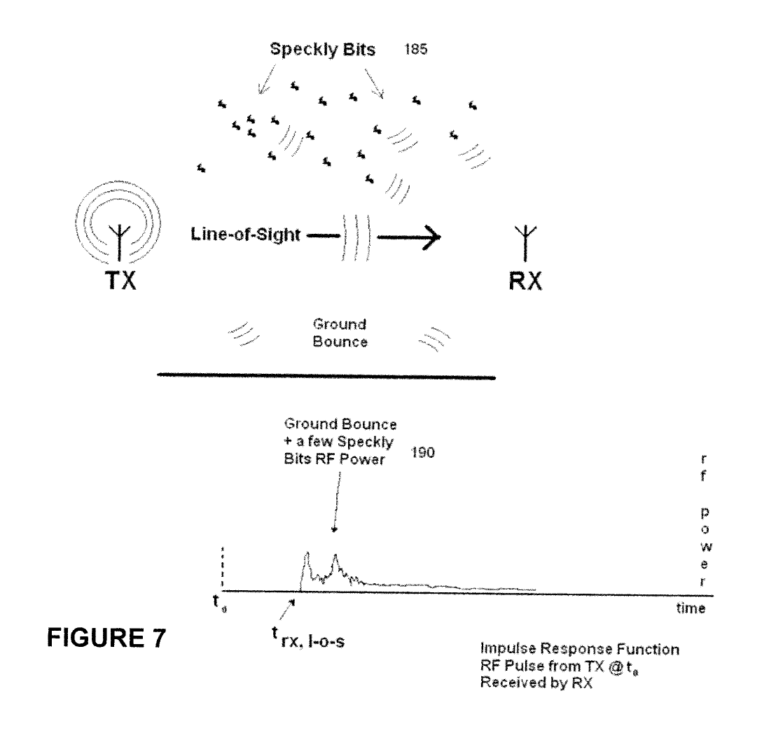

FIG. 7 partially repeats FIG. 5's basic notion that “signals bounce from everywhere,” but also introduces a larger number of discrete scattering elements referred to herein as “speckly bits” 185. The newly introduced speckly bits also correlate to more high frequencies in the impulse response function (separately from the effects discussed in and around FIG. 6), here labeled 190.

Omnipath: Formal Steps Toward Analysis

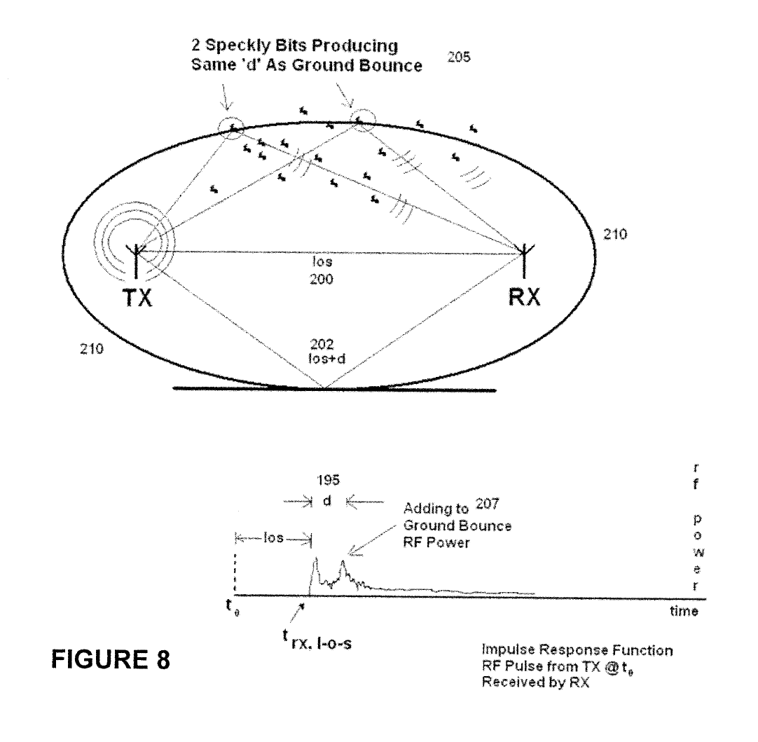

FIG. 8 is our departure into the analysis side of omnipath discussed above, and completes the turn of the discussion that FIG. 7 began. FIG. 8 is based on FIG. 7, now with further overlays.

FIG. 8 isolates one specific omnipath delay time labeled “d” in FIG. 8 (also labeled 195), which just happens to be the nominal delay associated with our earlier ground bounce. There is also a line drawn directly between TX and RX labeled 200 and having an “los” representing the line-of-sight light-time between the two. Directly below this is label 202 with “los+d” indicating that the two lines representing the ground bounce path have the collective light-time of the line-of-sight los plus d. Those practiced in the art well know that one can discuss distances and “light time” interchangeably. It can be then noted that “d” 195, is in time units, as well as los. This disclosure will generally be using light-time as a spatial distance metric for much of the discussion.

In the example shown in FIG. 8, two of the individual speckly bits happen to produce power reflections that produce the same los+d delay in power reception at RX. These two bits are pointed out by the arrows and text 205. The direct lines to and from these two speckly bits are also drawn, where it is clear that the two total path lengths thus drawn are each los+d. We can then anticipate an increase in the impulse response function over and above the ground bounce component, noted 207. The other speckly bits contribute power slightly before and slightly after delay time point los+d. Finally, 210 is doubly labeled, pointing out that any speckly bit that happens to lie on the ellipse that is tangent to the ground plane also produces a total path length between TX, to the speckly bit and then to RX, of los+d. Optics and acoustics professionals are quite familiar with this basic kind of elliptical behavior. In FIG. 8, only two speckly bits fall on the ellipse associated with the ground bounce.

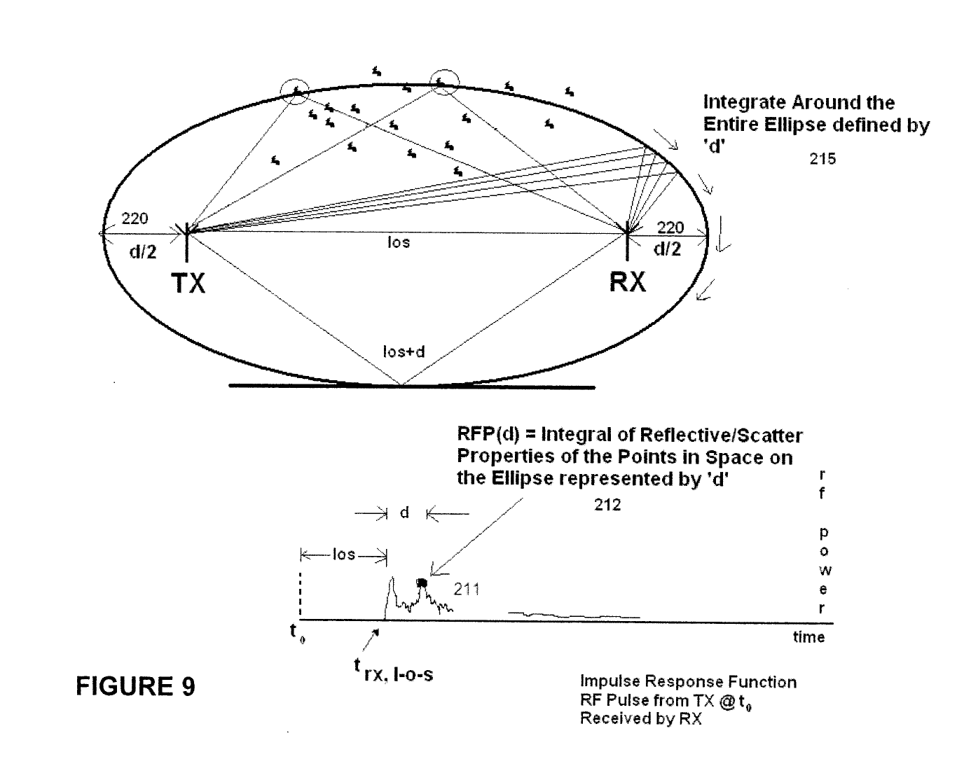

FIG. 9 has much the same graphic as was depicted in FIG. 8, with a differing set of overlays. The basic situation to be discussed surrounding FIG. 9 concerns the question of how we can cleanly understand where the power level value at the time point los+d came from and how it can be objectively measured as summation of components. FIG. 9 in particular confines the discussion to a universe where only one RF re-direction is allowed (not two or more, which will be discussed shortly).

We can begin the specific discussion about FIG. 9 by noting the point on the impulse response function associated with los+d, which has been drawn a bit thicker than before, and labeled 211. The idea is to try to discover what components of discrete multipath created this particular power level. Text note 212 pretty much answers this question. Elementary analysis would indicate that a closed integral around the previously discussed ellipse, with certain considerations to be discussed, should equate to what the text note calls “RFP(d)” or the RF power at the time point “d” after the los time point. We have dropped the explicit los and use its point as a new origin for reasons that will become clear as the discussion unfolds (e.g., carrying around an “los+d” in the ensuing discussions becomes unwieldy). Label 215, its text and the associated arrows and families of two-path pairs terminating on the ellipse, graphically convey the integration process that can determine the power level at time point d. Finally, label 220 (doubly labeled) points out that the lateral distance from TX to the left side of the ellipse is d/2, and likewise the same d/2 for RX and the right side of the ellipse. The function RFP(t) shown in FIG. 9 can be viewed as the “single bounce” component of the total impulse response function, as we will see that there might be two-bounce contributors of power to the time point d as well, and three bounce contributors, etc.

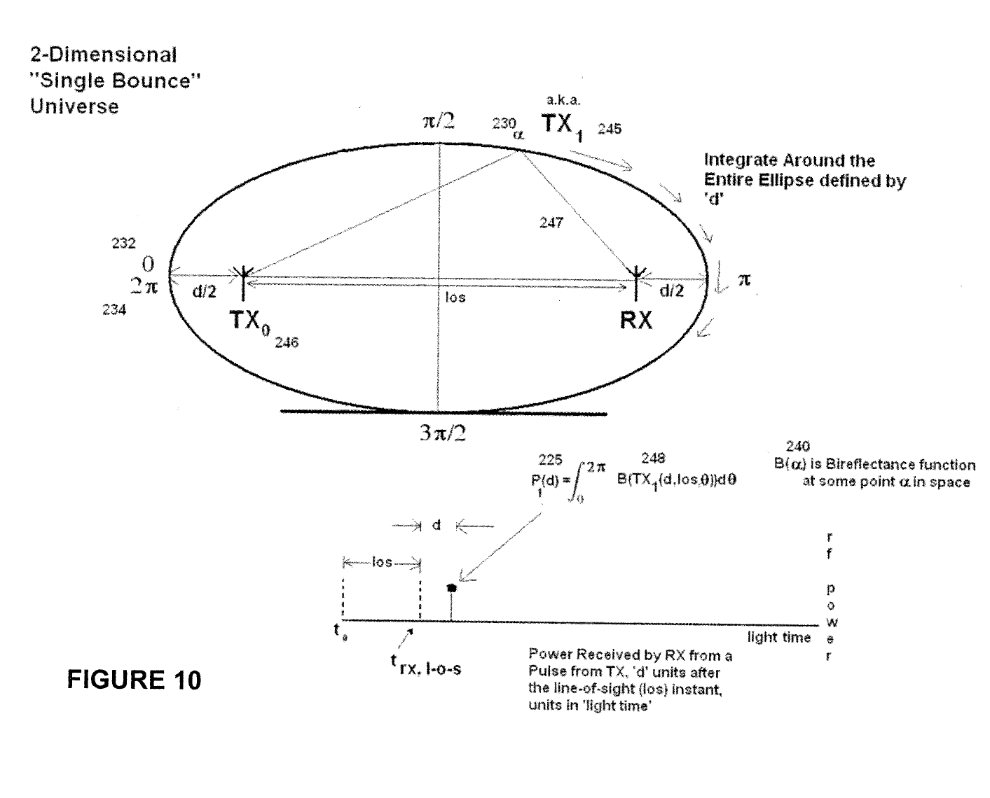

FIG. 10 attempts to clean up the mathematical picture and transfer the verbal descriptions to classic mathematical formalism. This figure strips away the speckly bits as well as other points in the RFP function. The integral formula 225 provides a simple spatial integration formulation that further discussion will build upon.

Greek alpha (α), label 230 in FIG. 10, becomes in this case a two dimensional spatial variable which travels around the ellipse associated with d. We'll use polar coordinates for the ellipse, starting from the origin “0” labeled 232, all the way around back to the just up to the coincident point 2pi (e.g., 2π), at 234. Rather than integrating using greek-alpha itself (which is just the imputed spatial coordinate of a point on the ellipse), the integral 225 uses the typical theta (θ) as the integrand instead. The integral is thus from 0 to 2pi.

This integral includes a newly introduced function B, labeled 240 with associated text. This is the bireflectance function for any spatial point greek-alpha. The bireflectance function may tend to look pretty complicated in its full three dimensional form, but fundamentally it is a very simple physical concept. For the purposes of this disclosure we refer the reader to advanced optical textbooks or simply searching the internet on this function. Its ultimate role in explaining the implementation of this disclosure is fairly minor, so the discussion here will be limited. Of note is the case where essentially no material surface exists at a point nor undue amounts of Rayleigh-scattering particles. In this case, the spatial point on the ellipse is simply near-zero and the integration is collecting no power from such a point. Hence, it is where these ellipses overlap with speckly bits and physical surfaces where the real action is.

The basic idea behind the bireflectance function is that for any given point in space that may contain a surface or particle that might redirect electromagnetic waves, a function can be defined that has as one of its input variables being the direction “from which” the electromagnetic wave came to that point, and a second variable being the direction “to which” the subsequent redirected energy is sent. The function itself is a scalar value representing the re-direction strength of that specific incoming direction and the specific outgoing direction, for that point in space, generally being a material property and an orientation property of the point in question. An optical mirror, for example, has close to a “1” bireflectance value for all “mirror pairs” of incoming and outgoing angles, and near zero for all other combinations of angles. We re-emphasize that a deep knowledge of the bireflectance function is not in any way necessary for enablement of this disclosure; it is included here purely for the sake of thoroughness.

For reasons that will be more clear as the discussion proceeds, label 245 in FIG. 10 introduces the new variable “TX₁” which can stand in for the more generic spatial variable alpha. The general idea here is that a power re-direction point looks like a new transmitter from the perspective of the receiver, RX. Accordingly, we have sub-scripted the actual transmitter TX with a 0 in FIG. 10, labeled 246. The line drawn from TX₁ to RX 247 becomes a new line-of-sight transmission, presaging an ensuing discussion about multiple bounces and the broader omnipath analysis. Label 248 then points out that the primary integration aimed at totaling up the single bounce power for the specific instance in time “d” is built around adding up the bireflectance for all points on the ellipse defined by d and los, along with the specific environmental geometry that they and the placement of TX and RX imply. This complexity is all stuffed into the three listed variables inside a TX₁ function, the variables being d, los and theta. Yet again, ensuing discussion would quickly become unwieldy if we were to not simplify these expressions right away.

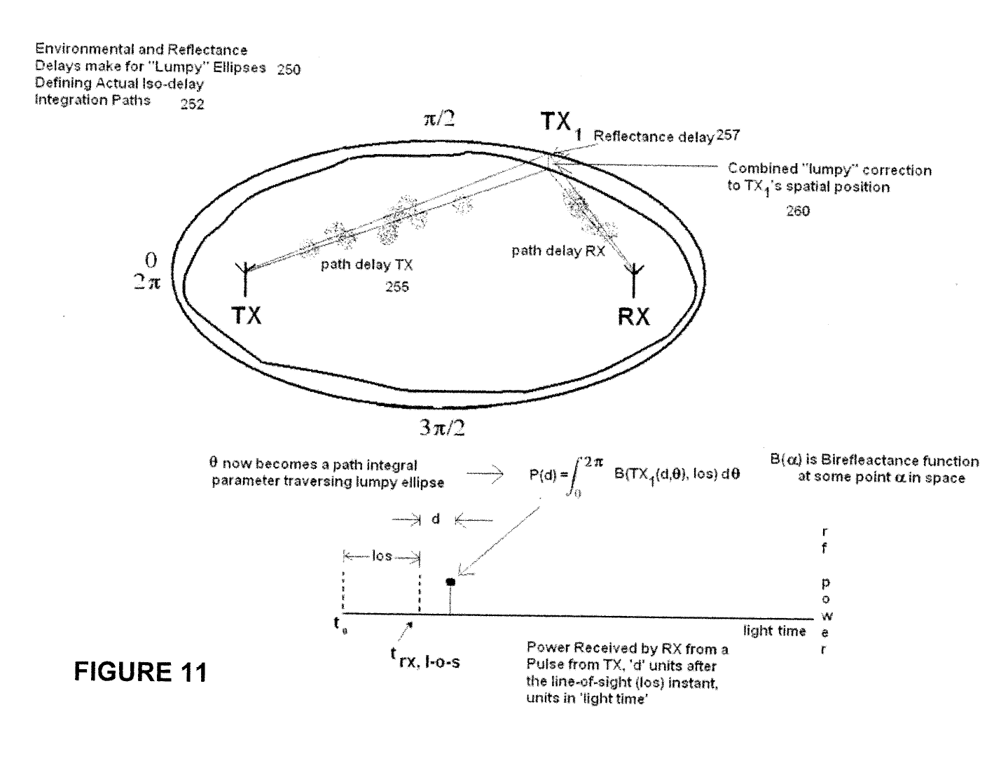

Referring to FIG. 11, when it comes to the ultimate nastiness of the multipath/omnipath mitigation problem, the disclosers have found that it is best to leave no known stone unturned in at least examining the fundamentals of analysis. Thus, let's explore the full analysis while we are at it, then we'll recommend certain pragmatic solutions for applications which may be affected by these subtle challenges.

Labels 250 and 252 immediately point out two new terms whose concepts are depicted in FIG. 11: 250, “lumpy ellipses” and 252, “iso-delay integration paths.” The short summary is that in practice, the perfect ellipse of FIG. 10 and previous figures never are realized due to both electromagnetic propagation delays as well as reflective delays. Also still as a summary statement, to the extent TX and RX are completely ignorant of their environment, they can choose to believe that the single-bounce delayed power they are receiving emanates from the outer smooth ellipse, while us living creatures in the real world can observe the system and understand that, for that specific delay “d,” the re-directed power actually came from the inner lumpy ellipse.

From the embodiment implementation standpoint, three notes remain in FIG. 11 for quick discussion.

Note 255 by the “path delays” depicted with all the mist draws attention specifically to the word “delay” as opposed to attenuation. To be sure, both are present in atmospheric propagation, but FIG. 11 specifically refers to what has also been called refraction or the effective slowing down of the speed of light in some particular medium. Much fine work has been done, for example, in this area for GPS signals traversing through the ionosphere, with particular attention being paid to the variability of this factor. For urban core situations, presumably this almost always won't be an irritant, on the other hand. The middle ground in relevance of all this might be, for example, applications in military theatre-scale networks where distances between communicating nodes can be in the kilometers range and much greater, where positioning and timing precisions/accuracies are trying to maintain sub-meter levels. In these applications, some of these seemingly trivial theoretical nits become job-threatening specification-busting nags.

The second note, labeled 257, points out the time delay inherent in all physical reflections of electromagnetic waves. Note that implementers of applications using lower frequency communications (such as below 1 GHz) may want to examine whether this reflective delay is worth paying attention to and explicitly addressing.

The third label 260 simply alludes to the practical notion that a simple contraction length of the outer ellipse can be used to represent the combined effects of both propagation delay as well as reflective delay. With a variety of simplifying assumptions applied, mainly that surface reflections have a great deal of similarity in their effects and that atmospheric delays do not have extremely small scale structure, virtually all applications will find that lumpy ellipses are really not that lumpy after all, and a fairly low order application of the “tweak” shown by 260 is a sufficient remedy if one is needed.

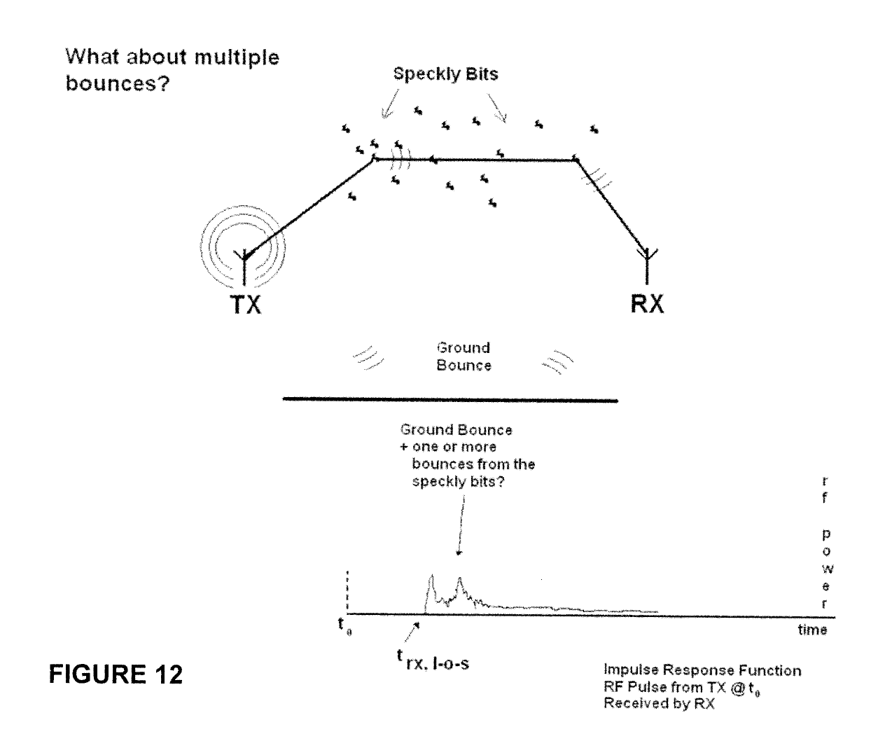

FIG. 12 is self-explanatory and rhetorical. In our ultra-thorough analysis world (as well as in a metal-rich office interior), the two bounce scenario and the resultant three paths between TX and RX should be considered. This discussion will now progress to discuss even more bounces than two, again in the interest of analytical thoroughness. Those practiced in the art will appreciate that straightforward signal to noise level analyses for a given TX-RX pairing, even in an echo-rich interior space, quickly show that signal levels rapidly decrease within increasing numbers of reflections, where practical considerations beyond three reflections and four resultant paths may already be overkill for virtually all applications.

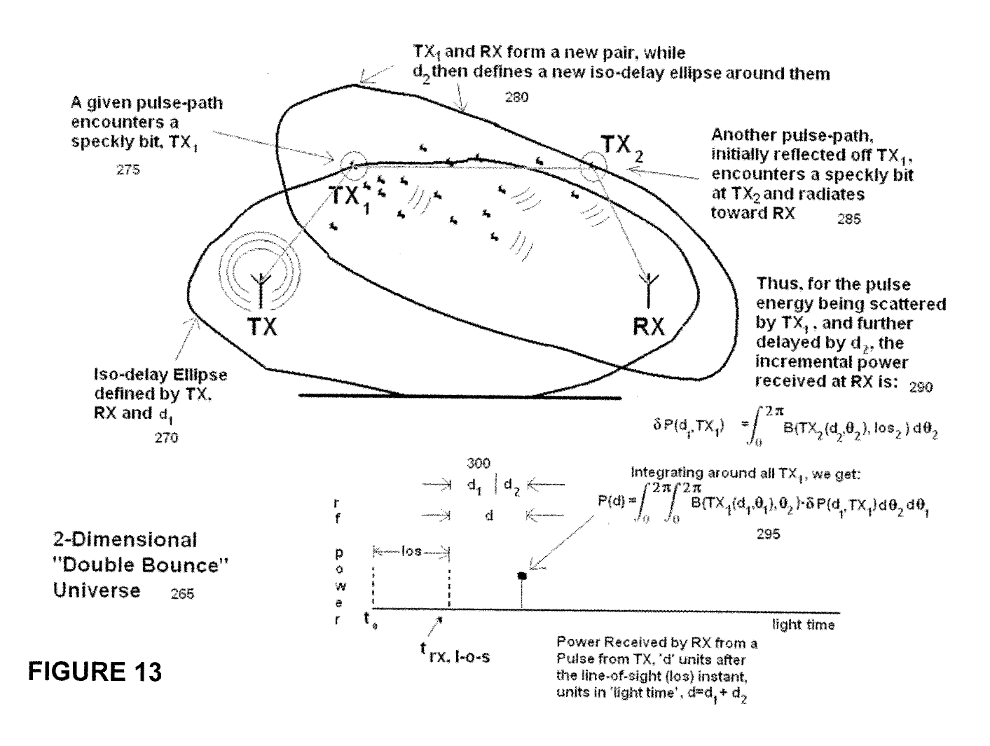

FIG. 13 is a rhetorical response to FIG. 12's rhetorical question. The inundation of new detail here is deliberate, as the ensuing figures and discussion will attempt to parse out the elements in the cacophony.

FIG. 13 maintains the lumpy ellipse view of the practical situation, where the text by label 265 announces we are now viewing a two dimensional “double bounce” universe. FIG. 13 itself attempts to summarize the entire story here, read clockwise from the text labeled 270. The disclosure will swiftly repeat the story here. Label 270 posits the iso-delay lumpy ellipse just discussed, initially set-up between TX and RX and the new delay parameter d₁. One of the speckly bits labeled 275 and named TX₁, lies on the d₁ iso-delay ellipse and re-directs the power in all directions. This then produces a second lumpy ellipse 280 chosen to correspond with a second arbitrary speckly bit 285 named TX₂. This new ellipse corresponds to an additional delay of d₂. Note 290 then summarizes the amount of incremental power being received by RX at the combined time d=d₁+d₂. This incremental amount is explicit in how the bireflectance function now operates on the angles from TX₁ to TX₂ as the incoming angle, and TX₂ to RX as the outgoing angle. Realizing that the points on the first ellipse defined by d₁ will each have their own unique ellipse based on d₂, we find that the total integrated power received at RX from all d₁-d₂ pairs of points is a double integral 295. The integration 295 is clearly already getting busy, and one can see why generalizations regarding the extreme details of the bireflectance function were needed earlier and here maintained. Note 300 simply points out on the composite nature of “d” on the double-bounce contribution corresponding to the specific d₁−d₂ pair. Clearly, the total double bounce contribution at time point d to the ultimate impulse response function of FIG. 1 will contain all d₁−d₂ pairs, where d₁ will vary from 0 to d itself. The disclosure will examine this further consideration in more detail below. The double integration 295 is only for this singular pair of d₁−d₂.

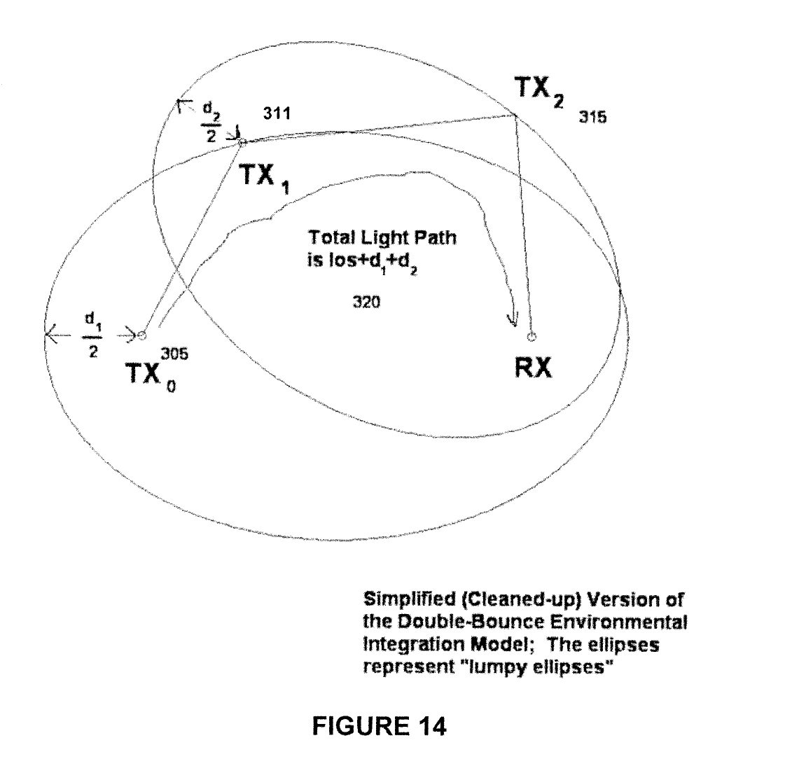

FIG. 14 takes an abrupt graphic-based turn toward Matlab-modeled analytics. The idea of FIG. 14 is to capture the path-based essentials of FIG. 13's situation. The lumpy ellipses are replaced by very faint true ellipses and their lumpiness is graphically gone but not forgotten (the lumpiness should always be presumed to be subtly present, but this graphic and ensuing ones will not complicate things by trying to display this lumpiness). Some geometric details are now what is left. Our original transmitter TX₀ broadcasts its impulse in all directions (antenna spatial power distribution profiles duly applied), that then runs into some arbitrary point TX₁, 311, then “re-transmitting” its own re-directed impulse later finding arbitrary point TX₂, 315, then it too re-directs the impulse power finding its way to RX via the line-of-sight path. Label 320 indicates the total light-time of the overall path, including los, where we have seen that we will drop los in most formulae. There are circles drawn around point TX₀ and TX₁, indicating that they are the two points which generate ellipses with RX as the opposite focal point. Again, emphasis must be placed on this graphic only applying to the d₁−d₂ pair, where later discussion and figures go into all families of pairs and how they combine to produce the full impulse response function of FIG. 1. This same situation applies to all TX₁ points on the initial ellipse, followed by all TX₂ points on the unique ellipses associated with each and every TX₁ point.

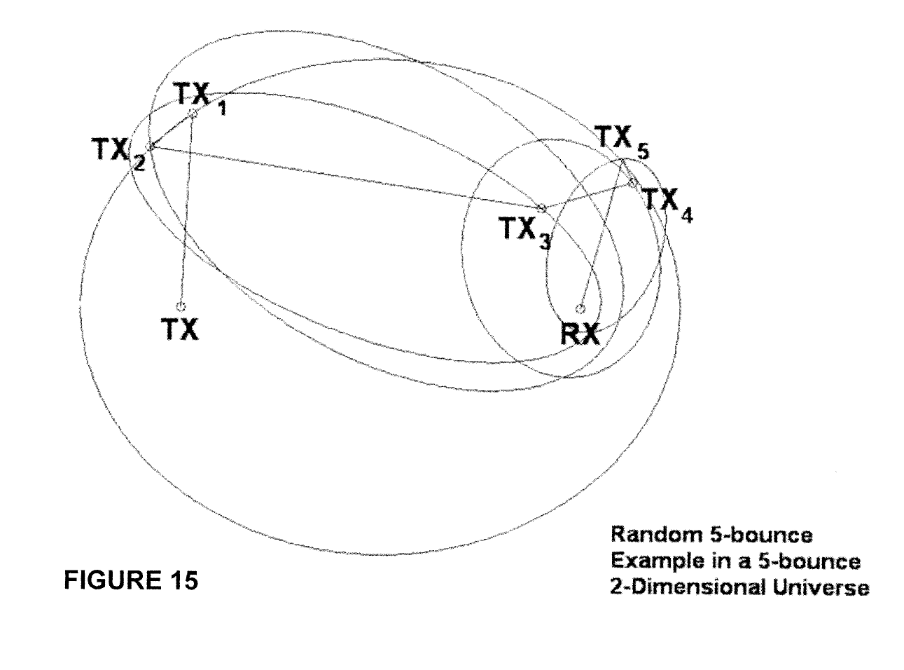

FIG. 15 is deliberately evocative in showing, e.g., a five bounce, six path example of how, hypothetically, an electromagnetic pulse could bounce its way from TX to RX. One can quickly see how this extends to any number of bounces N, N approaching infinity. The natural end-point of this kind of thinking is very reminiscent of what many Physicists know as Feynman all-path integration, with one major difference being the positing of an impulse transmitter producing a time-based function, as opposed to Dr. Feynman's inherent oscillatory model.

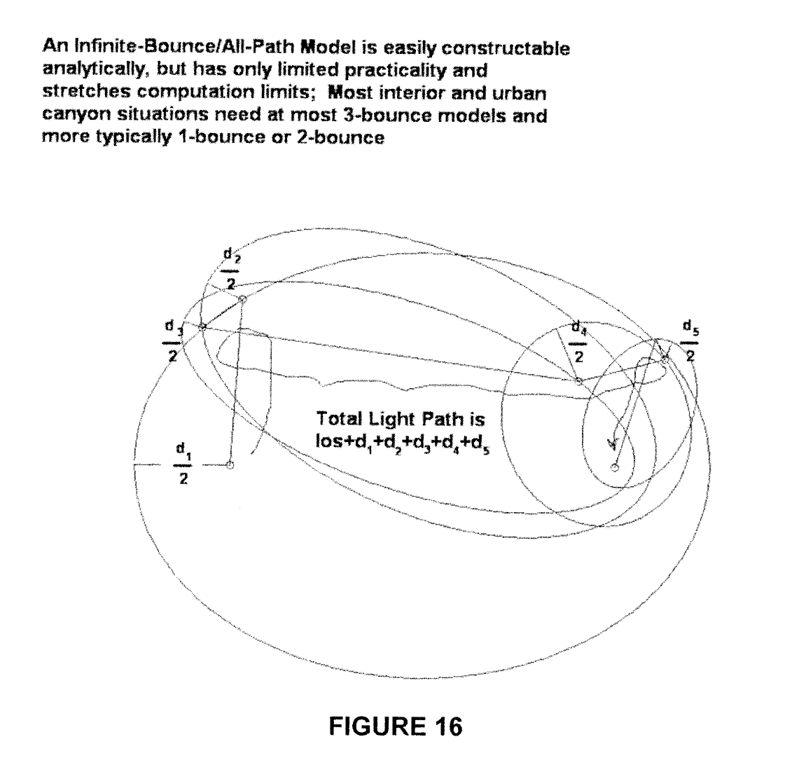

FIG. 16 at least pays lip service to this discrete impulse based approach to all-path integration, pointing out what was already mentioned, which is that even in fairly echo-rich interiors, three bounces may indeed be the signal-to-noise based limit on how far one has to consider multiple bounces. Ironically, this same kind of “most paths are trivially small” conclusion was quickly found in some of Feynman's very early work as well, not surprisingly.

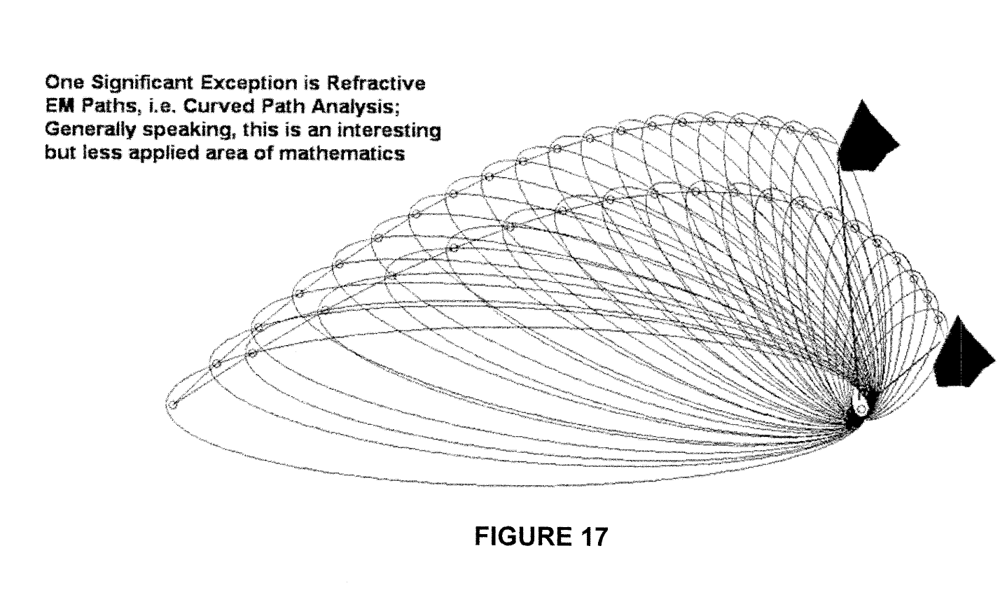

FIG. 17 continues the lip service by at least pointing out that there are “semi-applied” situations where “large-numbers-of-incremental-bounces” may wish to be studied, where heavily refracted signal propagation may be leading the application list. FIG. 17 has an extremely exaggerated view of signal path refraction which could be modeled by discrete families of multi-bounce ellipses. Depicted in FIG. 17 is a notional study of how moving a given object nearby RX can illuminate appreciable different multipath effects due to signal refraction.

At the end of the day, FIGS. 15, 16 and 17 are included in this disclosure not at all to advance the enablement potential of the described embodiments but instead to show that there is really no obstacle to extending the ensuing discussion and figures from the concentration they have on single, double and triple bounce environments to any number of bounces so desired, also including curved path situations.

FIG. 18 gets us back on track to the discussion on the full integration model behind the impulse response function of FIG. 1.

Harkening back to the discussion surrounding FIG. 14 and the note that it only applied to a very specific d₁−d₂ pair, FIG. 18 completes the picture by first noting, in label 325, that the full contribution of all possible double-bounce paths to the time point “d” will therefore include all values of d₁ from 0 to d, where the associated d₂ will be forced to be equal to d−d₁. Label 326 bears witness to the addition of this new third integration across d1, while label 327 points out the somewhat awkward “d d₁,” to show that this is an integration with respect to the variable d₁.

The remainder of FIG. 18 is intended to be a graphic intuitive aid explaining that the overall situation remains fairly simple to follow. Three specific points, 331, 332 and 333, on the 45 degree line representing all d₁−d₂ pairs making up a singular “d” project out to three two-ellipse examples, 335, 336 and 337, associated with those points. The patient reader generally familiar with the fundamentals of integration can then see that the inside integration of the three is doubly labeled 341, while the second integration is doubly labeled 340. In an almost animated kind of way, by conceiving of the integrations as a nested loop, it can be seen that this integration will sum up all possible two-bounce combinations of pathways between TX and RX, corresponding to the final delay “d.” The two-step bireflectance function B remains in this integral as well.

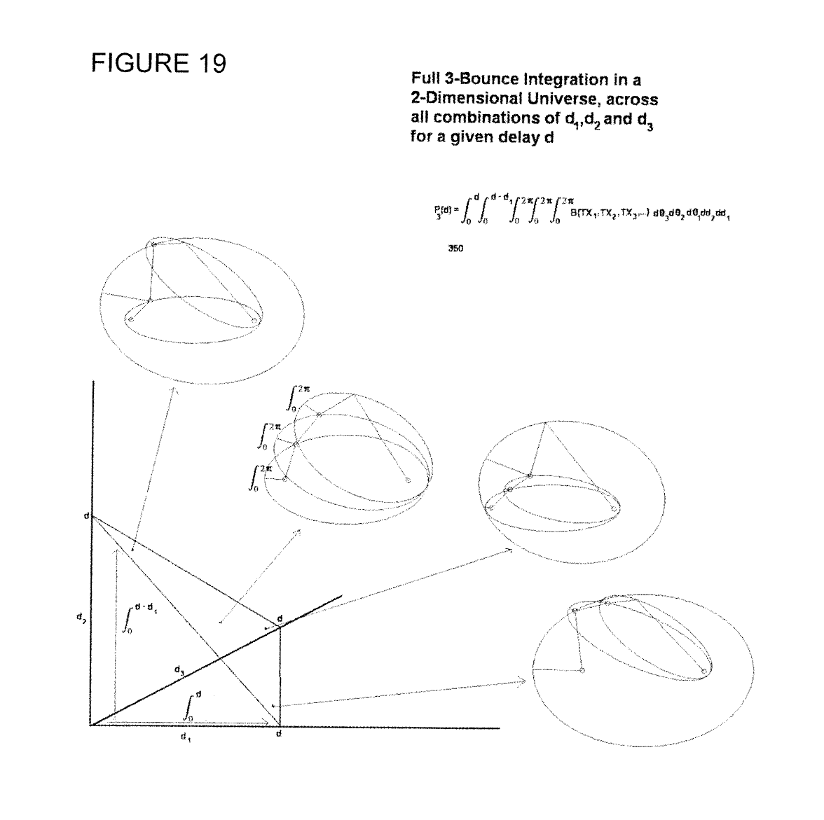

FIG. 19 then “one up's” FIG. 18 by showing the same situation, only now for the full three-bounce universe. The upshot of the one-up is that our primary integral 350 is now a quintuple integral rather than a triple integral for the two bounce case, integrating across two independent component delay parameters d₁ and d₂, and integrating across the nested ellipse families associated with each one of the d₁-d₂−d₃ triplets. We should also note that another generalization was put into the explicit integral formula in FIG. 19, where there is now listed only a single bireflectance function rather than the actual underlying family of bireflectance functions that applies to this three bounce case.

The reader is now asked to consider FIGS. 10, 18 and 19 as a set. In each of these three figures we find the complete summation of the power contribution at time point d, from single bouncing, double bouncing and triple bouncing respectively. [The “no bounce” case of line-of-sight is considered trivial, or if one wants, one can simply plug d=0 into any of the multiple bounce formulae]. For practical applications therefore, the total impulse response function of figure one looks like:

IRF_{3 bounce, 2-dimensional}(d)=P₁(d)+P₂(d)+P₃(d). (1)

Equation 1 subscripts the maximum number of bounces allowable, and we limit the explicit components to three. “Impulse Response Function” is also acronymized. The term “2-dimensional” is also subscripted for thoroughness, making sure that we don't forget that for explanatory purposes thus far, we have limited the discussion to a two dimensional universe of EM/RF pathways.

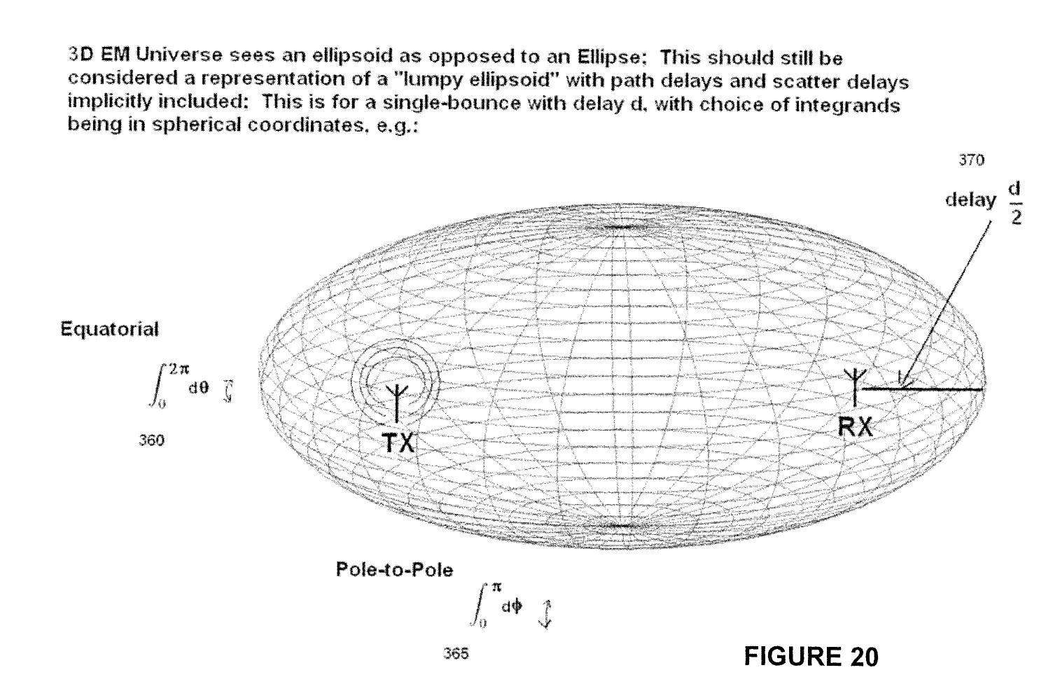

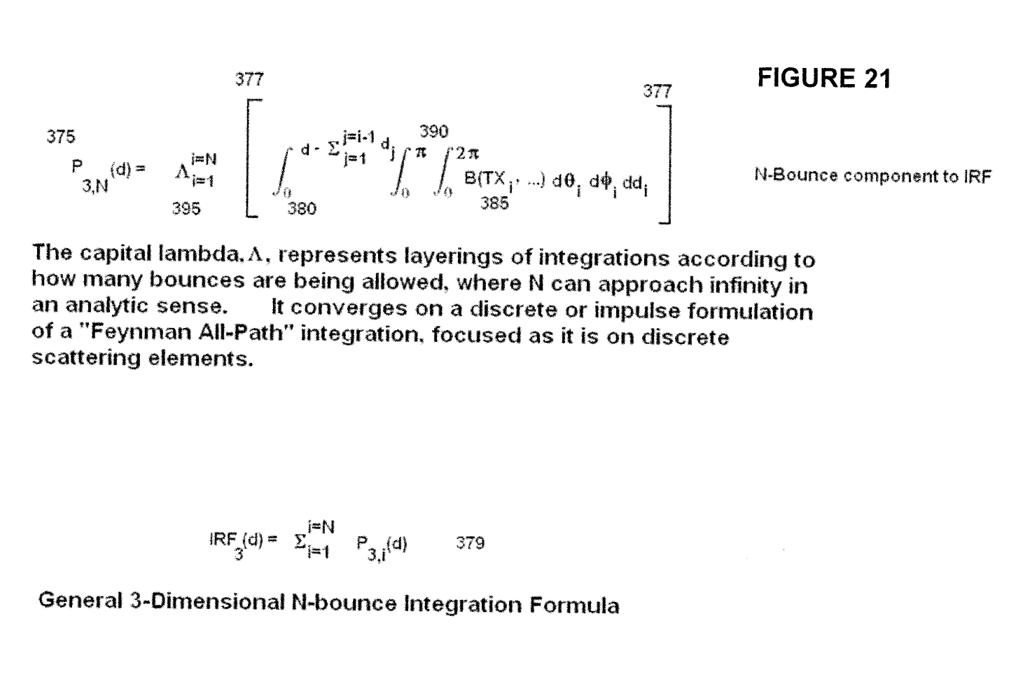

FIGS. 20 and 21 attempt to complete the real-world integration discussion by extending all of our 2 dimensional graphic examples thus far into the 3^{rd} dimension. FIG. 20 is a token intuitive piece for the one bounce case analogous to FIG. 10. We could have shown two-bounce and three-bounce examples of multiple ellipsoids, but FIG. 20 is already sufficiently busy even for the lowly one bounce case.

FIG. 20 finds our familiar 0 to 2pi integration around theta or the horizontal plane in this case, labeled 360. It is now joined by a rotating vertical plane integration from 0 to pi, using the polar variable phi (φ). One can conceive of this, for example, as moving from south pole to north pole. The same d/2 lateral distance from TX and RX to the ellipsoid is present, labeled singly by 370 as one example in FIG. 20. The ellipsoid is of course spatially symmetric about the TX-RX line-of-sight axis, something which was not attempting to be graphically depicted for fear of overwhelming the figure.

FIG. 21 may be one of the most difficult figure to explain up to this point in the disclosure. Almost all implementations of the disclosed embodiments will not require knowledge of its details, fortunately, but we shall try to explain it nonetheless here following.

The full three dimensional (i.e. real world) impulse response function, IRF, 375, can be constructed up to any desired “bounce order” N. Hence the 3 and the N as co-subscripts on IRF. Our familiar time delay point “d” is the primary variable.

Pick a bounce order, any N, and the expression inside the brackets 377 is an added triple-integration layer to the overall formula constructing the full integral equation for that contributing element, P(d), corresponding to that number of bounces N. Once each of the N bounce formulae are thus constructed, they themselves need to be added together for the overall IRF function 379. The singular exception to this “layering” is for the single bounce case N=1, where the first integral labeled 380 does not need to be included since there is no “splitting up” of d occurring for the single bounce case.

Thus let's say we wish to construct the full IRF function across all “d” from 0 to infinity but limiting our analysis to only 3-bounces (and thus four paths). We then first construct all three component P(d)'s corresponding to one bounce, two bounces and three bounces, ultimately adding them together as in formula 379. The one-bounce P₁(d) drops the first integral, 380, around the delay fraction variable since there is no fraction to speak of, and simply has a “layering” of one set in the brackets, giving a final double integral equation with a single bireflectance function 385 relating TX to TX₁ as the incoming direction, and TX₁ to RX as the outgoing direction. The resultant P₁(d) is essentially formula 225 depicted in FIG. 10 and discussed in the text, with the addition of the three dimensional universe integral from 0 to pi over the phi variable. This 3 dimensional double integration is labeled 390 in FIG. 21.

The two bounce P₂(d) retains these two integrals from the single bounce case but now “layers” three more integrals inside the bracket, forming a quintuple integration to describe the full two-bounce formula in three full dimensions. There are inherently two bireflectance functions 385 thus included, representing the angle-pairs going into the first bounce and the angle-pairs going into the second bounce. Likewise, the second ellipsoid of the second bounce now adds its two nested spatial integrations 395. A single integral layering is added by the splitting up of the “d” parameter into d₁ and d₂ components, labeled 380. The resultant P₂(d) likewise resembles formula 326 depicted in FIG. 18 and discussed earlier in the disclosure, only now it has the single spatial integrations about 0 to 2pi supplemented by a second integration about 0 to pi and the phi variable.

The three bounce case P₃(d) thankfully just follows the above prescription for layering in three more integrals to the whole mess. The result is an 8-fold nested integral equation. One can clearly see that an explicit computational approach to integration has already become unwieldy in the three bounce model if not even the quintuple integral 2 bounce model.

What Next after Integration?

The discussion reaches a preliminary conclusion here by noting that at least in the abstract, which includes real-world notions of iso-delay surfaces, a complete “integration” analysis of multipath can thus be built around any transmitter-receiver pair. This has been, of course, the easy part. The much harder part breaks down into several even harder parts: a) developing a generalized cluttered mobile environment model wherein active communicating nodes interact with a wide variety of both mobile and non-mobile EM scattering objects; b) outlining and then describing approaches toward knowing anything whatsoever about the environment in and around the TX-RX pair; c) getting a grasp of the “differentiation” side of analyzing multipath/omnipath; d) further exploring the practical differences between impulse environmental responses and single-symbol-modulated environmental responses; and e) rolling all these things up into new forms of multipath/omnipath mitigation approaches for mobile networks.

To many practiced physicists, engineers and mathematicians, most of the discussion to this point can be recognized as a typical “forward problem” in the sense that if one “a priori knows” the details of the TX transmitter (e.g. its power and antenna radiation function), the same type of details on the RX receiver, and all of the snapshot (non-dynamic) details (relevant to the carrier frequency of EM/RF being employed) of the environment in which they are placed, then one can use these formulae to predict and simulate the expected omnipath behavior between TX and RX (and with careful symmetry assumptions, the identical omnipath behavior when RX sends an impulse back to TX). To be entirely fair, these latter so-called harder parts are much more difficult without the firm integration “forward problem” in hand, so the time spent to this point has been well worth it.

Generalized Mobile Network Omnipath Solutions

A powerful approach to mitigating multipath/omnipath effects in mobile networks is the one that has already been described in the related disclosures and other disclosures. See, for example, International Patent Application Publication No. WO/2008/073347, filed Dec. 7, 2007, by Geoffrey Rhoads, which is hereby incorporated by reference herein for all purposes. The present disclosure will attempt to add more details to this basic approach, tuned to the omnipath problem. A very basic approach to mitigating omnipath delay has already been presented in the related disclosures, and that was simply including the unknown common path delay as one of the H matrix columns in the basic g=Hf formulation covered extensively in the related disclosures. In other words, where these earlier descriptions keyed in on the unknowns of spatial movements and time deviations, the role of placing in an unknown parameter for common path delay can be more highlighted with respect to this disclosure dealing specifically with multipath and omnipath.

In the most general of networks where all spatial, time and delay parameters are unknown, simply adding common path unknown parameters to the f-vector adds dimensionality to allowed solutions as opposed to constraining solutions or producing a singular unique solution. To further complicate matters, omnipath-induced delays generally exhibit larger scale dynamic changes as a function of network mobility, relative to spatial and timing unknown parameters.

But before reviewing the details of including a common path unknown in the g=Hf framework, let's go back to the listing of the “harder problems” in the preceding section and first get through the task of describing a generalized mobile network architecture that is explicit about real-world omnipath situations. Even this “generalization” may be abstract and not look a great deal like any “real” world anyone might know, but this is done by design, letting symbols take the place of an enormous range of potential real world objects and communicating devices.

First: Removing “Time” from the Omnipath Problem

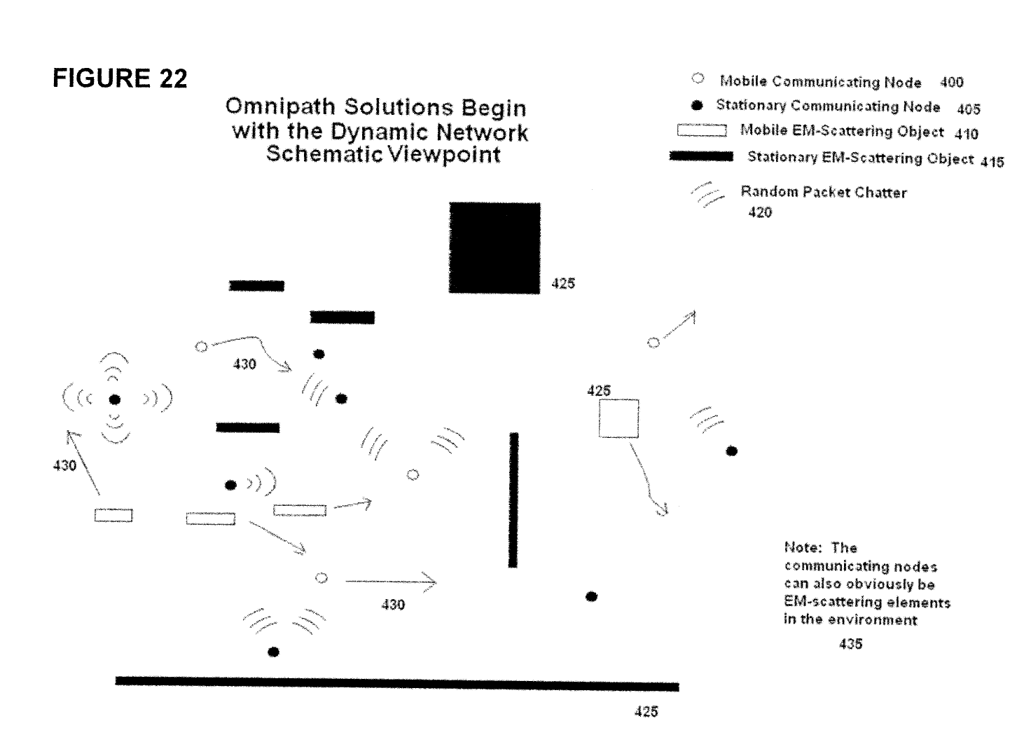

FIG. 22 introduces one embodiment of a dynamic network schematic that is utilized in the following discussions. FIG. 22 has been deliberately caste in a symbolic graphic context rather than attempting anything like an actual mobile environment.

The legend in the top right part of FIG. 22 lists four actors in this abstraction, along with a fifth more ethereal player that nevertheless has a part in the play. The open circles 405 and the filled circles 410 are mobile and fixed communicating nodes respectively. By “communicating node” we tend to emphasize its more general meaning at this early stage of description, where this can mean full duplex communications, or indeed receive-only or transmit-only devices. The mobility status of the nodes is considered a useful element to the ensuing descriptions, and hence they have this early stage distinction. Rectangular objects (including squares and elongated surfaces 425 giving at least some notion of gross properties) then represent mobile EM-scattering objects 415 and fixed EM-scattering objects respectively. Note 435 makes it explicit that the communicating nodes themselves can easily be EM-scattering objects as well. Note 420 then indicates that presumably there will be many instances of “packet chatter” transmitting from, being received by, and scatter off of, all combinations of communicating nodes and scattering objects. This is a very crude representation of “the signal soup” and is clearly the most abstracted element of the whole schematic. The basic idea is “echo rich” chatter all over the place, random bursts of signals, a busy buzz of objects, communicating devices and bouncing signals. Motion paths 430 of some of the mobile elements is also included to make sure that we don't leave out the dynamic part of the buzz. Next up is to look to get some structures and form into the chaos.

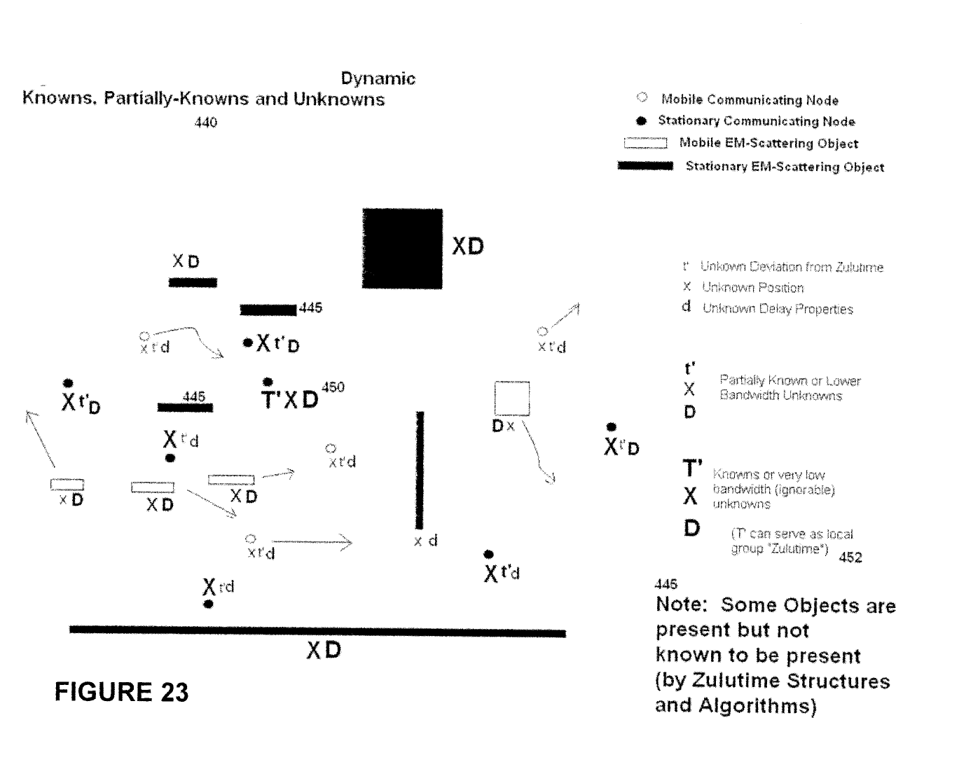

FIG. 23 continues with the deliberately symbolic and abstract graphic treatment of a general mobile networking situation. The three-period ellipses preceding the text 440 attempts to directly connect FIG. 23 to the previous FIG. 22, showing that FIG. 22 can be re-conceived as a whole bunch of unknowns, partially known things and potentially very well known objects and behaviors of various types.

FIG. 23 keeps all of the nodes and objects in FIG. 22 largely in place and has removed the chatter. Three core categories of variables, along with three separate levels of “knowledge” about those variables, are graphically depicted in FIG. 23. The three basic categories of variables have been given the symbols t′, x and d, representing time deviation, spatial understanding and delay properties respectively. In yet another deliberate graphic abstraction, the initially loose concept of “level of knowledge” about those variables is arbitrarily depicted as the size and boldness of those symbols, where as stated above, there are three arbitrary buckets of size/boldness corresponding to a) complete ignorance for the smallest size/boldness, b) some form of knowledge (often constraints) about these variables for the medium size/boldness, and c) firm knowledge of one form or another represented as large and bold.

There are a variety of high level concepts depicted in FIG. 23 which will be revisited often in the detailed embodiment of this disclosure. The first thing of note is that only communicating nodes, the circles, have t-primes (t′) associated with them. Another global note is that all nodes and objects have some form of delay property associated with them, which we will see has as much to do with their role in the local omnipath echo chamber as it does with their innate physical properties.

Note 445 provides a short comment that has several implications. It notes that some structures are not known to be present, which certainly implies that others must be known, and “known” implies some entity capable of knowing. Possibly the longest horizon vision for certain embodiments is that a local Zulutime group routinely develops its best estimate of the electromagnetic environment in which it is embedded, replete with a kind of tomographic understanding of both nodes and objects alike. This understanding is a matter of degree and not absolutes, and hence it is inherently open ended in terms of how the local group's knowledge of its environment evolves in data structure and shared protocol terms. This disclosure briefly provides several clear examples of some baseline examples of this local tomographic process, the process, that is, of building this local knowledge. Label 445 is also attached to two random filled-in rectangles in FIG. 23. These have no x or d associated with them, indicating that the local group organized by, for example, the node labeled 450, does not yet even know of their existence. By being filled in, the notion is that these objects are fixed in place, at least over time scales relevant to any given application. The general idea of an aspect of certain embodiments is that the ongoing dynamic activities of the local group may possibly and eventually infer the existence of these objects and instantiate a structural status for them with the group protocols and structures. The ways to potentially “bring them into the group fold” are vast, ranging from blocked line-of-sight inference procedures all the way to some technician coming along and simply programming new things into a fixed node's local environment map.

Viewed in this way, all of FIG. 23 might be seen as the “members” of a Zulutime local group along with two that are verging on becoming part of that group, including inanimate but non-negligible objects. Generally speaking, all the lower case unbold unknown symbols t-prime, x and d are ongoingly being estimated through various measurement properties, assisted by the partial and fully known variables.

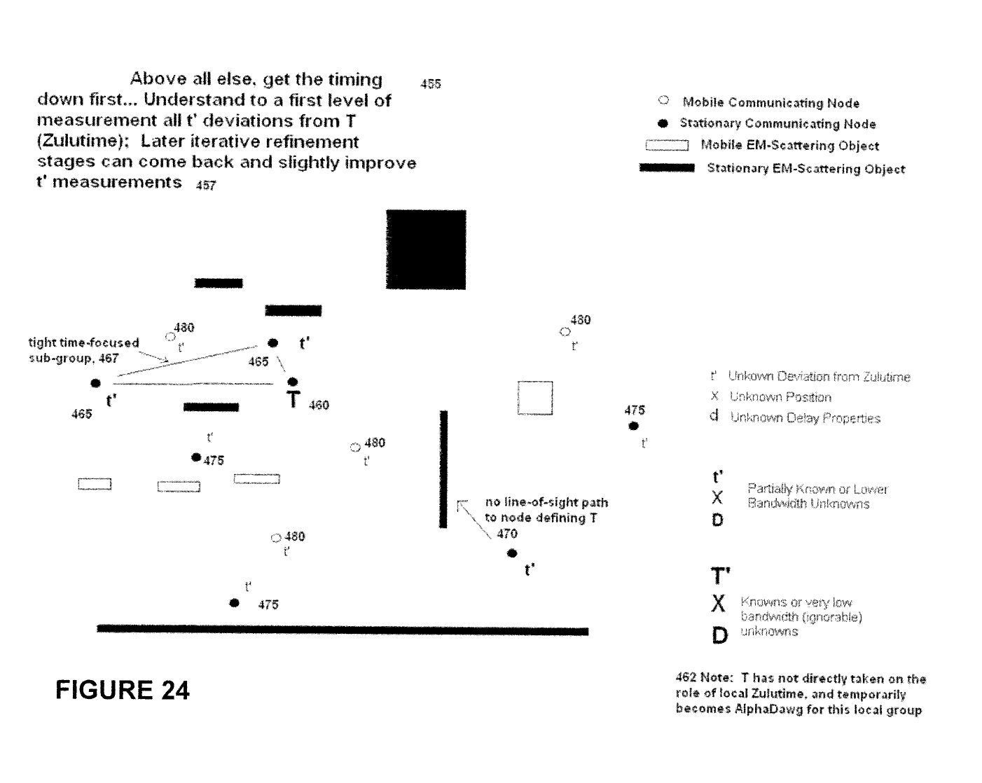

FIG. 24 introduces a mantra of Zulutime omnipath mitigation: before all else, get the timing right first.

Text 455 uses the phrase “ . . . to a first level of measurement . . . ” more specifically. FIG. 23 clearly has an entangled spaghetti bowl of interacting variables that make the task of measuring the various time deviations of the nodes very difficult, but that task is nevertheless a goal of the first stage of omnipath mitigation in one embodiment. Specifically, the g=Hf harmonic block formulation of equations and unknowns is first set up in a way that emphasizes the timing aspects of the overall problem to be solved, where these harmonic block methods are described at length in the related disclosures.

The broader idea is that with timing variations substantially removed from the overall omnipath mitigation problem, classic forms of geometric analysis and attack can be applied in a straightforward manner. These approaches then don't need to worry about timing being mixed into the problem, and their own estimation then simply includes error terms based on the residual timing error from this first stage timing solution estimation. So timing error will still unequivocally be present, but the first stage timing solutions will have quantifiably reduced their initial extent, usually by several orders of magnitude on consumer-grade oscillators and clocks.

The local group can go to great lengths to estimate the expected residual timing error and report this estimate to omnipath algorithms, methods and routines. Those practiced in the art can appreciate that knowing this level of probable timing error can then propagate into broader estimates of positioning errors after certain operations have been performed to determine position estimates. Iterative loops (made explicit in FIG. 24 by label 457) between omnipath-mitigated position estimations feeding their results back into second stage, then third stage timing-focused approaches in a likely approach to forming group-wide optimal solutions (with the resultant “newer” timing solutions being fed back to the omnipath approaches).

FIG. 24 removes the two other classes of variables from the members to emphasize this initial focus on timing. Near the center of all of the members we find a fixed node labeled 460 and a single capital T immediately below it. The prime on the T has been deliberately removed at this point, indicating that this node's internal clock arbitrarily serves as the ephemeral timing standard for this local group (the prime on this T in FIG. 23 was in deference to the notion that ultimately there is no global time, only some partially discoverable relationship between some given oscillator and some externally defined framework). Note 462 makes this explicit in FIG. 24 itself. Here we use the term “AlphaDawg” for nodes that elect to serve as temporary organizers of a local Zulutime group. Any node in the group can play this role, and indeed, its tasking could even be equally shared amongst the group, but for simplicity reasons it is practical to assign to one node certain organizing tasks and the bottom line role of trying to maintain the health and functioning of the local group. In certain embodiments, the AlphaDawg is in charge of initiating a group session, beginning and maintaining a certain level of communications traffic forming the minimum requirements for a group to call itself an active local group, and generally speaking serving as a group resource for all nodes in the local group. In certain embodiments, the system may also select an AlphaDawg backup that is ready to take over at a moments notice, typically within one tenth of a second or sooner, if something goes wrong with the AlphaDawg. Even in such switches, raw ping data is still being collected by all nodes and any such changes in group management will not affect the ability to produce ongoing solutions and associated solution error ellipsoids.

In FIG. 24, reference 465 is doubly labeled on two fixed communicating nodes near 460, each with an associated partially known t′ attached to their respective filled in circles. An idea being conveyed here is that many if not most applications have the opportunity to set up several fixed-position communicating nodes, with the most common type perhaps being the “access point” in 802.11 wireless systems, where slightly better oscillators might be specified for the underlying hardware, with tighter specification on their part-per-million (PPM) deviations.

In certain embodiments, a form of “ping relationship” can be set up between such nodes in a local group, whereby priority is given to communications between such designated nodes, thereby greatly increasing the ability of a tighter sub-group (label 467) can have enhanced ping rates unencumbered by mobility and largely immune to major multipath/omnipath distortions and errors. Those practitioners in for example the GPS engineering industry well know that in duplex communication situations, multipath effects on differential timing synchronization are nearly zero for relatively static environments or environments where very larger scattering objects are not present. One embodiment strongly encourages fixed-infrastructure applications and applications where “server-like” services are delivered by fixed nodes to use these kinds of methods and approaches, all in the service of the broader local group's attempt to mitigate omnipath effects for all members. (This last statement harkens back to the mantra: before all else, get the timing right first).

The stationary node labeled 470 is another “special yet normal” case of a fixed server-like node that might also have a similar relationship with the Alphadawg 460, just like the nodes labeled 465 have. Only here there is clearly an obstruction between the two nodes at 460 and 470. Despite the non line-of-sight situation between these two nodes, keying in on the timing relationships between these two nodes (and many others) likewise is unencumbered by mobility and largely immune to multipath/omnipath effects. Not drawn in FIG. 24 might be connecting lines between this node and 460 and both 465's. It is not drawn only because it would clutter FIG. 24, but this node 470 can easily be considered to be part of the sub-group 467.

There are also three other fixed nodes triply labeled 475 in FIG. 24. As the related disclosures fully explain, there is extreme flexibility of Zulutime group relationships, where these three nodes can represent linkage nodes between Zulutime groups (where these nodes belong to other groups as well, possible several groups each), where treating timing relationships as completely indeterminate unknowns in separate groups, allowing each group to form estimates of delta-Zulutime parameters intra-group, then allowing for inter-group timing relationships to be better managed by cooperating Alphadawgs.

Several mobile communicating nodes, labeled 480, can also be seen. In FIG. 24, they represent garden variety “client like” nodes travelling in and out of local Zulutime groups. They of course have completely unknown timing deviation behaviors which need to be ongoingly measured. The related disclosures and the harmonic block g=Hf core formalism remains as a centerpiece in these measurements (based on lots of ping chatter), where for the purposes of this disclosure on omnipath mitigation, it can be noted that here too duplex channels allow immediate multipath/omnipath mitigation relative to the first stage of timing deviation measurement.

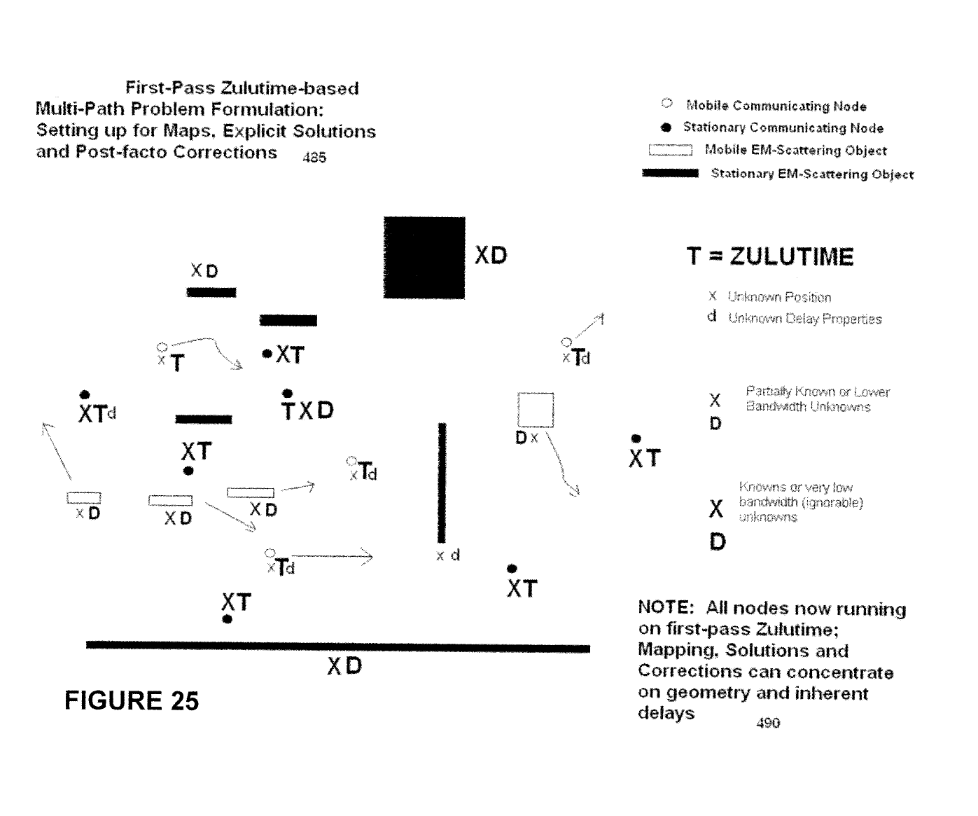

FIG. 25 graphically illustrates a goal of the mantra: get to the point where all communicating nodes within a local group effectively are on Zulutime (or as the related disclosures fully explain, each knows their deviation from Zulutime to a high precision, thus allowing them to calculate what Zulutime is at any count instance on their own clock/counter). The multipath/omnipath problem thereafter shifts largely to a classic map-based geometric problem, setting up code-based, carrier-based and symbol-waveform-based mitigation approaches. The spatial unknowns and the delay property unknowns remain as the inter-twined variables. The text labeled 485 is explicit with the “first pass” emphasis applicable to all the capital T's in the graphics, where it is implied that all of the T's other than Alphadawg's T have some estimated residual error, as previously discussed. The text also points toward just three of many categories of multipath/omnipath mitigation approaches that can thereafter be followed, those three being a) map-based approaches where scattering objects become spatially known and their expected behaviors literally mapped and stored by the local group; b) explicit multipath solutions based on RX signal processing, liberally borrowing from many methods developed for GPS receivers and applied across the code/carrier/symbol span; and c) so-called post-facto corrections, where initial estimates of all of the unknown variable of FIG. 23 can then lead toward modeling of expected data if those measured variables were correct, followed then by a comparison of the modeled data with the real collected data, and the differences between modeled data and collected data can then lead toward slight post-corrections of the initial estimates which minimize the magnitude of those differences (such general approaches can trace their origins back to such scientists as Van Gifted, who explicitly dealt with data gathering situations aimed at producing high quality measurements). Label 490 and its associated text summarizes the text above.

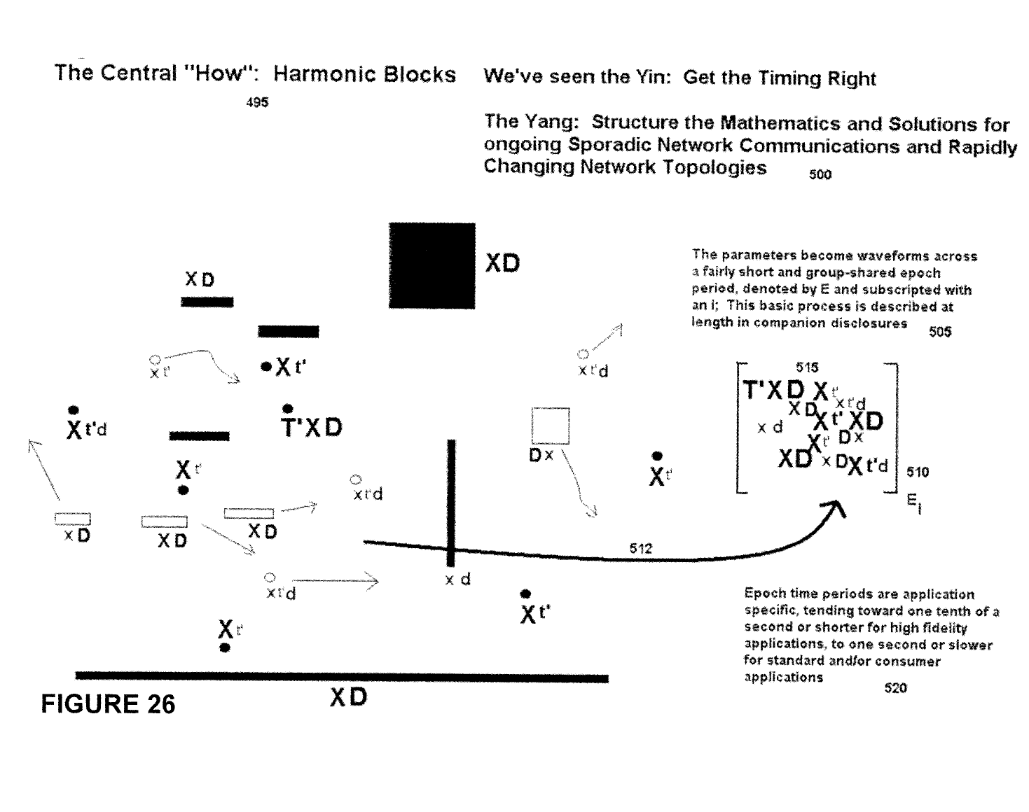

To the extent FIG. 25 summarizes the goal of focusing intensely on timing as the first step in multipath/omnipath mitigation, FIG. 26 begins the schematic summary of how we get there. Repeating what was discussed several paragraphs back, the related disclosures describe these approaches in much greater implementation detail, and FIGS. 26, 27 and 28, along with this related text, serves as a stand-in for these more detailed implementation particulars. Rather than continuing to repeat the need for the reader to refer to the related disclosure for detailed implementation details, we shall leave it as an emphatic statement here, and then make the observation that the following discussion is more about the “system level” design principles that need to be followed in implementing this particular disclosure on applying these implementation details toward omnipath mitigation.

Turning toward FIG. 26, text note 495 proposes that the harmonic block organization of the unknowns (and their relationship to a potentially quite chaotic and asynchronous set of ping data) is a useful element to how the PhaseNet/Zulutime moves from articulating all of these unknowns on the one hand, to solving for the critical unknowns that most applications are interested in: where are these things, what are their positions? That is, the lower case, non-bold x's for the mobile communicating nodes.

Note 500 recasts this necessity where here we emphasize the word “structure” and several of its meanings. Structure is used in the shared blocking of time units across disparate elements of a group; “structures” are used in software code including information about groups, members, etc.; structured flows of protocol based shared information between nodes is used; and further structured flows are used to ingest blocks of input data and spit out staged solution vectors as described earlier and in the related disclosures. The text also adds the note about rapidly changing network topologies. The harmonic block approach yet again is an embodiment for dealing with this extremely difficult problem. Harmonic blocks form a stable template that flows through time, growing and shrinking (in data input and solution output size, not in time extent) as nodes come and go, all the while accepting sporadic bits of data wherever they may come from within the group and whenever they happen to have been recorded and shared. The ability to collect and properly organize, pre-filter and weight sporadic and asynchronous raw data is also best served by harmonic block structures, where one very practical and common benefactor of this pre-organized raw data stream will be the entire class of Kalman filtering that has developed both inside and outside the GPS industry. Indeed, standard Kalman filtering has been developed to accept certain classes of asynchronous data sources, where certain embodiments and the harmonic block structuring of group-defined epochs can properly frame data inputs such that many of these filters can be utilized in a given application if an implementer so chooses.

Note 505 points out that all of the t's, x's and d's wind up being mathematically structured as short waveform snippets across a single harmonic block period, abstractly depicted as a matrix-like bracket structure 510. Some snippets may be represented by a single variable, and others may have two or more variables which can describe sloped lines, curves and higher Taylor-esque polynomials (though other bases functions have easier border stitching properties). E is used to represent a given epoch, sub-scripted by i.

The line labeled 512 indicates the notion that all relevant variables get piled into these harmonic block structures, which mathematically winds up being g=Hf form H matrices, where explicit unknown parameters of the snippets are associated with columns of the H matrix, while raw ping data (or differentiated and/or filtered versions of ping data) is associated with the rows of H. Partially known variables can also be transformed into independent equations separate from raw ping data equations. For example, if a given semi-mobile node already “roughly” knows where it is, then it can simply state this fact and g=Hf formulations can place in weakly weighted equations placing that information into the system of equations, weighted by the confidence of the partial knowledge. Other forms of partial knowledge may or may not be included directly in linear formulations of solutions, but from the graphic standpoint one can imagine that such information is certainly thrown into the algorithmic mix at least as a constraint or non-linear element. Note 515 is attached to this piling in of all the knowns, partial knowns and unknowns, where again the brackets should be more suggestive of the harmonic block structuring of the waveform snippets than taken strictly as a linear H matrix.

The text labeled 520 in FIG. 26 makes the note that the typical time durations defining the length of a single group-shared harmonic block is application specific, typically ranging from one tenth of a second or even one one hundredth of a second for very high precision applications with strong dynamic elements, to one second or even longer for certain applications such as container movements in warehouses or low-dynamic medical instrument inventory management in a hospital.

Omnipath Effects on Timing (DZT) Solutions

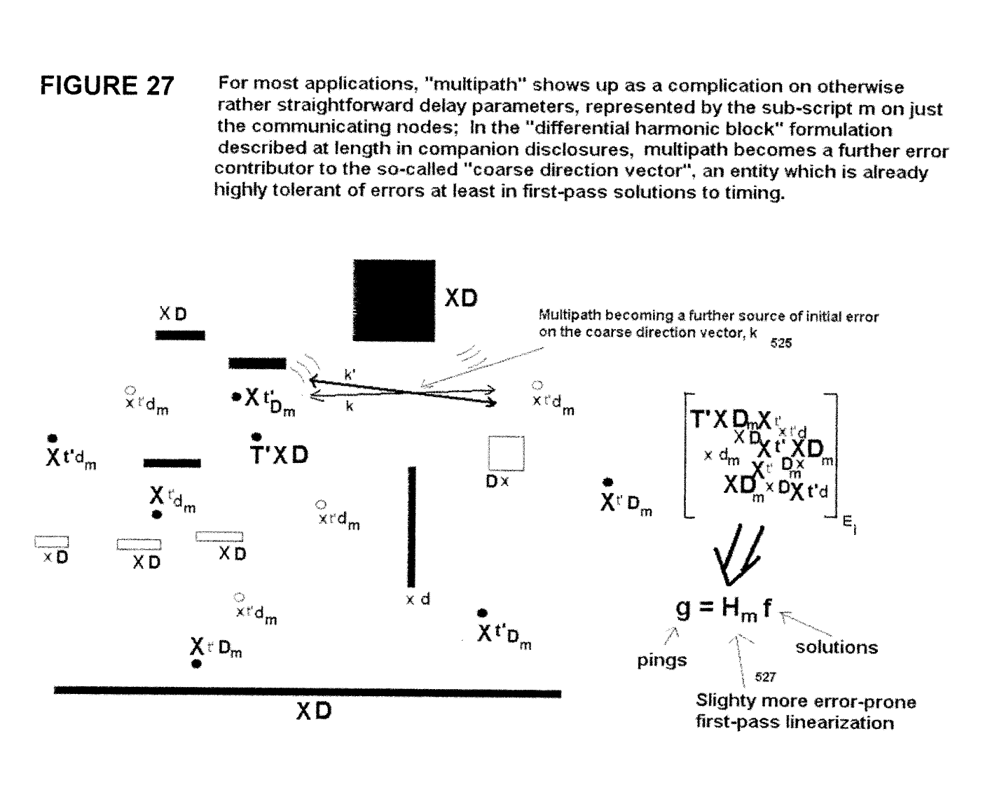

FIG. 27 represents the specific connecting point between the system level multipath/omnipath mitigation approaches that this disclosure has been focused on thus far, and the detailed linear and iterative non-linear algorithms that the related disclosures describe. Remembering that it is the first pass timing solution that we are driving toward in first stage processing, the question to be asked here is how do most if not all forms of omnipath distortion affect the timing solutions specifically. FIG. 27 illustrates that it is primarily the so-called coarse direction vectors of the detailed implementation algorithms that may be most affected by omnipath distortions, with the additional statement . . . “with respect to timing deviation solutions.” The intuitive reasons behind this can be grasped by considering two clocks ten meters apart that are attempting to track each other's time deviations, and a separate pair of clocks twenty meters apart: for time deviation or DZT (delta-Zulutime) measurements specifically, the extra 10 meter delay in the second pair is of no consequence. It is the same situation with “absolute” omnipath delays, they simply manifest themselves as arbitrary constants that might turn a physical clock distance of 10 meters into one that is sensed by the RX node as if it was 20 meters away, but relative to DZT solutions, this will not matter. But when we “turn on the dynamics” of the system and things start moving around, the g=Hf methods of the related disclosures still nicely determine “coarse” differential motions of the nodes (i.e. node A just moved 2 meters closer to node B, but not caring whether it was 20 meters away down to 18 or 10 meters down to 8), while the omnipath distortion specifically will generally be varying the “actual received” coarse direction vectors during the dynamics of the system. It is this variation in time of these coarse direction vectors which then translates into residual errors in DZT solutions, which is one of the main reasons this disclosure has repeatedly discussed “first-pass” and other equivalent terms when describing the first set of timing solutions.

Text note 525 takes two arbitrary nodes and alludes to this dynamism of the coarse direction vectors, where label 527 points out its effect on the g=Hf formalism and how it further increases error on the error-tolerant H matrix coefficients. As pointed out in the related disclosures, differences between the “actual” in situ direction vectors and the “coarse direction vectors” which are placed into the H matrices can be typically on the order of 5 or 10 degrees and still produce solution errors less than the innate noise floors represented by the raw noise on the ping data itself. But omnipath distortions can in practice swing these coarse direction vectors fairly abruptly over short periods of time, for example in cases where a line-of-sight condition all of the sudden becomes occluded and a purely reflected path is what is allowing one node to communicate with another. Fortunately, higher level PhaseNet/Zulutime processes can begin to take over in these situations, most notably the “RRQ” categorization tables (Riccian-Rayleigh-Quality) whereby any given pair of nodes is constantly assessing the state of “linqs” between a given node and another, assigning an RRQ state to that linq, and whereby abrupt changes of these states give rise to moving from one H matrix to another, sometimes at the rate of the harmonic blocks (i.e., very quickly, less than a second).

In practice, the point of all of this is that for first pass solutions, implementers may need to be quite cognizant of these additional sources of errors due to omnipath, and either just live with them and build them into the empirical-based error specifications for an application, or look toward the cocktail of post-first-linear solution approaches to further mitigating their propagated errors.

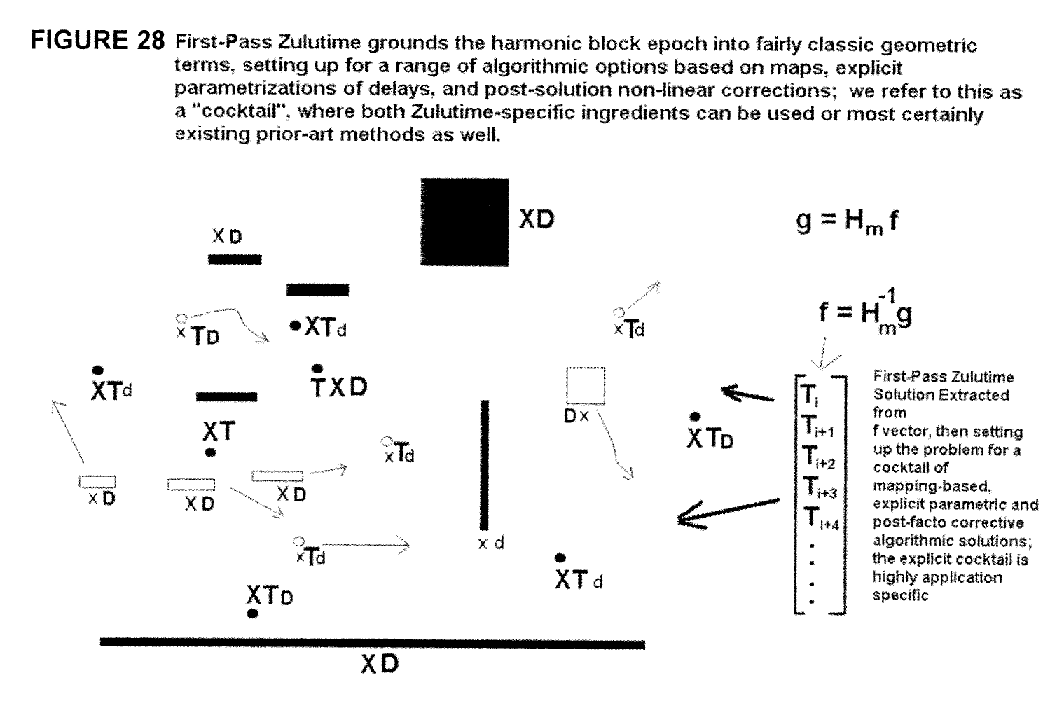

FIG. 28 gets us to the promised land already laid out in FIG. 25: the previously described first stage processes are improving timing understanding by typically several orders of magnitude over and above the fairly crude synchronizations built into common consumer grade network communication equipment such as 802.11. The existing synchronization methods in commercial networks have been designed primarily to facilitate packet ordering and minimizing communication collisions, not for positioning applications and certainly not having anything whatsoever to do with multipath/omnipath distortions. The text in FIG. 28 is meant to be self-explanatory and the reader is encouraged to go through these comments at this point in this disclosure.

Physical demonstrations have shown that even in environments with fairly extensive omnipath distortions, single-digit nanosecond DZT measurements can nevertheless be produced by common consumer grade devices in highly dynamic situations, using the approach outlined in this disclosure thus far and as described in the related disclosures. This improvement in timing can itself form the basis for direct range-based algorithms where each singular ping from any node to any other can be seen as a relatively noisy and distorted pseudo-range data point between one node and another. The second descriptor “distorted” in this last sentence directly refers, primarily, to unknown multipath effects (where for the sake of this discussion, we can assume that a given receiving RX node has a relatively stable, known and therefore removable fixed RX delay).

GPS Approaches

Having thus far outlined the general analytic properties of multipath and omnipath distortions and their relationships to timing measurements within arbitrary environments, the disclosure now takes a step back to examine in more detail the art of dealing with multipath effects within GPS receivers and the GPS system as a whole, while at the same time taking a step forward to outline how some of these approaches can be modified for more complicated and arbitrary communications networks. Many of the basic physics principles are of course the same, but require specific modifications for omnipath environments rarely seen in GPS situations.

The Multipath Problem in GPS

Both GPS and ZuluTime obtain estimates of position by measuring the propagation time of radio signals from various points to other points in space. In GPS a number of satellites with known locations transmit one-way signals to a receiver, which measures the signal arrival time from each satellite. Each satellite sends data which provides the signal transmission time and the location of the satellite at that time. By measuring the arrival time of each satellite signal containing a wide-bandwidth spread-spectrum code (such as the widely used C/A code), the receiver can compute the relative signal propagation delays (hence relative ranges) from all satellites and use them to compute the position of the receiver using a process often loosely called “triangulation.”

However, errors in positioning occur if there are errors in measuring the signal arrival time. Objects in the vicinity of the receiver antenna, such as buildings or even the ground, can easily reflect GPS signals, resulting in one or more secondary propagation paths. These secondary path signals, which are additively superimposed on the desired direct-path signal, always have a larger propagation time and can significantly distort the amplitude and phase of the direct-path signal. In a GPS receiver without multipath protection, this can cause range errors of 10 meters or more, which can translate to positioning errors as large as 40 meters or more, depending on satellite-receiver geometry.

Multipath not only causes errors in the measurement of range using the GPS spread-spectrum code, but it can severely degrade the ambiguity resolution process required in another method of ranging using the carrier phase of the GPS signal.

Multipath propagation can be divided into two classes: static and dynamic. For a stationary GPS receiver, the propagation geometry changes slowly as the satellites move across the sky, making the multipath parameters essentially constant for perhaps several minutes. However, in mobile applications there can be rapid fluctuations in fractions of a second. Most past research has focused on static applications, such as surveying, where greater demand for high accuracy exists. However, the expansion of high-accuracy requirements into mobile applications is rapidly altering the situation.

How Multipath Causes Ranging Errors

A typical GPS receiver downconverts the frequency of the received signal to a baseband signal at zero frequency. In the absence of multipath the baseband signal has the form

r(t)=ae^{jφ}c(t−τ), (2)

where c(t) is the amplitude-normalized, undelayed spread-spectrum code as transmitted, τ is the signal propagation delay, a is the signal amplitude, and φ is the carrier phase. For purposes of simplification we have omitted the noise on the signal, as well as any data modulation. Range estimation consists of estimating the delay parameter τ, which is accomplished in almost all GPS receivers by forming the cross-correlation function

R(τ)=∫_{T}_{₁}^{T}^{₂}r(t)cᵣ(t−τ)dt (3)

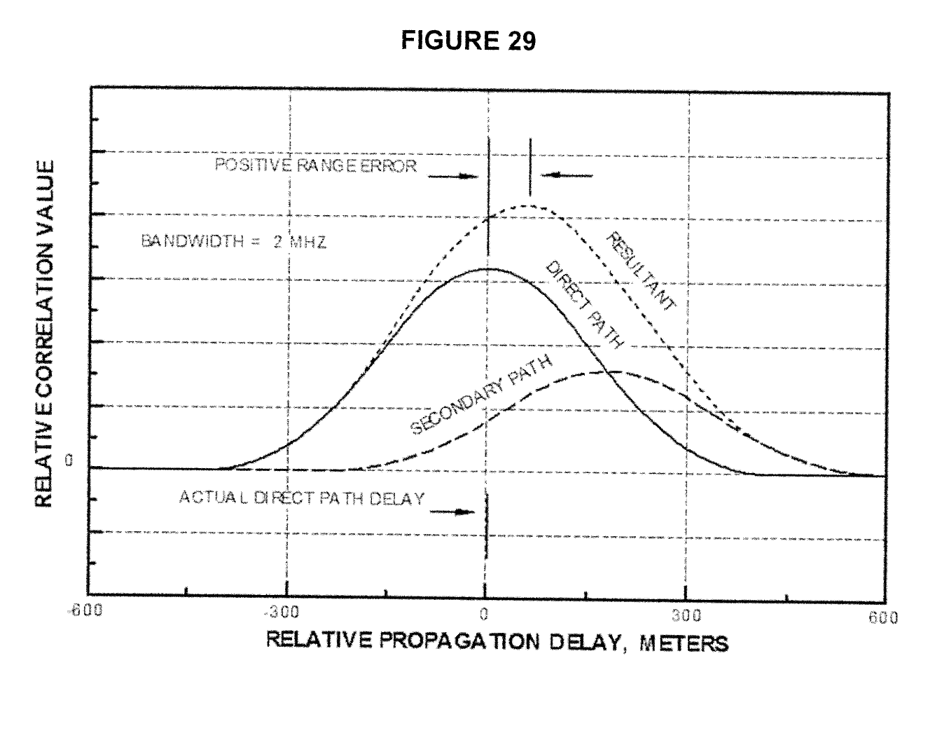

of r(t) with a replica Cᵣ(t) of the transmitted spread-spectrum code and choosing as the delay estimate that value of τ which maximizes the magnitude of this function. Without noise this occurs when the received and replica codes are in time alignment. Cross-correlation is used because under suitable assumptions it is optimal according to estimation theory. A typical noiseless cross-correlation function without multipath for C/A code receivers having a 2 MHz precorrelation bandwidth is shown by the solid curve in FIG. 29, when the signal arrives via the direct path only.

If multipath is present with a single secondary propagation path, the waveform of expression (2) changes to

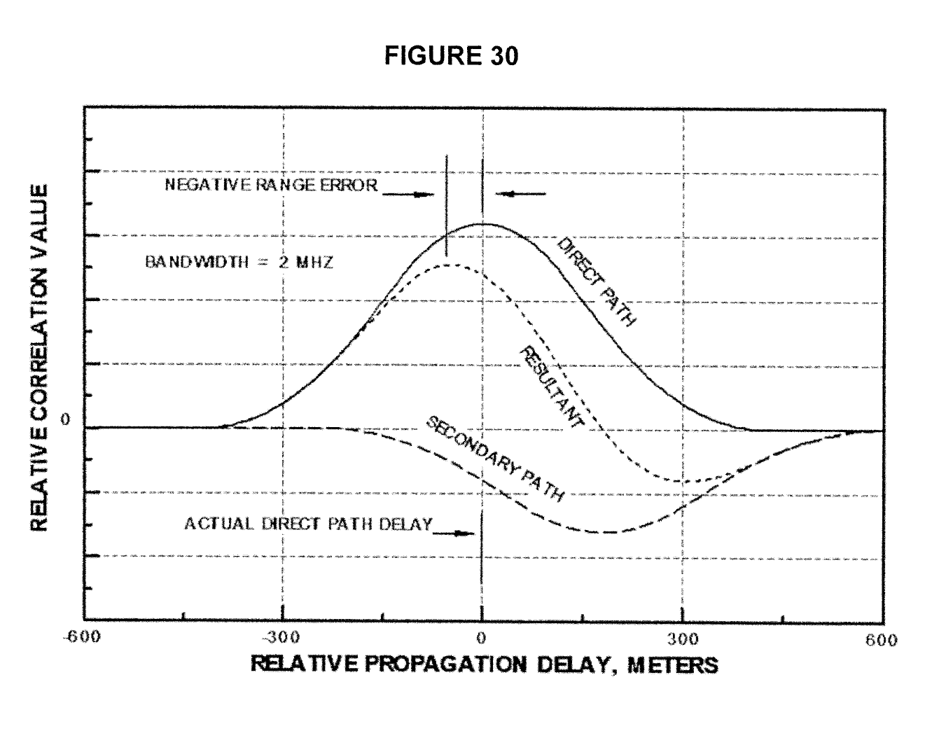

r(t)=ae^{jφ}^{₁}c(t−τ₁)+be^{jφ}^{₂}c(t−τ₂)(4)

where the direct and secondary path signals have respective delays τ₁ and τ₂, amplitudes a and b, and phases φ₁ and φ₂. In a receiver not designed to mitigate multipath, the resulting cross-correlation function will now have two additively superimposed components, one from the direct path and one from the secondary path. The result is a function with a distortion depending on the relative amplitude, delay, and phase of the secondary path signal, as illustrated in FIG. 29 for an in-phase secondary path and in FIG. 30 for an out-of-phase secondary path. The location of the peak magnitude of the function has been displaced from its correct position, causing a ranging error.

The Role of Signal Bandwidth

Regardless of the methods employed, reduction of multipath error depends on the bandwidth of the received signal. For best results, the bandwidth should be as large as possible, since this increases the ability to separate signal components with different delays. Although in GPS the designed bandwidth of the transmitted signal cannot be changed, the receiver bandwidth can be made wide enough to accommodate the full signal bandwidth. However, there are costs, which include higher sampling rates, greater power consumption, and increased susceptibility to interfering signals. With better multipath mitigation as a goal, the newer GPS signals, such as the L₅ and the military M-coded signals have been designed with a wider bandwidth than the legacy L₁ signals.

The Challenge of Close-in Multipath

Close-in multipath, in which at least one secondary path has a small delay relative to the direct path (less than approximately 100 nanoseconds), poses the greatest problem in effective multipath mitigation for two reasons: (1) Extraction of the direct-path delay from such a signal is an ill-conditioned parameter estimation problem, i.e., it is difficult to accurately separate the direct-path component from secondary components, and (2) Close-in secondary components tend to have a larger received power level compared to far-out components.

GPS Spatial Methods of Multipath Mitigation

Antenna Location Strategy: If the application permits, the receiver antenna can be located where it is less likely to receive reflected signals. For example, it can be located in a large area free of any structures, and can be placed directly at ground level to eliminate ground reflections. This is a constraint that is unacceptable in many applications.

Groundplane Antennas: Secondary path signals reflected from the ground can be reduced by using a metallic groundplane disc centered at the base of the antenna to shield the antenna from below. However, performance is somewhat compromised, because surface waves can be induced on top of the disk when the signal wavefronts arrive from below. The surface waves can be largely eliminated by replacing the groundplane with a choke ring, which is essentially a groundplane containing a series of concentric circular troughs one-quarter wavelength deep. However, the size, weight, and cost of a choke-ring antenna is significantly greater than that of simpler designs. The choke ring cannot effectively attenuate secondary-path signals arriving from above the horizontal, such as those reflecting from buildings or other structures.

Directive Antenna Arrays: A more advanced form of spatial processing uses antenna arrays to form a highly directive spatial response pattern with high gain in the direction of the direct-path signal and attenuation in directions from which secondary-path signals arrive. However, because signals from different satellites have different directions of arrival and different multipath geometries, many directivity patterns must be simultaneously operative, and each must be capable of adapting to changing geometries caused by satellite motion. For these reasons, directive antenna arrays seldom are practical for most applications.

Long-Term Signal Observation: If a GPS signal is observed for sizable fractions of an hour to several hours, changes in multipath geometry caused by satellite motion will cause changes in the relative phase of the direct and secondary path signals. By measuring the resulting variations of the phase and amplitude of the received signal, it is sometimes possible to extract the direct-path signal component. However, the requirement of long periods of signal observation is unacceptable in many applications.

GPS Receiver-Based Methods of Multipath Mitigation

Most of the practical approaches for GPS multipath mitigation employ special forms of signal processing within the receiver that have been developed by receiver manufacturers. To better understand these methods, recall that to make a range measurement, a GPS receiver must accurately locate the peak magnitude of the cross-correlation between the received spread-spectrum code and a receiver-generated reference code. To obtain continuous range measurements, the GPS receiver must be able to track this peak continuously in time. The standard tracking method is to generate an early, prompt (or central), and late version of the reference code and cross-correlate each against the received signal. The resulting early and late correlator output magnitudes are subtracted to form a code tracking error signal, and a code tracking loop utilizes the error signal to keep the prompt code in alignment with the received code. The time delay between the early and late reference codes is called the correlator spacing, which is usually expressed in terms of chips of the spread-spectrum code.

The following receiver-based multipath mitigation methods are mostly attempts to reduce errors in ranging using the received spread-spectrum code, and with one exception do not provide significant improvements in carrier phase measurements.

Narrow Correlator Technology (1990-1993): The first significant means to reduce GPS multipath effects by receiver processing was introduced in the early 1990's. Until that time, most GPS receivers had been designed with a 2 MHz precorrelation bandwidth that encompassed most, but not all, of the GPS spread-spectrum signal power. These receivers also used one-chip spacing between the early and late reference codes. However, a 1992 paper (A. J. Van Dierendonck, P. Fenton, and T. Ford, “Theory and Performance of Narrow Correlator Spacing in a GPS Receiver,” Proceedings of the National Technical Meeting, Institute of Navigation, San Diego, Calif., 1992, pp. 115-124) showed that using a significantly larger precorrelation bandwidth combined with a much smaller correlator spacing would dramatically reduce ranging accuracy both with and without multipath.

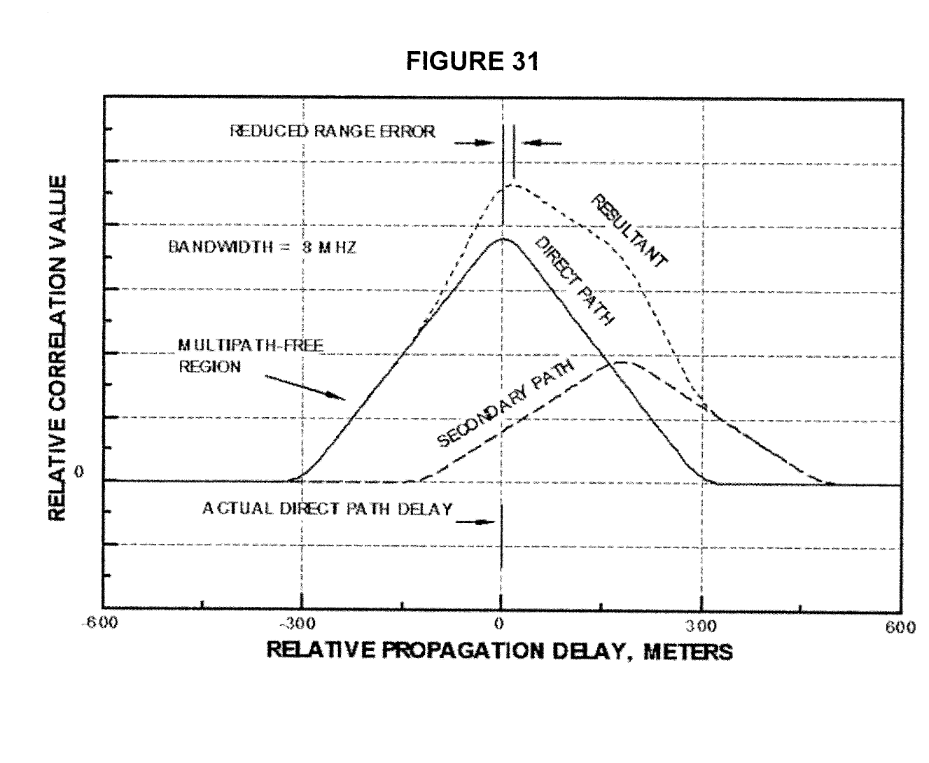

A 2 MHz precorrelation bandwidth causes the peak of the direct-path correlation function to be severely rounded, as we have seen in FIGS. 29 and 30 (solid curves). Consequently, the sloping sides of a secondary-path component of the correlation function can significantly shift the location of the peak, as indicated in FIGS. 29 and 30. The result of using a larger 8 MHz bandwidth is shown in FIG. 31, where it can be noted that the sharper peak of the direct-path correlation function component is less easily shifted by the secondary path component. It can also be shown that the larger bandwidth makes the peak location less affected by receiver thermal noise. This seems counterintuitive, since the wider bandwidth reduces the signal-to-noise ratio (SNR) prior to correlation.

Another advantage of a larger precorrelation bandwidth is that the correlator spacing between the early and late reference codes can be made smaller without significantly reducing the gain of the code tracking loop; hence the term narrow correlator. It can be shown that this causes the noises on the early and late correlator outputs to become more highly correlated, resulting in less noise on the loop error signal. An additional benefit is that the code tracking loop will be affected only by the multipath-induced distortions near the peak of the correlation function.

Correlation Function Leading-Edge Techniques: Since the direct-path signal always precedes secondary-path signals, a leading (left-hand) portion of the correlation function is uncontaminated by multipath, as illustrated in FIG. 31. The detection of the leading edge is normally accomplished by the crossing of a small positive threshold. If one could measure the location of just this leading part, all multipath error could be eliminated. Unfortunately, the situation is not so simple. With a small direct-to-secondary path separation, the uncontaminated portion of the correlation function is a miniscule piece at the extreme left, where the curve just begins to rise. In this region, not only is the SNR relatively poor for GPS signals, but the slope of the curve is also relatively small, which can severely degrade the accuracy of delay estimation.

For these reasons, in GPS applications the leading-edge approach best suits situations with a moderate to large direct-to-secondary path separation. However, even in these cases one must make the delay measurement insensitive to the slope of the correlation function leading edge, which can vary with signal strength. Such a problem does not exist in measuring the location of the correlation function peak.

There are applications other than GPS where the received signal power is orders of magnitude greater than that of a GPS signal. In these applications, such as the ZuluTime network, leading edge techniques might be effective, and will be discussed in more detail later.

Correlation Function Shape-Based Methods: Some GPS receiver designers have attempted to determine the parameters of the multipath signal from the shape of the correlation function. For best results, many correlations with different values of reference code delay are generally needed to obtain an estimate of the function shape. There is a practical difficulty of mapping each of the many possible shape distortions into a corresponding accurate direct-path delay estimate. Even in the simple two-path model of expression (4) there are six signal parameters, so a very large number of shape distortions must be handled.

An example of a heuristically developed shape-based approach called the early-late slope method (ELS) can be found in B. Townsend and P. Fenton, “A Practical Approach to the Reduction of Pseudorange Multipath Errors in a L1 GPS Receiver,” Proceedings of ION GPS-94, the 7th International Technical Meeting of the Satellite Division of the Institute of Navigation (Salt Lake City, Utah), ION, Alexandria, Va., 1994, pp. 143-148; and a method based on maximum-likelihood estimation called the multipath-estimating delay-lock loop (MEDLL) is described in B. Townsend, D. J. R. Van Nee, P. Fenton, and K. Van Dierendonck, “Performance Evaluation of the Multipath Estimating Delay Lock Loop,” Proceedings of the National Technical Meeting, Institute of Navigation, Anaheim, Calif., 1995, pp. 277-283.

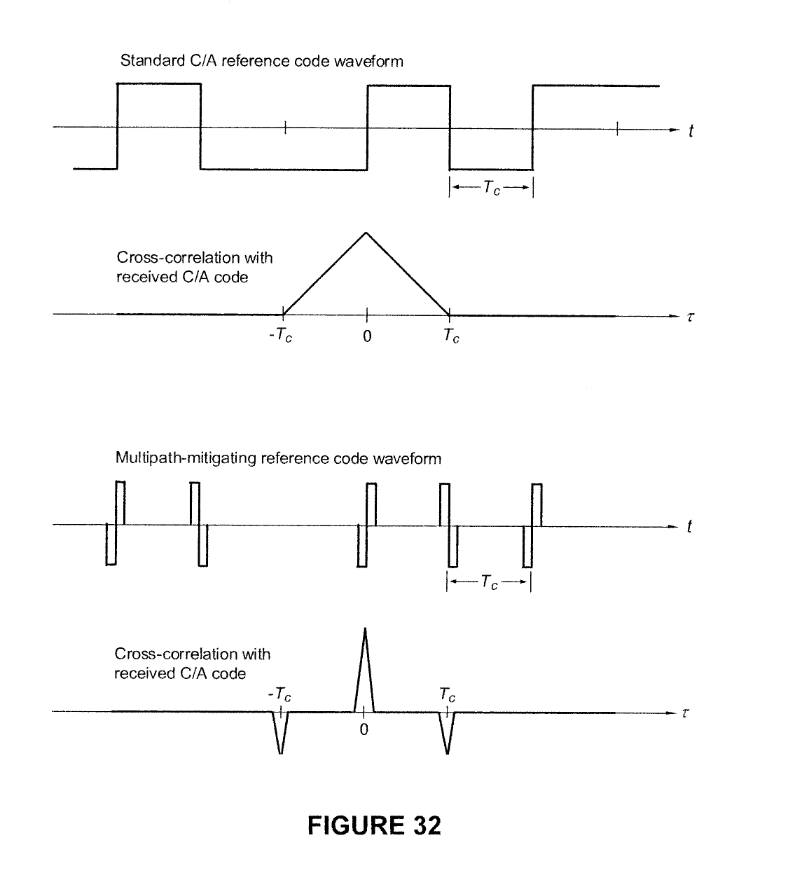

Modified Correlator Reference Waveforms: Undoubtedly the most practical and popular method of GPS receiver-based multipath mitigation, which first appeared in 1996, is alteration of the receiver-generated correlator reference code to provide a cross-correlation function with inherent resistance to errors caused by multipath. Examples of this technique include the strobe correlator, see L. Garin, F. van Diggelen, and J. Rousseau, “Strobe and Edge Correlator Multipath Mitigation for Code,” Proceedings of ION GPS-96, the 9th International Technical Meeting of the Satellite Division of the Institute of Navigation (Kansas City, Mo.), ION, Alexandria, Va., 1996, pp. 657-664; the use of second derivative code reference waveforms described in L. Weill, “GPS Multipath Mitigation by Means of Correlator Reference Waveform Design,” Proceedings of the National Technical Meeting, Institute of Navigation (Santa Monica, Calif.), January 1997, ION, Alexandria, Va., pp. 197-206; and L. Weill, “Application of Superresolution Concepts to the GPS Multipath Problem,” Proceedings of the National Technical Meeting, Institute of Navigation (Long Beach, Calif.), 1998, ION, Alexandria, Va., pp. 673-682; and the gated correlator developed in G. McGraw and M. Braasch, “GNSS Multipath Mitigatiioon Using Gated and High Resolution Correlator Concepts,” Proceedings of the 1999 National Technical Meeting and 19th Biennial Guidance Test Symposium, Institute of Navigation, San Diego, Calif., 1999, pp. 333-342. These techniques, which are all basically similar, take advantage of the fact that the range information in the received GPS signal resides primarily in the polarity transitions of the received spread-spectrum code. By using a correlator reference waveform that is not responsive to the flat portions of the received code, the resulting cross-correlation function can be narrowed down to the width of a polarity transition, thereby being immune to multipath having a direct-to-secondary path separation greater than 30-40 meters. An example of such a reference waveform and the corresponding correlation function, as compared to the correlation function using a standard reference, is shown in FIG. 32 using idealized (infinite bandwidth) waveforms of the GPS C/A code.

Some advantages of multipath mitigation using modified correlator reference waveforms are simplicity and low cost, and for this reason many GPS receivers currently employ this technique. However, it is not particularly effective for close-in multipath, in which the direct-to-secondary path separation is small. Later, more will be said about the difficulties engendered by close-in multipath.

Maximum Likelihood (ML) Multipath Parameter Estimation: Because ML estimation has certain optimality properties, some of the latest approaches to GPS multipath mitigation are based on ML theory. For a top-level example of the basic ML approach, we again consider the simple 2-path signal model of expression (4), but this time we include the noise n(t), which is a stationary additive zero-mean complex Gaussian noise process with flat power spectral density:

r(t)=ae^{jφ}^{₁}c(t−τ₁)+be^{jφ}^{₂}c(t−τ₂)+n(t). (5)

In this model the signal parameters are the same as previously described following expression (4). It will be convenient to group the signal parameters into the vector

θ=[a,φ₁,τ₁,b,φ₂,φ₂,τ₂]. (6)

Observation of the received signal is accomplished by sampling it over a time interval [T₁,T₂] to produce a complex observed vector r, which is a random vector because of the noise n(t). The observation interval length T₂−T₁ is typically on the order of 1 second.

The ML estimate of the six signal parameters is the vector \hat{θ} of parameter values that maximizes the likelihood function p(r|θ), which is the probability density of the received signal vector conditioned on the values of the six signal parameters. In this maximization the vector r is held fixed at its observed value. Within the vector \hat{θ} the estimates \hat{τ}₁ and \hat{φ}₁ of direct-path delay and carrier phase are normally the only ones of interest for the purpose of multipath mitigation. However, the ML estimates of these parameters requires that the likelihood function p(r|θ) be maximized over the six-dimensional space of all multipath parameters (components of θ). For this reason the unwanted parameters are called nuisance parameters.

Since the natural logarithm is a strictly increasing function, the maximization of p (r|θ) is equivalent to maximization of L(r; θ)=ln p(r|θ), which is called the log-likelihood function, and in this application is simpler than the likelihood function itself.

Maximization of L(r; θ) can be a daunting task, because in this particular application it is a highly nonlinear function of the signal parameters. Even for the simple two-path propagation model, a brute-force search over the six-dimensional parameter space takes too long to be of practical value. Other well-known methods, based on gradient search, iteration, or maximization using calculus are either too slow, fail to converge, or find only a local maximum and not a global one. This is the main reason that historically, ML methods for multipath mitigation have not gained much acceptance. However, recent progress has been made in solving this difficulty. One example is the Multipath Mitigation Technology (MMT) ML estimator described in M. S. Grewal, L. R. Weill, and A. P. Andrews, Global Positioning Systems, Inertial Navigation, and Integration, Second Edition, John Wiley & Sons, New Jersey, 2007, pp. 172-183; and B. Fisher and L. R. Weill, Method for Mitigating Multipath Effects in Radio Ranging Systems, U.S. Pat. No. 6,031,881, Feb. 29, 2000, which uses an invertible transformation to linearize the amplitude and phase parameters. For the two-path model the log-likelihood function then becomes purely quadratic in four out of the six signal parameters and can be maximized with respect to these parameters by solving a linear system of equations. Thus, a search in 6 dimensions is reduced to a search in only two dimensions (τ₁ and τ₂). A similar reduction in computation occurs for signal models having more than two paths.

A virtue of the ML method is that it is capable of significantly better performance than any of the previous methods described, especially with close-in multipath. Under suitable assumptions it can be shown that no method of multipath mitigation can provide uniformly better results than the ML method. Another advantage is that ML estimation mitigates errors in both code and carrier-phase range measurements. Yet another advantage is that unlike most of the other multipath mitigation methods, ML performance improves with increased SNR, which can be obtained by increasing the processing gain of the receiver. The primary method of increasing the processing gain is to observe the received signal for a longer time interval. This is especially important in GPS applications because of the extremely low power levels of the received signals as compared to the receiver thermal noise level.

However, there are at least two useful disadvantages. First, the computation in maximizing the log-likelihood function can be onerous. Second, the performance of the ML method depends on an accurate multipath signal model, which basically means that the number of paths in the model must equal the number of paths that actually exist. If there is a mismatch in either direction, performance can degrade significantly. Some researchers have attempted to develop methods to estimate the number of paths, but this is also fraught with difficulties whose solution remains elusive. For example, suppose that diffuse multipath is present, where the path delays are not discrete, but instead are “smeared.” However, in many cases there is only one dominant secondary path (such as ground bounce), where a two-path model works well.

Performance Comparison of GPS Receiver-Based Methods

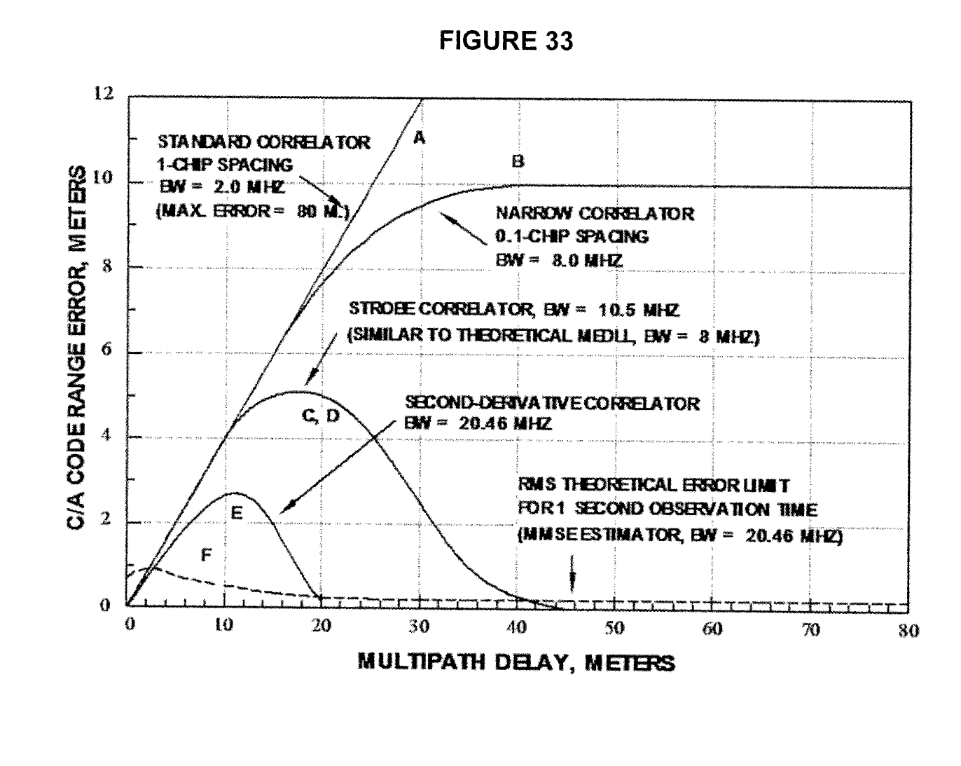

FIG. 33 compares the code ranging performance of several receiver-based multipath mitigation techniques for the case of a single secondary path having half the amplitude of the direct path and the same phase. The superiority of the ML estimator as implemented by MMT is clearly evident, especially for close-in multipath. However, elation must be tempered by the modeling problem just described.

Multipath Mitigation: Similarities and Differences Between GPS and ZuluTime

The following includes some differences between the GPS and ZuluTime systems disclosed herein:

1. GPS uses one-way transmission between a number of satellites and a receiver, whereas ZuluTime has a multiplicity of nodes with the capability of two-way transmission between subsets of them.

2. For the current GPS system the received power levels are very small (less than about −130 dBm) due to the large satellite-to-receiver distance (approximately 22,000 kilometers) and limited power generated at the satellites. Such low-level signals are OK (at least for most outdoor positioning scenarios) because the data rate is low (50 bits/second) and narrow-bandwidth tracking loops can be used to obtain high processing gain for code- and carrier phase-based range measurements. On the other hand, for ZuluTime the transmitted power levels are such that high-speed data can be transmitted over relatively short node-to-node distances. Received power levels should generally be much larger than for GPS—perhaps in excess of −70 dBm.

3. The transmitted RF bandwidth of the current GPS system (roughly 30 MHz) is significantly larger than what is anticipated for ZuluTime (roughly 1-2 MHz to support high-speed data transmission).

4. GPS imposes two types of modulation on the transmitted RF carrier. The first is the wide-bandwidth spread-spectrum code which, among other things, is specifically designed for accurate range measurement. The second is simple binary phase-shift keying (BPSK) modulation at a much lower bandwidth, which includes data essential for determining the satellite position at any time (ephemeris data). On the other hand, the wireless systems used by ZuluTime are mostly designed for high-speed data transmission rather than positioning, and may only have data modulation, such as multiphase or orthogonal frequency-division multiplexing (OFDM). Without the freedom to use different types of modulation, there would be a possible constraint on multipath mitigation performance.

5. The carrier frequencies in the ZuluTime network may be higher than for GPS.

Some impacts of these differences are as follows:

1A: ZuluTime Clock Synchronization

In GPS, a solution for accurate time at the receiver is part of the navigation solution, which amounts to synchronization of the receiver clock with GPS time, the highly accurate time from atomic clocks in the satellites. Here synchronization is defined as determining the time difference between GPS time and time obtained from a master clock oscillator in the receiver. In the GPS community synchronization is often called time transfer. Because signals travel only from the satellites to the receiver and not in the reverse direction, multipath will cause not only errors in determining receiver position, but also errors in clock synchronization. Since determination of accurate time at the receiver is an essential element in accuracy of positioning, time errors will dilute the accuracy of GPS positioning.

However, the availability of two-way signal transmission between at least some nodal pairs in the ZuluTime system can, at least theoretically, significantly reduce the impact of multipath on internodal time synchronization accuracy, with a concomitant reduction in positioning errors at the nodes.

Consider two nodes A and B having identical transceivers, which are linked by two-way radio transmission. Within each transceiver is a clock. We show that under suitable assumptions, multipath has no effect on the accuracy of time synchronization between these nodes. To simplify the analysis, it is assumed that the transmissions are pulses, but this can be extended to arbitrary waveforms. Also, thermal noise is ignored, since only the effects of multipath are of interest. The symbols t and u will denote time as measured by the clocks at respective nodes A and B. The node A and node B clocks will respectively be called clock A and clock B. At any given time t observed on clock A, the difference in time observed on the two clocks at that instant is

e(t)=u−t. (7)

Note that e(t) is expressed in terms of node A time, and can vary with t.

Suppose that node A transmits a pulse at time t₁ on its clock, and t₁ is recorded. The arrival of the pulse at node B is detected at time t₂, but the arrival time according to the node B clock is recorded as u₂ at that same moment. Now suppose that node B has the capability transmitting a pulse at exactly the same time it receives the pulse from node A, that is, it transmits a pulse at time t₂ (note that it is not necessary for node B to transmit a pulse at exactly the same time that it receives the pulse from node A, as long as the delay is known and is relatively short). The pulse is received by node A at time t₃, and t₃ is recorded.

The difference between times t₁ and t₂ for the forward transmission is

$${t}_{2} - {t}_{1} = \frac{d}{c} + ɛ , \qquad ( 8 )$$

where d is the distance between the nodes, c is the speed of light, and ε is a bias error due to multipath in combination with the receiver measurement characteristics.

Assuming identical measurement characteristics in the two transceivers, the bias error for the forward and reverse transmissions is the same. This is guaranteed by the Law of Reciprocity in radio propagation, which says that the transfer function of the propagation path is the same in either direction, so that multipath characteristics are likewise the same. Thus, the difference between times t₂ and t₃ for the reverse transmission is

$${t}_{3} - {t}_{2} = \frac{d}{c} + ɛ , \qquad ( 9 )$$

which is the same as that of the forward transmission, that is,

t₂−t₁=t₃−t₂. (10)

Solving for t₂, we obtain

$${t}_{2} = \frac{{t}_{1} + {t}_{3}}{2} . \qquad ( 11 )$$

Since the time of arrival t₂ of the pulse in the forward transmission was recorded as u₂ according to the node B clock, from (2) we have

e(t₂)=u₂−t₂. (12)

Since t₁, u₂, and t₃ have been recorded, t₂ is now known from (11), and (12) gives the difference in times on the two clocks at known time t₂ on clock A. Of course, there needs to be a way to transmit the recorded times to the location where the calculation of e(t₂) takes place. For example, if the calculation takes place at node A, the value of u₂ needs to be sent from node B to node A. However, this should not be a problem, since it is merely data transmission by radio.

Note that e(t₂) can be calculated even if the clocks at the two nodes have different rates.

Determining Difference in Clock Rates: The difference in clock rates at the two nodes is readily obtained by repeating the above process a second time. In this case the recorded times would be t₄, u₅, and t₆. The time t₅ would be calculated by

$$\begin{matrix}{t}_{5} = \frac{{t}_{4} + {t}_{6}}{2} \\ and & ( 13 ) \\ e ( {t}_{5} ) = {u}_{5} - {t}_{5} . & ( 14 )\end{matrix}$$

The difference in clock rates would then be

$$\frac{e ( {t}_{5} ) - e ( {t}_{2} )}{{t}_{5} - {t}_{2}} seconds \text{/} second , \qquad ( 15 )$$

where time in the denominator is measured using clock A. This method assumes that both clocks have negligible frequency variation over the time interval from t₁ to t₆. Since a typical time interval over which measurements establishing internodal distance will probably not exceed 1 second, this seems to be a reasonable assumption.

Of course, another method of measuring difference in clock rates is to make frequency measurements using carrier transmissions, which might be preferable according to certain embodiments.

Thermal Noise: At the transmitted power levels and maximum internodal distances anticipated in the ZuluTime system, error in synchronizing the clocks at nodes A and B due to thermal noise in many cases should be relatively small, especially if large amounts of processing gain are possible.

Extension to Multiple Nodes: The results presented above can be extended to multiple nodes: If A₁, A₂, . . . A_{N} are nodes such that each of the node pairs (A₁, A₂), (A₂, A₃), (A₃, A₄), . . . (A_{N-1}, A_{N}) have two-way communication, then all N nodes can be mutually time-synchronized without errors due to multipath. Of course, this assumes that the change in the multipath environment for all nodes is negligible during the time that all signals are sent.

1B: Increased Positioning and Time Accuracy Due to Reduced System Error Sensitivity

The ability of the ZuluTime system to communicate node-to-node (sometimes in both directions) among a plurality of nodes offers an advantage over GPS in that the ratio of the number of possible node-to-node range measurements to the number of nodes can be made much larger than for GPS. If N nodes are communicating with each other and each makes a single range measurement to every other node, the maximum possible number M of range measurements is given by

$$M = 2 ( \begin{matrix}N \\ 2\end{matrix} ) = 2 \frac{N !}{2 ! ( N - 2 ) !} . \qquad ( 16 )$$

For example, if there are N=6 nodes, then there are M=30 possible measurements. If the objective is to determine the three-dimensional positions of each of the 6 nodes, there will be 6×3=18 unknowns (an x, y, and z coordinate for each node), resulting in an overdetermined system of equations. In this case a minimum of 18 equations would be required for a unique solution, assuming that time synchronization of all the nodes has already been achieved (with two-way communication between every node pair, multipath causes no error in the time synchronization, at least theoretically). Assuming that the measurement errors are uncorrelated, zero-mean, and have the same variance, the additional equations (30−18=12 of them in this example) will generally result in a smaller positioning error at each node as compared to that using the minimum number of equations required.

If the positions of the nodes are obtained by linearized least-squares estimation, a quantitative measure of reduction in position error can be obtained. To illustrate this, assume that positioning is two-dimensional for simplicity (the analysis carries over directly to three dimensions). Let the position of the k^{th} node be specified by the vector

$${p}_{k} = [ \begin{matrix}{x}_{k} \\ {y}_{k}\end{matrix} ] . \qquad ( 17 )$$

Combine the positions of all N nodes into the single column vector (the multi-node position vector)

$$p = [ \begin{matrix}{p}_{1} \\ {p}_{2} \\ ⋮ \\ {p}_{N}\end{matrix} ] . \qquad ( 18 )$$

Let the range measurement obtained by a transmission from node j to node k be denoted by ρⱼₖ, a scalar. In this measurement the receiver at node k is measuring the time of arrival of a signal transmitted from node j. Arrange all of these range measurements in the single column vector (the measurement vector)

$$ρ = [ \begin{matrix}{ρ}_{12} \\ {ρ}_{21} \\ {ρ}_{13} \\ ⋮ \\ {ρ}_{( N - 1 ) N} \\ {ρ}_{N ( N - 1 )}\end{matrix} ] , \qquad ( 19 )$$

where it is understood that some range measurements may not occur. The basic linearized equation to be solved to estimate the positions of the nodes p from the set of measurements ρ is

ρ≈Ap, (20)

where A is the matrix consisting of the partial derivatives of the range measurements with respect to the x and y node coordinates evaluated at a base position vector p₀, and the vectors ρ and p are respectively small displacements of the measurement and position vectors from their values at p₀. For example, the first two rows of A, which respectively pertain to the first and second range measurements ρ₁₂ and ρ₂₁, are

$$\begin{matrix}\begin{matrix}\frac{\partial {ρ}_{12}}{\partial {x}_{1}} & \frac{\partial {ρ}_{12}}{\partial {y}_{1}} & \frac{\partial {ρ}_{12}}{\partial {x}_{2}} & \frac{\partial {ρ}_{12}}{\partial {y}_{2}} & 0 & 0 & … & 0\end{matrix} \\ and & ( 21 ) \\ \begin{matrix}\frac{\partial {ρ}_{21}}{\partial {x}_{1}} & \frac{\partial {ρ}_{21}}{\partial {y}_{1}} & \frac{\partial {ρ}_{21}}{\partial {x}_{2}} & \frac{\partial {ρ}_{21}}{\partial {y}_{2}} & 0 & 0 & … & 0.\end{matrix} & ( 22 )\end{matrix}$$

The number of columns in A is twice the number N of nodes (to accommodate the two coordinates of each node), and the number of rows is equal to the number of measurements.

The well-known linear least-squares solution to equation (20), assuming a unique solution exists, is

p=(A^{T}A)⁻¹A^{T}τ, (23)

where A^{T}A is a symmetric positive definite matrix.

Assuming that the measurement errors in the components of p are uncorrelated zero-mean random variables with common variance σ², the covariance matrix of the resulting position error components is

$$\begin{matrix}{C}_{p} = E ( {pp}^{T} ) = E [ {( {A}^{T} A )}^{- 1} {A}^{T} ρ {ρ}^{T} {A ( {A}^{T} A )}^{- T} ] \\ = {( {A}^{T} A )}^{- 1} {A}^{T} E ( ρ {ρ}^{T} ) {A ( {A}^{T} A )}^{- 1} \\ = {( {A}^{T} A )}^{- 1} {A}^{T} ( {σ}^{2} I ) {A ( {A}^{T} A )}^{- 1} \\ = {{σ}^{2} ( {A}^{T} A )}^{- 1} {A}^{T} {A ( {A}^{T} A )}^{- 1} \\ = {{σ}^{2} ( {A}^{T} A )}^{- 1} .\end{matrix} \qquad ( 24 )$$

Expression (24) can be used to give a relationship between measurement errors and position errors by normalizing σ², i.e., setting σ²=1. In GPS this relationship is called dilution of precision (DOP), given by

DOP=\sqrt{c₁₁²+c₂₂²+ . . . +c_{NN}²}, (250

which is just the square root of the sum of squares of the diagonal elements of Cₚ. In the ZuluTime application a more meaningful relationship might be called system error sensitivity (SES) for the position of a specific node, given by

SES for node n=\sqrt{cᵢᵢ²+cⱼⱼ²+cₖₖ²}, (26)

where the elements cᵢᵢ, Cⱼⱼ, and cₖₖ are the diagonal elements of Cₚ which are respectively the variances of the x, y and z coordinates in the solution for the position of node n.

Now suppose we throw in additional measurements whose errors are zero-mean, uncorrelated among themselves and also uncorrelated with the original measurement errors, and have the same variance σ². The matrix A now changes to the augmented matrix

$$\tilde{A} = [ \frac{A}{B} ] , \qquad ( 27 )$$

and the covariance matrix of the position error components becomes

$$\begin{matrix}{\tilde{C}}_{p} = {{σ}^{2} ( {\tilde{A}}^{T} \tilde{A} )}^{- 1} \\ = {{σ}^{2} ( {[ \frac{A}{B} ]}^{T} [ \frac{A}{B} ] )}^{- 1} \\ = {{σ}^{2} ( {A}^{T} A + {B}^{T} B )}^{- 1} .\end{matrix} \qquad ( 28 )$$

It can readily be verified that

(A^{T}A+B^{T}B)⁻¹=(A^{T}A)⁻¹−(A^{T}A)⁻¹B^{T}[I+B(A^{T}A)⁻¹B^{T}]⁻¹B(A^{T}A) (29)

when the inverses exist, by left-multiplying both sides by A^{T}A+B^{T}B. Since A^{T}A is assumed to be positive definite, its inverse exists. Furthermore, I is certainly positive definite, and both B^{T}B and B(A^{T}A)⁻¹B^{T} are at least nonnegative definite, so A^{T}A+B^{T}B and I+B(A^{T}A)⁻¹B^{T} must be both be positive definite and have inverses.

Now the diagonal elements of (A^{T}A)⁻¹ are the variances, which are positive, of the position coordinates of the nodes resulting from the original set of measurements, and the diagonal elements of (A^{T}A+B^{T}B)⁻¹ are the variances, also positive, that result from including the extra measurements. If B has full column rank (linearly independent columns), it is easy to show that the product subtracted from (A^{T}A)⁻¹ in (29) has positive diagonal elements. In this case it follows that including the extra measurements reduces the variance of both coordinates of every node in the position solution. If B does not have full column rank, the extra measurements will at least reduce the variance of some coordinates, and can never increase the variance of any coordinate.

It should be kept in mind, however, that this conclusion is valid only under the assumption that the errors in the measurement components are zero-mean uncorrelated random variables with the same variance. Including a measurement which has a large error compared to the others can actually worsen the positioning accuracy. This problem will be discussed in a later section on consistency checking.

2: The Advantage of Higher Received Signal Power in Mitigating Multipath

Although an increase in received signal power can reduce the thermal noise error components in time synchronization and positioning, there is no material improvement in multipath mitigation performance of the most popular receiver-based mitigation methods developed for GPS, including narrow correlator technology, correlation function shape-based methods, and modified correlator reference waveforms, all of which have previously been discussed. The reason is that the residual range error using these methods is in the form of a bias which is not noise-induced.

There are two notable exceptions: (1) The performance multipath mitigation performance of correlation function leading edge techniques is quite sensitive to SNR. As the SNR increases, the leading edge of the correlation function can be detected just as reliably with a smaller threshold, thus decreasing the extent of the multipath-free portion of the function. Thus, rejection of the influence of secondary paths closer to the direct path can be accomplished. (2) The ML estimate of the direct path delay also improves with SNR, and in the limit it becomes a zero-error estimate as the SNR approaches infinity, assuming the underlying ML multipath model matches the actual situation.

Since the received power in the ZuluTime application will generally be much larger than in GPS, these two forms of multipath mitigation might offer considerably better performance than with GPS, assuming they can be adapted to the types of modulation already existing in wireless networks, or that there is freedom to add an additional type of modulation.

3: Bandwidth Considerations

The significantly smaller signal bandwidths of typical wireless networks used by ZuluTime as compared to GPS are a disadvantage in obtaining good multipath mitigation performance.

4: Modulation

Aside from signal bandwidth, the types of modulation used in the ZuluTime wireless networks has a likely impact on any receiver-based multipath mitigation method. The specific implications will not be clear until further analysis is performed.

5: Carrier Frequency

Radio signals with higher carrier frequencies that may exist in the ZuluTime network reflect from objects more easily, thus making multipath mitigation more difficult.

Aside from the differences between GPS and ZuluTime just described, the challenges of multipath mitigation are similar when GPS positioning is attempted indoors and in urban canyons. In this case both systems must be capable of dealing with severe multipath due to the presence of multiple reflecting objects.

Some Aspects of Multipath Mitigation for ZuluTime

Generally, the GPS spatial multipath mitigation techniques previously described are not suitable for ZuluTime because of cost, non-adaptibility for mobile nodes, or excessive required signal observation times. Most of the GPS receiver-based methods could be used. However, there are some special considerations for the ZuluTime application, which we now describe.

The Benefit of Reduced System Error Sensitivity

The ability of the ZuluTime system to provide significant reduction in system error sensitivity can materially aid in reducing the effects of multipath. With multiple nodes, the multipath-induced measurement errors are likely to have a certain node-to-node “randomness,” including some negative and some positive values. As previously described, an overdetermined position solution will tend to reduce the position error based on the measurements, as compared to using the minimum required number of measurements.

### Consistency Checking

Because the ratio of the number of equations to the number of unknowns in ZuluTime positioning can be made large, there is some capability to identify “outliers” in the range measurements likely to be caused by large multipath errors, and eliminate them from consideration. For least-squares estimation as described previously, this is easily done by observing the components of the residual vector

r=ρ−Ap=ρ−A(A^{T}A)⁻¹A^{T}ρ. (30)

One method of selecting which components of p to eliminate is to form the ratio of the magnitude of each component of r to the RMS residual

$${r}_{RMS} = \sqrt{\frac{1}{N} {‖ r ‖}^{2}} , \qquad ( 31 )$$

where N is the number of measurements, and ∥r∥ denotes the norm (length) of r. The measurements for which the ratio exceeds a predetermined threshold are eliminated, and then a new solution for position is computed.

It is also possible to improve consistency checking for mobile nodes by keeping a record of the residuals over time as position solutions are updated. If the residual of a particular measurement is sufficiently large compared to those of previous corresponding measurements, that measurement can be eliminated from the solution for the current position update.

Signal Compression

As has been mentioned previously, optimal measurement of range without multipath requires cross-correlation of a received waveform with a receiver-generated replica (the reference waveform) of the received waveform. Most GPS multipath mitigation methods still involve this cross-correlation process, which provides a large amount of processing gain to combat thermal noise. The generation of a reference waveform implies that the received waveform is known. In GPS the known received waveform is a pseudorandom code (the C/A code for most GPS receivers in current use), which has much wider bandwidth than the data modulation.

However, in the ZuluTime application there may be only high-bandwidth data modulation on the signal. The transmission of such data implies that over time intervals long enough to obtain processing gain, the entire waveform is not predictable. However, the waveforms of the individual symbols in the data stream are known, except for parameters such as amplitude, frequency, or phase. To make use of such signals to measure range, a process called signal compression may be employed. Signal compression may also be applied in global navigation satellite systems (GNSS's), which includes GPS, to reduce the amount of computation in generating correlation functions. See, L. Weill, “Theory and Application of Signal Compression in GNSS Receivers,” Proceedings of ION GNSS-2007, the 20th International Technical Meeting of the Satellite Division of the Institute of Navigation (Fort Worth, Tex.) September 2007, ION, Alexandria, Va., pp. 708-719 (hereinafter, “Weill”).

For simplicity, we describe signal compression for BPSK modulation, in which there is only one symbol waveform with a phase of 0 or 180 degrees, the phase generating one binary bit of information per symbol. Each symbol waveform is a rectangular pulse which has been filtered to some extent both in transmission and reception. All such waveforms have the same length T_{b}.

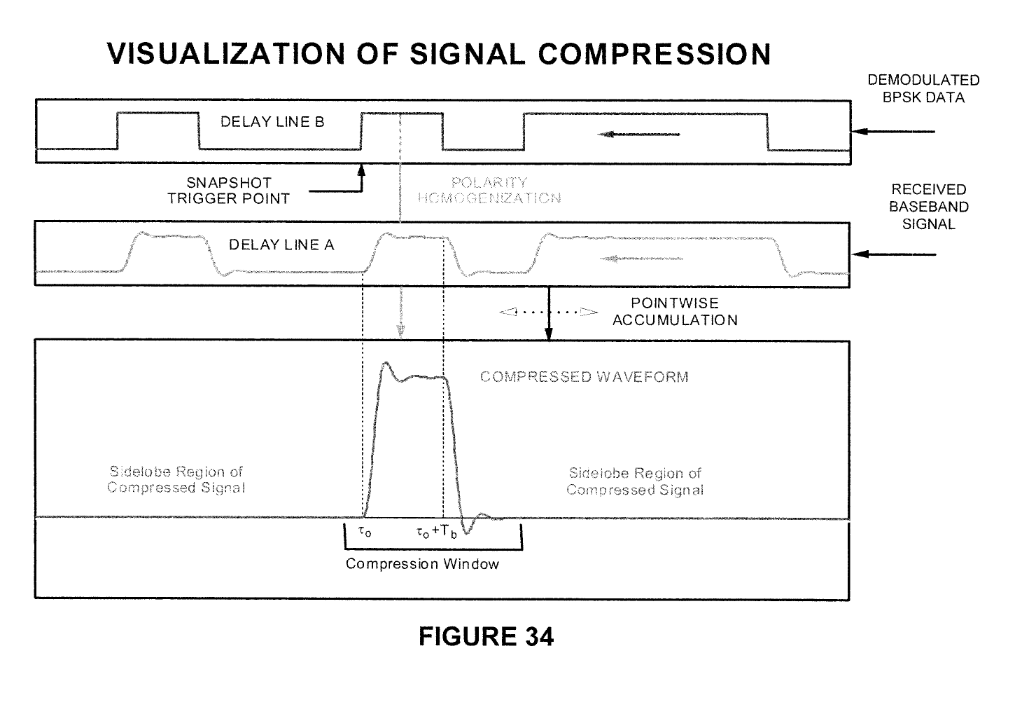

Referring to FIG. 34, we can visualize compression by thinking of the received baseband signal as passing through a delay line A, which is several data bits in length (for clarity, the noise is omitted). The signal enters the delay line from the right and moves to the left (this permits the waveform within the delay line to be seen as if it were displayed on an oscilloscope, with later parts of the waveform on the right). Simultaneously, the receiver is demodulating the data bits, and these demodulated bits simultaneously pass through an identical delay line B, the center of which is called the trigger point. In order to have the demodulated and received bits line up as shown in FIG. 34, the input to delay line A has been delayed by one bit to allow the demodulator to extract the bit values.

As the leading edge of each demodulated bit in delay line B reaches the trigger point of delay line B, a snapshot is taken of the entire waveform in delay line A, and the polarity of the entire snapshot waveform is inverted if the triggering demodulated bit has negative polarity. The polarity-homogenized snapshots (one for each arriving data bit of the received signal) are pointwise accumulated to build up the compressed signal shown at the bottom of FIG. 34.

The compressed signal has the appearance of a single symbol waveform, but it will be at a much higher SNR than any single symbol in the received signal if the compression is performed over a sufficiently long time interval. It might be asked why there is very little response outside the single symbol waveform. If the modulation consists of independent random symbols, the polarity homogenization process at the trigger point causes symbol waveforms outside the compressed waveform to statistically cancel. Actual modulation will generally have enough “randomness” to effectively perform this cancellation.

The compressed waveform can now be used for measuring range by any of a variety of techniques. Because of its augmented SNR, compression can be used with multipath mitigation techniques that improve with increasing SNR. Compression preserves all range information, which is supported by the Compression Theorem described in Weill.

The compression process can readily be extended to other types of modulation in which there may be more than one symbol type. In this case, symbols of each type are separately compressed. This can be achieved because the receiver's demodulator inherently identifies each type of symbol. It is only necessary that the received signal have enough power for data demodulation with a reasonably small error probability.

A Leading Edge Technique for Multipath Mitigation

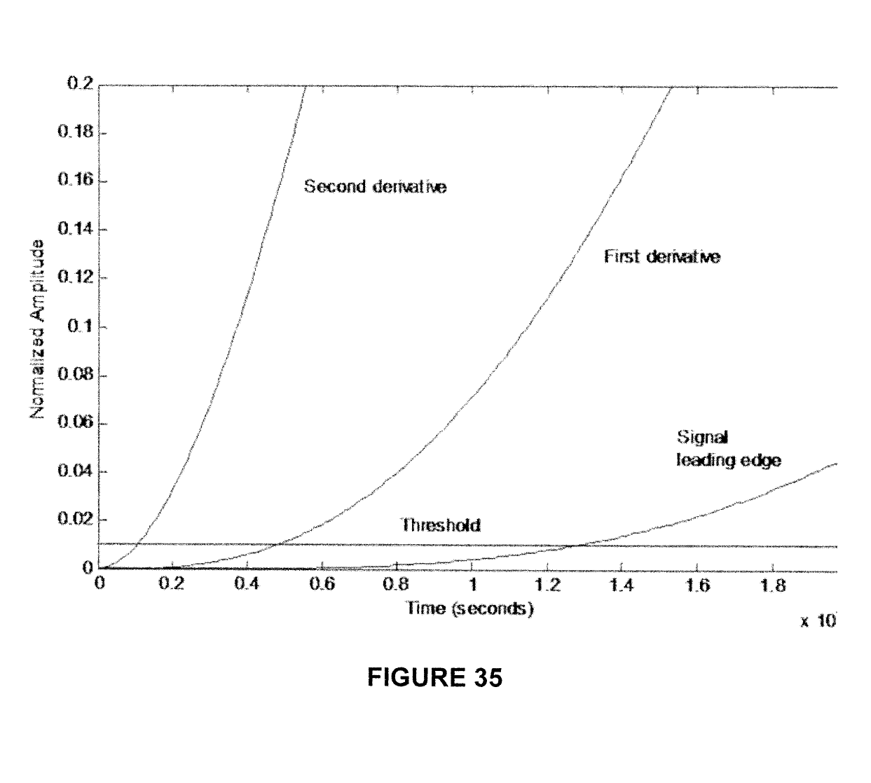

A relatively simple leading-edge technique for ZuluTime multipath mitigation may prove useful. It is enhanced by the signal compression process just described, and signal cross-correlation is not required. FIG. 35 shows the very first portion of the leading edge of a received pulse, as well as its first and second derivatives. The pulse could be the compressed signal shown in FIG. 34. Amplitudes have been normalized for visibility, and the bandwidth of the signal is 2 MHz. The leading edge actually begins at the time origin at the left end of the horizontal axis.

Suppose the signal arrival time is defined as the time at which the leading edge of the pulse crosses the threshold shown in FIG. 35. The crossing occurs at about 128 nanoseconds (38.4 meters) after the beginning of the pulse, which means that multipath signals exceeding this delay will not cause any errors.

The multipath-free region of the leading edge drops significantly if threshold crossing of derivatives of the pulse are used instead of the pulse itself. In FIG. 35 the first and second derivatives respectively cross the threshold at about 48 nanoseconds (14.4 meters) and 11 nanoseconds (3.3 meters), correspondingly giving better close-in multipath performance. Although the derivative operations increase the noise level, the slopes at the threshold crossing also become larger, acting in opposition to the decreased SNR.

One good reason for using signal compression to produce the pulse is the increase in SNR that results. This permits the threshold to be lowered, thus decreasing the size of the multipath-free region.

Taking Advantage of Mobile Node Multipath Characteristics

Due to the short carrier wavelength of typical wireless signals (on the order of 10-20 centimeters), a moving node will generally cause changing relative amplitudes and phases of secondary signal paths. In such situations, averaging or linear regression of the measurements over a predetermined time interval can reduce the multipath errors.

Network Generalizations of GPS-Like “Code Phase” and “Carrier Phase” Raw Data Introducing “Hard Pings” Versus “Waveform Pings”

A brief segue discussion is in order before outlining a variety of pseudo-range and delay solution approaches. This wide swath of solutions applies across a range of raw data production assumptions. Due to the extremely vast range of network types, such a generalization needs to be necessarily broad and sweeping.

A very well known distinction in raw data production has been handed down cleanly from the GPS world: the distinction between code-phase based data production and carrier-phase data production. It is well known that carrier-phase data has an innately higher data quality in pristine conditions, simply because it is derived from higher frequency components of arriving signals. Code-phase measurements on the other hand derive from much lower bandwidth “demodulated” signals. The original work in separating these two aspects of GPS signal measurement was focused on the sheer finer-scale timing measurements of the arrival of signals (nanosecond and sub-nanosecond scale for carrier phase; tens and hundreds of nanoseconds for code phase, generally speaking). However, as multipath-compensation techniques were developed for GPS, the distinction between code phase data and carrier phase data became increasingly important. A middle ground between the two, namely, so-called “I-Q waveforms” has become an important multipath raw data source, in that much of the phase and distortion effects from multipath are retained in post-demodulated waveforms.

This disclosure introduces a somewhat analogous difference in raw data sourcing for generalized networks, presented in the title to this section. “Hard Pings” refers to data sources where the count values associated with transmitted pings leaving a device and received pings arriving at a device are intimately tied to the symbol-encoding and symbol decoding logic of a device. Many of such count-stamping techniques have an innate lower-bound time resolution set by a counter's rate, which is almost always tied to the symbol rate and/or chip rate of a device.

“Waveform Pings” on the other hand derive from sample-sequence waveforms of either I-Q waveforms, or their more cutting edge equivalents of parallel demodulated waveforms in such communications approaches as OFDM and/or multiple-input and multiple-output (MIMO). A digression into describing such new communications approaches would be unwieldy at best, where the point here is that sequences of sample data are much better, vis-à-vis omnipath distortion measurement and mitigation, than a hard-coded singular value a la a count-stamp based method. It should be noted that for most if not all modern communication devices, these sequences are not the direct electromagnetic signals arriving at an antenna, but are instead in some demodulated form, whereby the carrier signal central frequency has been subtracted one way or another from the actual EM signal. (Again, going into endless discussion on the details would dilute the point for this disclosure: having a set of waveform data for every ping is much preferable to having a singular discrete value).

Hard-Ping Omnipath Measurement and Approaches

The following sections assume the former category of singular-value raw data production for ping data. That is, the sending of a ping and the receiving of a ping result in a singular discrete data value.

Pseudo-Ranges and Delays: Omnipath Effects and Multiple Solution Approaches

The baseline enablement of an embodiment is very straightforward at this point: go ahead and treat each ping as a pseudo-range measurement, knowing that there will be an unknown, generally “symmetric” additional delay caused by omnipath, as well as some quite small time-based residual error.

When node A transmits a signal and node B receives it, all following ping protocols, it then applies DZT corrections to both its counter and to node A's counter (which it knows via pung channels or implicitly), then calculates a distance measurement (pseudo-range) between itself and node A, knowing that this distance measurement is either pretty decent and not too distorted if there is no omnipath distortion present, or, more likely, is a bit too long by some small or not so small amount depending on this unknown amount of omnipath delay. The “symmetric” notion is that when B sends a signal back to A and the process is symmetrically repeated by A, then the “lengthening” of A's distance estimate should be roughly the same as for B's distance estimate, so long as the signals were exchanged within a second or less of each other in a moderately dynamic mobile network.

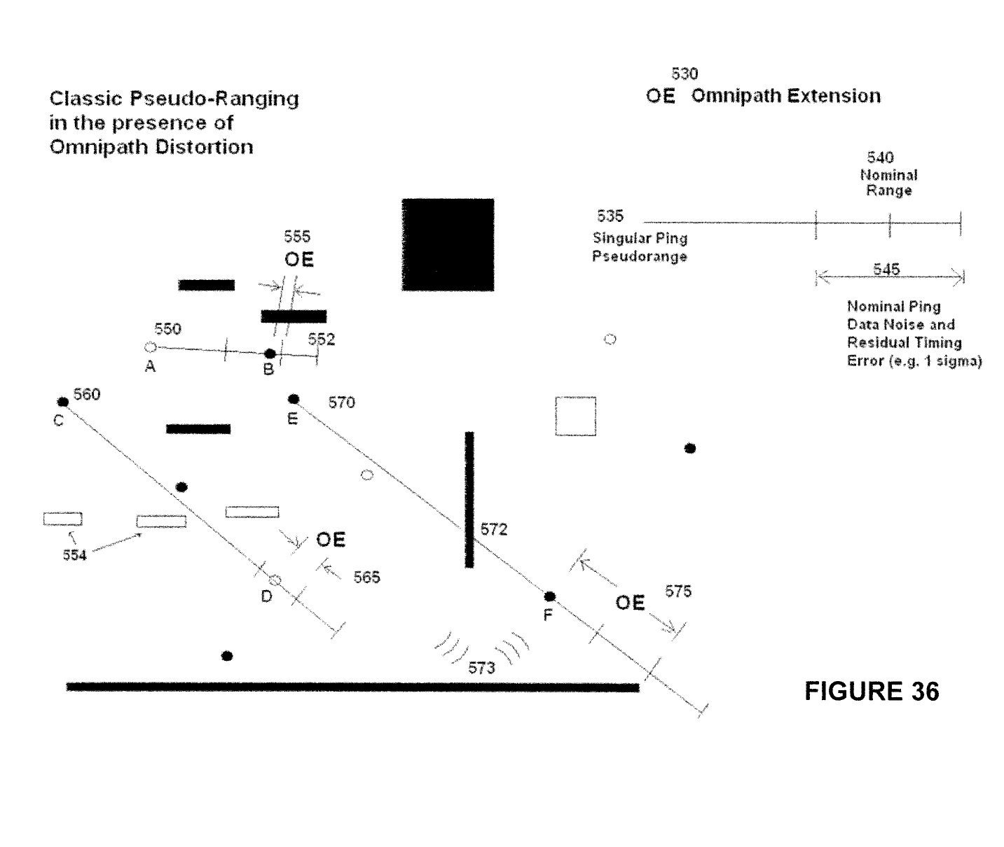

FIG. 36 attempts to graphically depict the situation described in the last paragraph in a few different examples. The sheer ability to conceive of the problem in this very simple manner owes itself to the “get the timing right” mantra and the previously described approach to calculating DZT solutions and effectively removing timing issues from the problem. As will be discussed, timing errors do certainly remain, but they have been relegated to simple descriptions of residual error as opposed to being primary actors in the omnipath drama. Earlier disclosures related to PhaseNet/Zulutime as well as the related disclosures explain that this unknown symmetric delay, call it a non-negative parameter that is indeterminate in the general case, can certainly be “thrown in” to the g=Hf harmonic block formalism: this is an altogether workable solution for many applications, with the “cost” being that each new set of two independent equations that a given new and unique linq brings to the local group generates a single new unknown, the common-path symmetric delay parameter. So the “networking effect” of new data equations growing faster (ratio-wise) than unknowns does not apply when including the unknown common path delays directly in H (and f). Most applications can mitigate this large growth in unknowns by heavily constraining the acceptable ranges of solutions for these new unknowns or by simply assigning probable values to some of the less important ones (fixed node to fixed node, for example), and then living with the resultant residual errors. Empirical testing would thereafter drive the extent to which the entire set of common-path omnipath delay terms would be directly included in the first-pass or second-pass g=Hf solutions.

FIG. 36 puts into pictures the notion of simply performing classic pseudo-ranging calculations for each and every single instance of a node receiving a signal launched by another cooperative local group node, i.e., for each individual ping. FIG. 36 then focuses in on the unique properties of typical omnipath distortion.

Label 530 in FIG. 36 introduces the initials “OE” that refers to “Omnipath Extension.” We use the spatial term “extension” here mainly to correspond the pseudo-ranging concept, in that these imputed values will generally lengthen as omnipath distortions come into play.

Label 535 highlights the basic graphic structure used in the example, where a notional ping is sent out from one node and received by another, and this singular ping can be re-conceived as a range estimate replete with bias errors and random noise errors.

Label 540 and associated text highlight a hash mark (middle of three hash marks) which graphically represents the calculated range estimate based on a single ping exchange. The related disclosures go into great length in how this nominal range value can be directly calculated once DZT solutions are in place (which they are in this example, via the lengthy previous discussion herein). FIG. 36 refers to this as “nominal range” as opposed to the “actual range” that might come from a gnome (by way of an imaginary example, and not by limitation) quickly hopping into an environment with a long tape measure, providing us with some ground truth on the actual distance between two nodes during their light-time-instantaneous ping event (gnomes are very swift indeed).

Label 545 and associated text refer to the outer two hash marks of the three hash marks present. Those practiced in the art of any kind of measurement, and specifically in the art of pseudo-range measurements, can appreciate that a very wide variety of errors get lumped into a general conception of noise distributions represented by these “one-sigma” has marks. The idea behind the 540 and 545 pairing is that the sole component of error introduced explicitly by omnipath distortions (an error which is de facto non-negative) is separated out from the laundry list of all other error sources, where the headliner for these other sources is most often garden variety Gaussian noise on communications channels, with the very common co-star of “discrete binning” noise where the counters on board physical equipment are forced to choose integral numbers for their generated data. Poor estimates of innate instrument delays are another very common source of error lumping into these hash marks as well.

To be very explicit then, these outer two hash marks stand in for the elusive properties of actual noise and error distributions, as if hundreds and thousands of independent pings were sent concurrently with the physical singular ping in question, and we could somehow generate an actual distribution (which is certainly possible if we take out the dynamics in the nodes themselves and just run seconds-long and minutes-long tests). The totality of labels 535, 540 and 545 is then applied to our now familiar dynamic network environment where we will discuss a few interesting and common situations.

The first example to be discussed is the notional situation where node A has transmitted a ping and we will focus in on node B's receipt of that ping, labeled as the 550, 552 pair and quickly alluding to the 535-esque pseudo-ranging estimation to which this singular ping has effectively given rise. A note is that this same exact graphic could be flipped where the start of the pseudo-range estimate could emanate from B and the three hash marks parked around node A. This reverse graphic might better conform to the text description above, but we'll leave it as is, partially because this emphasizes that the pseudo-ranging view of the problem is as much an intuitive aid as it is an explicit algorithmic basis. It should be both, not one or the other.

In the single-ping pseudo-range event labeled 550, 552, we ask our gnome to come back out, faster than light he/she is, and ask the gnome to bring along with him/her a few hundred thousand dollars worth of specialized signal measurement equipment. This gnome is well versed in the elliptical integration understanding of the actual omnipath situation as it exists between node A and node B at this particular ping instant, knows very well which exact carrier frequencies are being used, how the ping-measurement data is being extracted, etc. Using their highly tuned measurement equipment, along with performing a whole bunch of parallel pings alongside the single physical ping, our gnome finds that the component of error due to omnipath delay is fairly slight, represented by label 555, and that the “everything else” errors distribute as referenced by the hash marks. The gnome surmises and can partially even measure that it is the two fixed walls immediately above nodes A and B which is the largest contributor to something around, e.g., a 5 nanosecond phase shift in the particular carrier frequency being used in, say, the 802.11 transmission which manifested the ping event, where such a phase shift then manifests itself as the depicted omnipath extension, OE 555. Smart gnome that, with a little help from some very expensive measurement equipment.

One practical “early real world” comment on an 802.11 network is based on the discloser's fairly recent experience with actual 2008-era commercial hardware. In practice, 2008-vintage 802.11 chips were not designed to carry out these kinds of high precision operations, where the “counter resolution” of any given commercially available discrete counter might be as coarse as 1 microsecond, and generally not much better that a few ten's of nanoseconds. The practical implication of this fact is that the outer one-sigma hash marks depicted in FIG. 36, 545 and their example brethren, are much worse than indicated in FIG. 36: the error distributions on a singular ping event can easily reach into the many tens of meters if not even hundreds of meters. The ultimate practical solution to this basic issue is quite simple: don't rely on a single ping, or, design in higher resolution counters. Fortunately, both of these practical solutions are quite commercially viable, where the former is manifested by “making sure many pings fly back and forth,” i.e., trying to get ping rates in normal networks up to where a given node is launching a ping event at least a few times per second, and ideally ten times a second or more. Even once a second will get things started, once a network of five, six, seven, etc. numbers of nodes start to participate. It all still will work, it's just a matter of bringing system error specifications down to where applications want them, where many applications desire accuracies and precisions about on the order of one meter. The later approach of designing in higher resolution counters into the 802.11 chips themselves (or any other communication method, generally), is an involved but far from super complicated chip design issue. One can certainly radically increase the count rate, say from a typical 40 megacount per second up to a 400 megacount or even 1 gigacount per second, but there are also signal fidelity issues involved at the analog design level which need to be considered in order to make sure these higher resolution counts are not just sampling analog noise at higher resolutions.

Moving back to the discussion on FIG. 36, our gnome will now move on to a ping event launched by node C and received by node D, labeled together as 560 and 565 in FIG. 36. Here we have a little more distance between the nodes and we find that there are mobile EM scattering objects present in the environment, labeled 554. Similar to the A-B example 550, 552, 555, our gnome finds that for this particular ping we indeed find, e.g., another appreciable but not radical 10 nanosecond omnipath delay contribution to this ping's range estimate. Not depicted in FIG. 36 is the idea of “turning on” the dynamics of the environment, imaging that the mobile node D is temporarily stationary for a few seconds, even though it is supposedly “mobil,”, and then conceive of the mobile scattering boxes travelling left in FIG. 36, variously occluding and then opening up the line-of-sight condition between node C and node D. Pretty normal, real world stuff. What our gnome would clearly find in this situation is that the OE extension in the resulting sequence of pings going on over this several second period would be generally fluctuating in and out, say from a low of 3 nanoseconds to a high of 15 nanoseconds being something not out of the ordinary. This node C-node D example is meant to clearly illustrate that the variety of specific approaches which can be applied to distilling accurate spatial estimates must be exceedingly cognizant of these highly dynamic (and normal) omnipath situations. One of the specific embodiment approaches to this situation in particular is what we refer to as “network consistency,” wherein individual range estimates can be flagged as producing these dynamic fluctuations become unique to individual channels as opposed to globally present in the g=Hf spatial solution formulation, where actual node motion produces effects in all channels according the dx, dy and dz movements. Another embodiment approach is the advanced inference method whereby unknown scattering objects can nevertheless be inferred, provided there is a reasonable “spatial web” of network connections and in effect, something like “shadows” of objects cross through the web, manifested as these apparent increases in pseudo-range. This effect can be readily demonstrated in, say, a ten node system where all nodes are fixed, and some EM-blocking screen travels through the web of line-of-sight communications. Many specific algorithms to look for these dynamic single-linq modulations can be developed and begin to explore the previously mentioned “tomographic” approaches of this disclosure. For example, in the ten-fixed-node example immediately above, a linq with a clear temporal increase in pseudo-range becomes a mathematical indication what some EM-active object “just crossed through” the line-of-sight between one node and another. In and around the time of this crossing, a select set of other linqs in the vast 90-stranded web (90 channels for a ten node network) are reporting the same thing, and by simple geometry one can hone in on locating the object in space, and then as a function of time once this is done over seconds of time.

There is a third ping event example depicted in FIG. 36, associated with nodes E and F, and labels 570 through 575. Here we find two fixed nodes E and F with a clear EM obstruction in their line-of-sight path. A quick glance at the resultant nominal range point and its associated omnipath extension, 575, leads our gnome to conclude that perhaps it is the strong EM bounce, 573, which is primarily driving the large amount of omnipath delay for this particular ping. Note that both nodes are fixed (filled in circles). There are a variety of ways to calibrate what will manifest itself as a fairly stable and “knowable” amount of omnipath delay. There will still of course be dynamic variations on the instantaneous OE based on changes in the EM environment, a la the last paragraph for example, and also due to instrumentation drift, but the implementing a decent estimate of the steady state omnipath delay of any given fixed linq is clearly achievable.

One generic note about FIG. 36 and several figures following is that, in general, a single ping range event does not inherently know the precise direction of the range, and its mathematical and structural form is indeed a circle at a given radius as opposed to a hash mark at a nominal range point. It was felt that as a graphic convention matter, this fact was intuitively obvious, and making the center hash mark become a relatively wide ranging “arc” of a circle seemed to be unwarranted, making the graphic much more complicated for little return in extreme clarity. Classic triangulation based on “psuedo-ranging overlapping arcs” as has long been practiced in the art remains the baseline assumption approaches that would underpin the details of how a series of pseudo-ranges can be used to locate objects (all as is very well known in the existing art of pseudo-ranging).

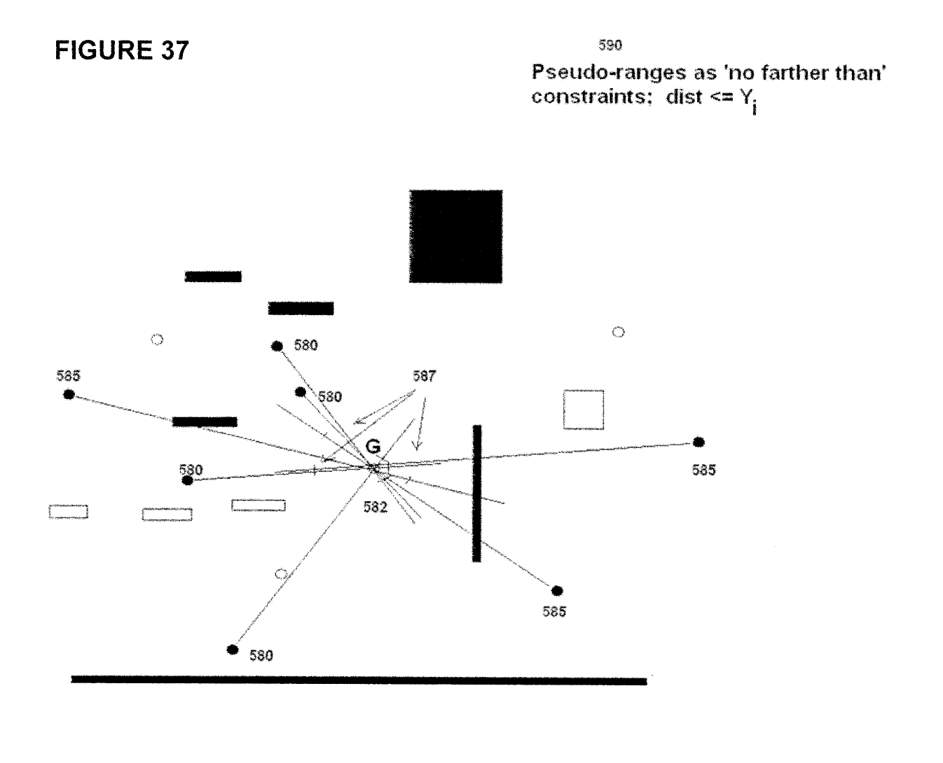

FIG. 37 illustrates a mobile node G near label 582 being swamped by a bunch of pseudo-range estimates based on other nodes. These pseudo-range estimates can be derived both by node G sending out a ping and that ping being received by other nodes, or those nodes send out a ping and node G receives the ping; either case can produce the same range estimate. The graphic confines the range-lines to only the fixed nodes, but it doesn't need to be only that way. We can see that some linqs have line-of-sight conditions, 580, and others don't 585. The subtle nominal range hash marks can be seen, 587, where some are closer to the actual position of G, usually associated with the 580 nodes, while the 585 linqs tend to show more omnipath delay. Only the nominal range value (e.g. 540 in FIG. 36) is here depicted, it being felt that more hash marks would push an already messy graphic over the messy edge. Note 590 in the top of FIG. 37 just emphasizes the normal mathematical relationship set up with one of these typical pseudo-range estimates, where they are generally hard-constrained to be either un-biased by omnipath distortion, or lengthened by omnipath distortion.

Those practiced in the art of pseudo-range triangulation will recognize this situation as a fairly typical example of decent geometric diversity, with an over-determined set of variously biased estimators. Note that all estimates are “beyond” the actual position of G. One can further imagine that G now progress on some mobile path, with pings coming and going, with these range estimates become a virtual movie of, typically, dozens and dozens of these estimates appearing and disappearing per second (for a system where each node transmits a ping at least a few times per second). As G progresses on its spatial journey, a virtual cloud of position probabilities follow along, most typically being thrown into a classic Kalman filtering routine in order to determine an optimal path for G.

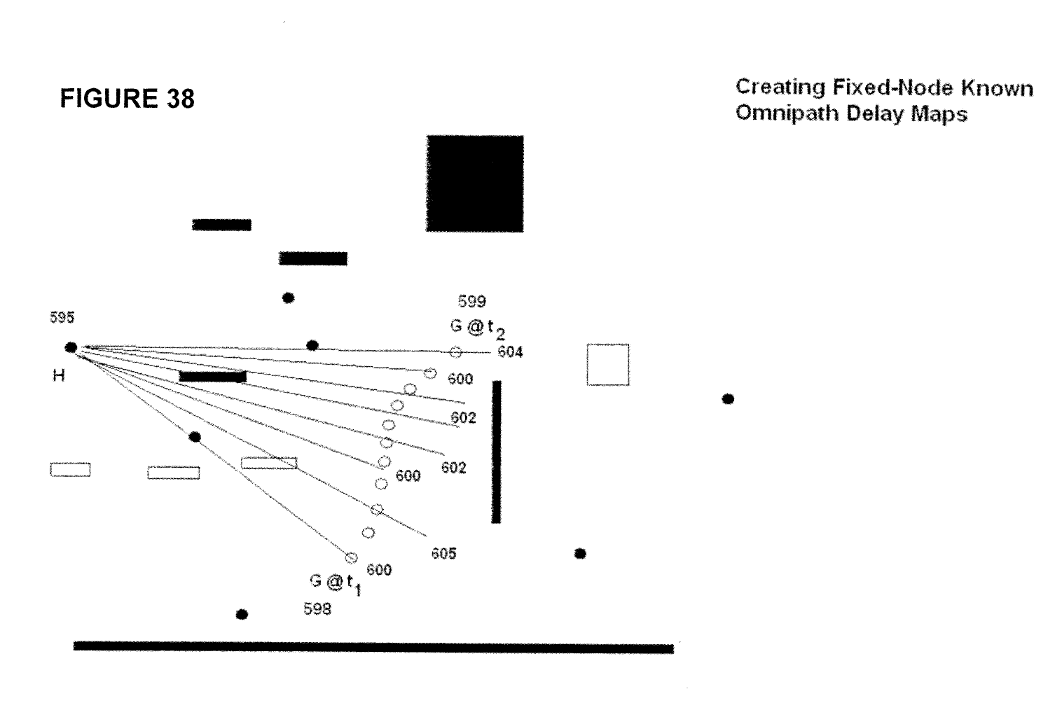

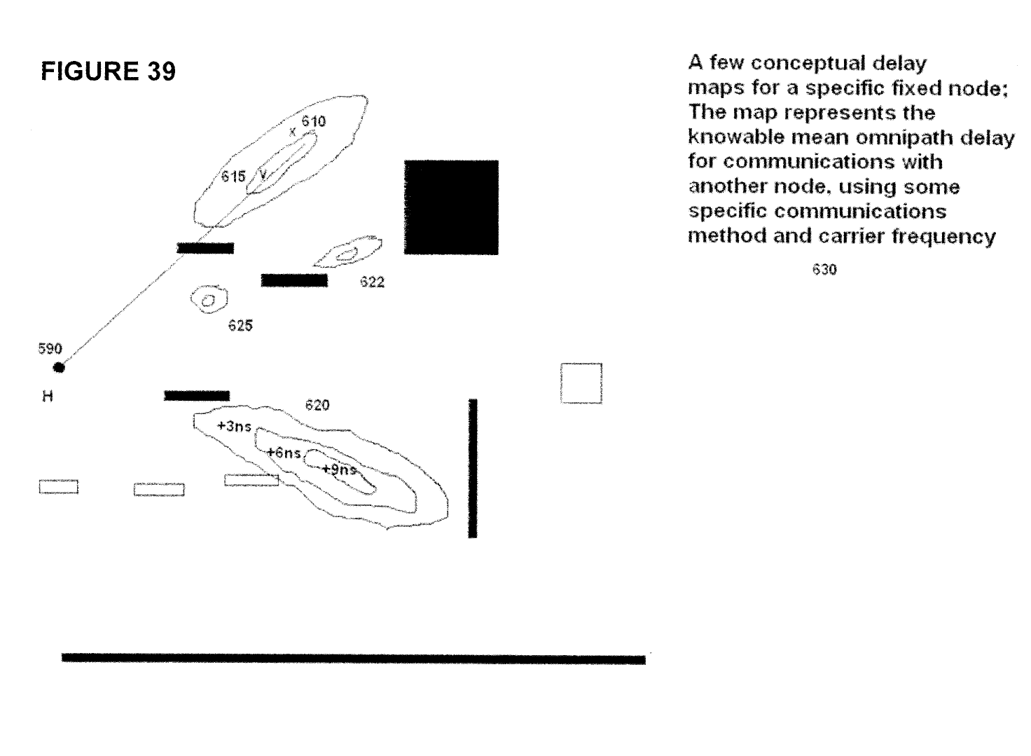

FIG. 38 somewhat alludes to this last paragraph of node G in motion, but also intends to segue the discussion toward one or the more powerful aspects of certain embodiments. This latter aspect has to do with the previously discussed “delay maps,” whereby definitely fixed nodes, but also in certain applications mobile nodes, can fairly quickly develop (or be programmed to have) specific local environmental maps which literally track and ongoingly improve its knowledge of expected omnipath delays as a function of where, in actuality, another communicating node finds itself. FIG. 39 will go into further details on the maps specifically, where FIG. 38 talks about at least one of the many ways such maps can be generated.

FIG. 38 graphically posits our mobile node G travelling from one spatial point at time t subscript 1 (t₁), through many snapshots in time to another spatial point at time t subscript 2 (t₂). We then focus in on its linq with fixed node H, 595, as but one of its many ongoing linqs active during its journey. Also loosely depicted is an abridged form of the ping pseudo-range estimates discussed in previous figures and text. Now, in FIG. 38, simply the length of the line represents an ongoing omnipath delay modulated distance estimate.

One can immediately see the “shadowing” effect discussed at length earlier, whereby a clear increase in length is caused by intervening EM scattering objects. The term “shadow” is not exactly correct, but hopefully the reader does not mind its use here. But what is also happening here, provided there is some method of providing “ground truth” on precisely where G happens to be (possibly relying on, or possibly not all relying on the H-G linq itself), is that the fixed omnipath delay map associated with H is making itself “partially” known, at least for the particular carrier frequency and modulation method being employed in the linq. A technician doing a few minutes of driving around in a local urban environment might be the form of this operation for a quick set-up routine, attached to the normal procedure of setting up node H as a local access point to node H, as but one of many examples. Ground truth methods can also be many, such as this technician using special purpose urban-canyon ruggedized GPS/INS hybrid positioning systems, as one example, or, if other access points have already been “omnipath calibrated,” then ground truth can simply come from normal PhaseNet/Zulutime estimations based on those pre-existing nodes, possibly ignoring node H's ping data. Further still, node H's actual data can be used to “roughly estimate” these maps, then as more and more random nodes travel through the environment, all fixed nodes can slowly improve their own delay maps by continually comparing their individual pseudo-range estimates of a given object and comparing that to what the broader local group decided the position was, at the instant that pseudo-range was determined (its ping time). Bottom line: there are many ways to create these delay maps.

Briefly examining the details of FIG. 38, the pseudo-ranges labeled 600 seem to be pretty decent and not too much affected by omnipath; the 602 estimates are noticeably affected by the fixed EM object; estimate 604 is a token notion that sometimes even an intervening communicating node may tweak omnipath upward; while estimates labeled 605 clearly points out the ephemeral hazards of creating “average” non-dynamical delay maps which do not depend on short term behaviors of the environment, where are temporary mobile EM scattering object has lengthened the omnipath bias map during this particular pass of node G. The word “average background” map becomes an operable concept here, with the ideal that all effects from non-fixed EM scattering objects has been removed; “ephemeral maps” and “instantaneous maps” are also quite possible, loosely corresponding to a) somewhat stable “minutes-scale” maps where, for example, some large metal truck has been parked in some throughway, noticeably tweaking the network consistency of converged solutions and whose presence becomes “sleuthed” over ten or twenty seconds time; and b), truly second-by-second mappings of EM objects as they travel through the local group terrain using the basic approach outlined above.

FIG. 39 is then a very crude representation of a more classic (and not often actually implemented) way to view a resulting delay map for node H. The actual form of the maps will either/both be GIS-like vector maps overlaid on a local map, and/or a raster image of integers or floating point numbers. All of these maps will typically have units of either time (in nanoseconds) or distance, the two most often being equivalent. One embodiment of the use of these maps is not perfectly straightforward but close: looking at labels 610 and the x initial pseudo-range estimate, the map then “implies” that the object must really have been at the spatial point y, 615, because if it were at y, then the map says it would be projected to seem to be at x. Hence, the subtlety here, but now really a major complication, is that based on a measurement x, one needs to find an earlier point on the line-of-sight line whereby a “y” plus its value on the omnipath delay map adds to give x.

FIG. 39 is thus more designed to describe a few basic and common uses and behaviors of these maps as opposed to truly resemble one, starting with the last paragraph's x to y re-mapping use. Another note is labeled 620, where this little “shadow” of the fixed EM scattering object has been calibrated to actual average delay times due to omnipath. 622 is another conceptual example of a shadow. The mini-region labeled 625 is meant to show that these pockets of delays can show up even in apparent nice line-of-sight places, primarily due to carrier frequency phase shifting, highly related (but not the same as) so-called “fading” in the communication industry. The mini-region 625 might be caused by a small amount of reflected ways bouncing off the fixed EM scattering objects immediately above that region. Note 630 wraps up FIG. 39 by making explicit what was largely discussed in these last few paragraphs.

Lower Bound Clumping

The preceding paragraphs explored a variety of details on artificially extended pseudo-range values due to omnipath distortions, with both the gnome-view which is unavailable to an actual functioning network, as well ignorance and discussions on how that ignorance can either be mitigated or simply lived with. The title of this section refers to a specific approach to generating position solutions based on several levels of ignorance relative to both omnipath-induced delays as well as residual device delays. The term “clumping” may be translated by mathematicians and engineers into least-squares terms, but in general refers to overall agreements of measurements. The guiding idea is that correct positional answers will clump together either over some short-defined epoch of time, or certainly over an evolution in time of say ten to twenty seconds. Omnipath-induced false solutions will tend to diverge from each other and not clump, as the opposing notion.

The phrase “lower bound” is a direct reference to the uni-directional effects of delays in time. Generally speaking, the “zero delay” answer to an amount of delay is the lowest one can go, while in a physical instrument there is generally some lowest value of delay that that device will necessarily introduce. Omnipath-induced delays merely increase the overall delay component of a pre-compensated pseudo-range value.

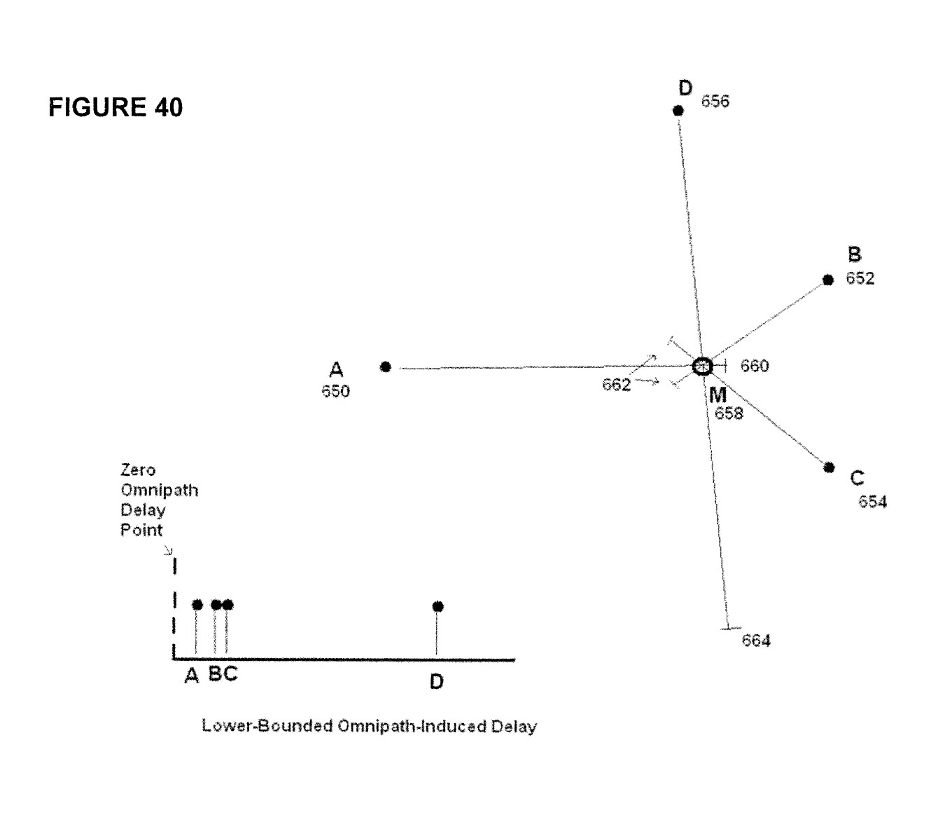

FIG. 40 presents the basic notions and context for lower bound clumping. It is slightly idealized relative to actual implementations in that we still are taking a gnome-like view of seeing “exactly” how much omnipath-induced delays are elongating pseudo-range values. Device-induced delays are also not included in the picture. Later discussion will delve into how that actual implementation deals with this lack of gnome-like knowledge.

Four arbitrarily splayed fixed nodes A, B, C and D (650, 652, 654,656) are all producing pseudo-range estimates to moving node M (658). Methods described earlier in this disclosure and in the related disclosures outlined how such pseudo-range values are derived, while the additional step of removing device-induced delay values has been performed. The resulting graphic treatment then isolates the individual omnipath-induced delays for each of the four independent range-lines. The range-line from fixed node A to M extends only slightly beyond M, depicted as the 660 overhang. Likewise, nodes B and C's range-lines extend a bit further, 662, while the range-line from node D is quite a bit further out, 664. For all and arbitrary networks, where a variety of approaches exist that can boil down to this system of inherently over-determined pseudo-range values, the question becomes: what to do?

Lower bound clumping is felt to be a very reliable embodiment of positional solutions which has the property that it downplays outliers in much the same way that finding median values as opposed to mean values of an unknown variable tends to de-weight outliers. In particular, lower bound clumping re-formulates range-excess values into a form graphically represented by the plot in the lower left of FIG. 40, labeled 670. Here we still see the gnome-like view of excess range values, about the only-gnome-known zero omnipath delay point, 672. The core principle in determining lower bound clump solutions is to find the point on the map where all range-excess values best clump toward the least excess value. The median-like approach to this is to metricize clumping as absolute values of difference instead of differences-squared, which is inherent to a least-squares over-determined averaging approach. Conceptually, one can imagine examining all spatial points in an X-Y positional space to determine which point in that space best clumps the pseudo-ranges. In practice, however, a map of that clumping profiles is relatively smooth and bottoms out with a global minimum nearby the correct final answer (in cases where omnipath distortion is not extreme). In these more omnipath-tame situations, simple search based methods can find a global clumping minimum quite readily.

Specifically, the “algorithm” used in certain WiFi embodiments has been the following:

1) Determine the N independent pseudo-range values between all fixed nodes and a moving node for some epoch in time.

2) Pick any point in space and determine that point's N range distances from it to all fixed nodes, as if the moving node was at that point.

3) Subtract the second N-vector from the first, call it the difference N-vector, where it can be appreciated that any pseudo-range subject to an extreme form of omnipath-induced distortion will produce a higher resultant value than if it were not distorted.

4) Select the lowest value in the N-vector and subtract it from all others. This new N-vector will have a zero value where the lowest one was, and all other positive.

5) Simply sum the values in the N-vector of step 4.

6) Now search through space to find the spatial point which minimizes the N-vector sum of step 5.

There are numerous variants on this basic scheme, including various weighting schemes on the difference N-vector as well as simply throwing out all but the lowest two or three values. The main relationship that this “algorithm” has with the median operation is that it is not weighting via the square of differences, and indeed, the further outliers are often thrown out of the calculations altogether.

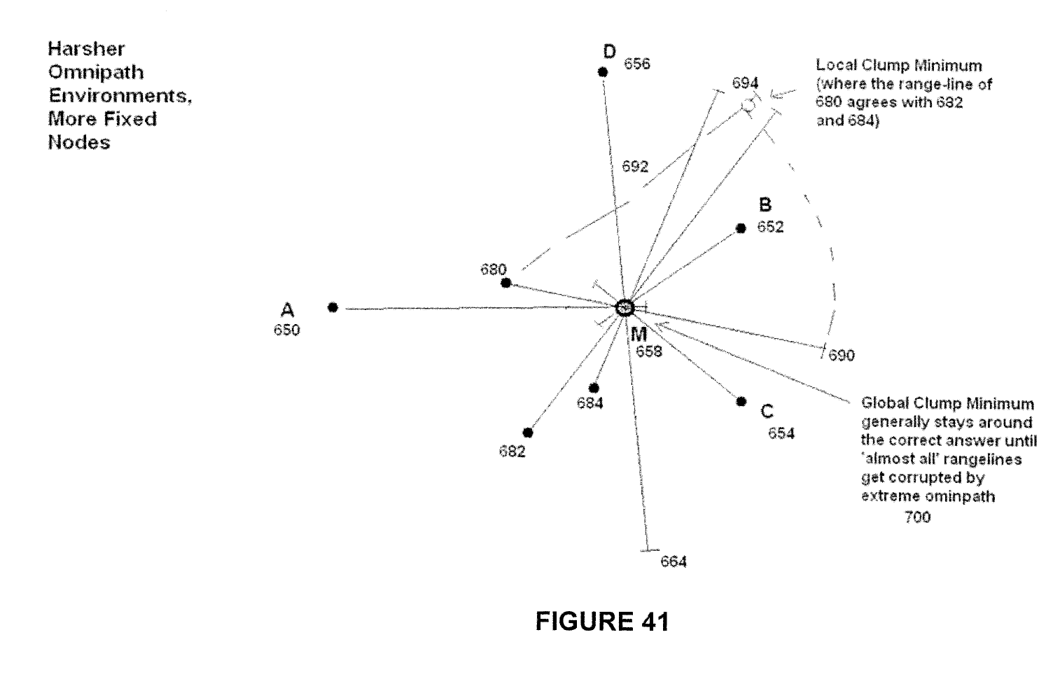

In deployed systems, the situation depicted in FIG. 40 holds up well in outdoor situations as well as relatively benign and “roomy” interior situations. Be that as it may, very dense office interiors tend to have much worse omnipath distortions than those implied by FIG. 40. FIG. 41 introduces how lower bound clumping can nevertheless deal with harsher environments.

The limitations of lower bound clumping relative to the degree of omnipath distortions present in a network can be clearly spelled out. The following discussion delves into roughly how far lower bound clumping can still produce decent positional solutions, and at what point it breaks down, resorting to waveform based approaches, advanced network consistency approaches, map based approaches and all their various combinations and permutations (the many cocktails and their various combinations).

In FIG. 41 we introduce three new fixed nodes 680, 682 and 684, on top of the earlier A, B, C and D. We also show that all three of these new nodes also are suffering from extreme omnipath-induced delays. Furthermore, if we draw an arc from node 680, we find the “random” occurrence that its pure range-excess value happens to agree quite nicely with 682 and 684 in and around the spatial point labeled 694. The range-line 690 has been virtually rotated into the range-line 692. The spatial point 694 would then happen to also have three range-lines indicating that it may be the correct solution.

Fortunately, use of a median-based definition of “clumping,” as opposed to a least-squares based definition, can help distinguish the correct global minimum 658 from one or more local minimum typified by the spatial point 694. A point is reached in an N-node fixed network whereby false local minimum overtake the “correct” answer. This answer will be entirely dependent on local conditions.

For example, a specific environment can be readily tested to see if only four or five fixed nodes generally suffice in order to achieve some level of omnipath distortion, as opposed to needing seven, eight or even higher, thereby increasing the basic odds that some small set of three or four will be agreeing on the spatial location of a mover. For environments with horrendous omnipath present, other methods previously discussed (specifically the map based method) and others following should be considered. Even when using more advanced techniques, however, the least bound clumping approach can still be brought into the solution process as it has excellent median-like properties in determining final solution choices.

The Best-Solution Clumping Value

It should be pointed out that the whatever specific median-like metric or any other type of metric is used to find a “global minimum,” itself becomes a form of feedback on what degree of omnipath distortion a given network is experiencing at any specific epoch in its operation. This is rather intuitive, in that if range-values are nicely agreeing with each other, this generally indicates that one way or another the omnipath distortions are either not present or are adequately being corrected-for, while if residual agreement in clumping is poor, the opposite case of heavy omnipath is probably at play.

The reason for being explicit about this is that such a final clumping value at the global minimum can be utilized both as feedback to current users of a network, helping them to better understand the error bars of the presented solutions; but perhaps more importantly to assist in calibration routines, network set-ups, and trouble shooting, with further discussion on these topics below.

Isolating Inherent Device Delays from Ephemeral/Omnipath Delays

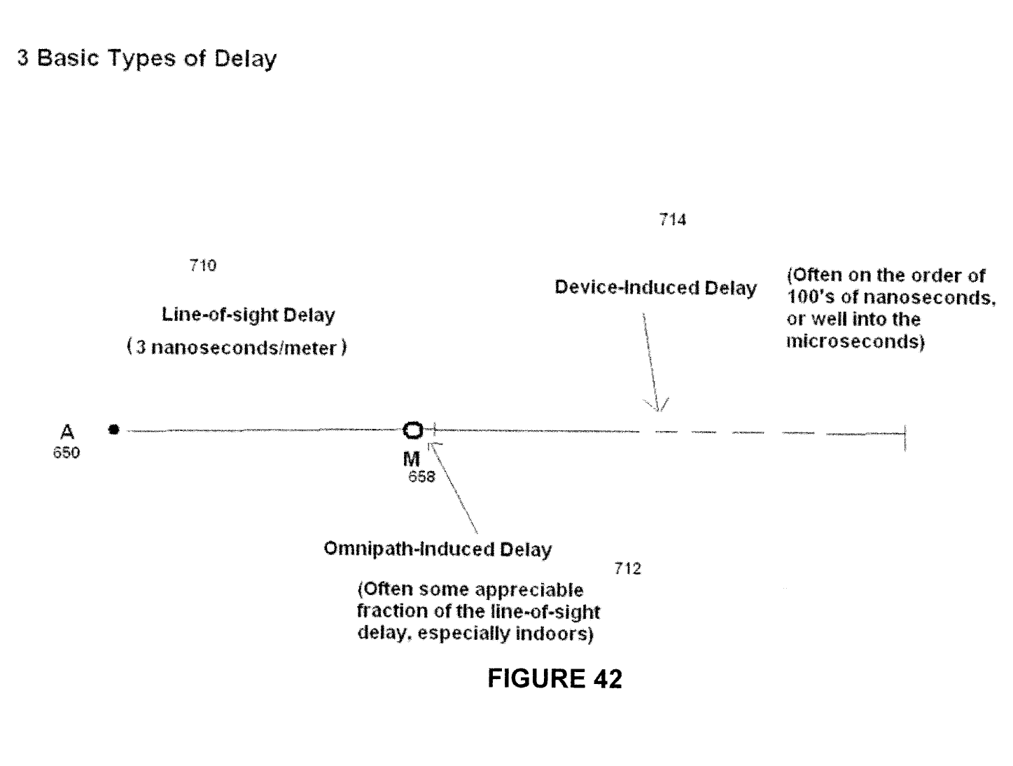

FIG. 42 depicts a further break-down of three basic types of delays encountered in arbitrary networks. We have already discussed all three types, where this section suggests both calibration methods as well as run-time measurement approaches which can continue to refine how, specifically, a given network can produce undistorted spatial solutions.

FIG. 42 isolates one fixed node, A (650) with the mover node, M, 658, along with the range-lines from FIG. 40. It now adds what graphically would be a much longer range-line depicting what is here called the device-induced delay, 714. As noted, in a functioning wifi device or cellular phone, this delay that derives from the demodulation and symbol decoding logic within a device can amount to hundreds of nanoseconds if not microseconds for off-the-shelf wifi devices. The disclosers have found empirically for a wide range of wifi devices that even though these delays are extremely long relative to line-of-sight delays and omnipath-induced delays, they are very fortunately quite stable to the double-digit nanosecond level over minutes of time. Nevertheless, the disclosers have found it prudent to perform two types of measurements in order for ongoing measurement this delay.

The first type of measurement is quite straightforward, whereby a given device is put into a position where both line-of-sight delays and omnipath delays are essentially eliminated, and what is left is simply measuring this device-induced delay. This is what we refer to as calibrating the innate device-induced delay of that particular device. It is easier said than done, in that insuring that no omnipath delay is present can be rather tricky. Nevertheless, if one is willing to accept a few nanoseconds of residual error, or, go to lengths to take antennae out of the equation by doing wired links between devices, then one can measure and thereby calibrate a given device to discover its innate delay as well as the innate drift in the magnitude of that delay over minutes, hours, and days of time.

The second type of measurement has been covered extensively in the related disclosures, whereby it is treated as a full unknown parameter in the g=Hf formulations. Engineers will recognize that this may not be necessary where the devices are relatively stable and the residual errors introduced by using calibrated values are acceptable.

Static/Dynamic Combined Network Consistency

The earlier disclosure on lower bound clumping could be called a form of “static consistency” to solutions, in that the operation of the clump-map minimization was finding the point on the map where measured pseudo-ranges most agreed, or were consistent.

A broader view of consistency would involve dynamics within a mobile network as well, and in the process provides a very powerful additional tool in both sleuthing pseudo-range values which are particularly subject to omnipath-induced distortions, as well as disambiguating correct solutions from incorrect ones as omnipath distortions become particularly extreme. A further benefit-in-the-extreme of looking at static/dynamic consistency is when it is applied to new nodes joining an existing group or even when an entirely new group is set-up and calibrated: discussion below will outline how both direct and recursive procedures can be put in place whereby detailed delay maps can be measured, stored and thereafter utilized for normal solution refinements.

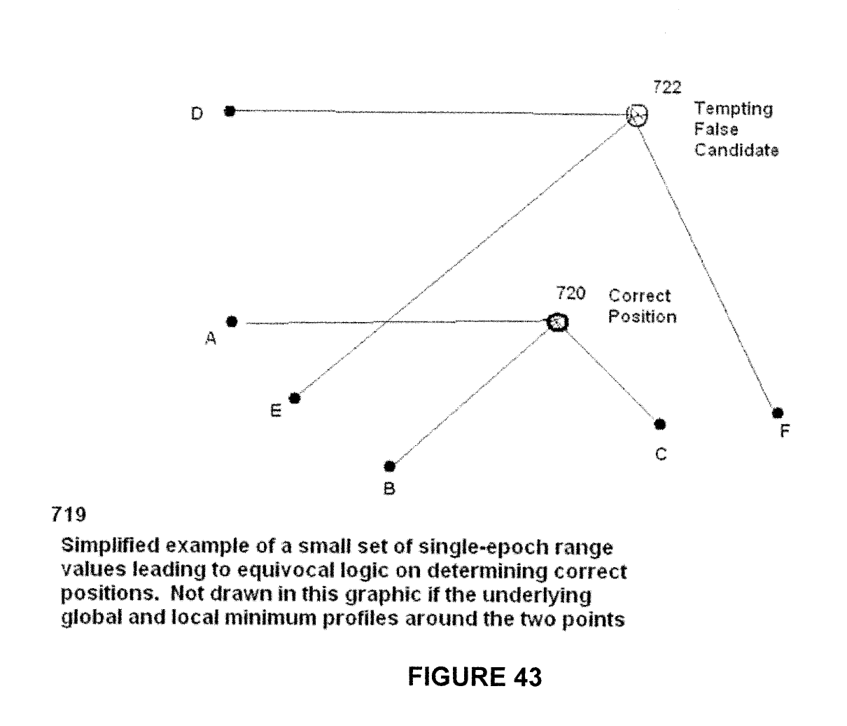

FIG. 43 depicts a deliberately over-simplified view of the earlier outlining of how pseudo-range lines can determine a correct positional solution even in the presence of modest omnipath distortion. The basic idea behind the graphic is that given only a small set of potentially corrupted range-values, wherein perhaps no delay map is available in order to attempt a first correction of said range values, then one might be left with a logical problem whereby several pseudo-ranges from A, B and C seem to be agreeing on the correct solution, while due to the quasi-randomness of omnipath distortion, D, E and F just happen to agree on a false solution. One might view this situation from its de minimus perspective, summarized in the phrase “imagine this is all we know”. One could further imagine that the range estimates from A, B and C perfectly align at point 720, and D, E and F perfectly align at point 722. In this case, three votes versus three votes equal a stalemate.

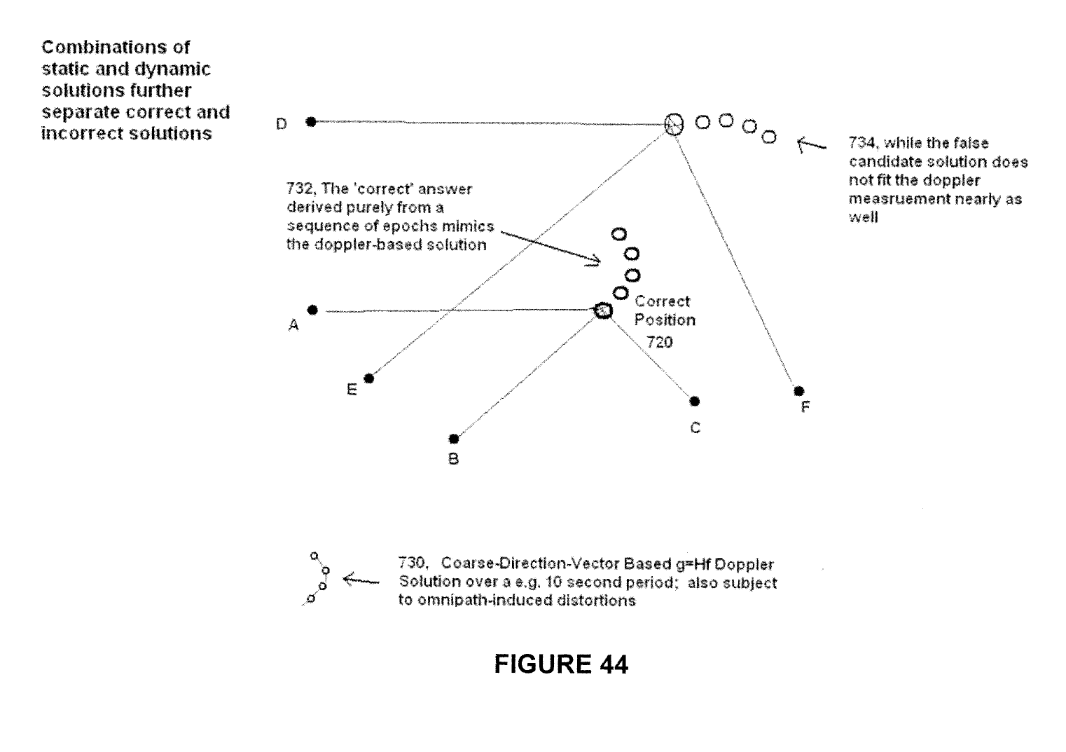

Fortunately, real networks probably will never reach this thought experiment conundrum as outlined in its pure logical form above. Basic random noise alone pretty much ensures this. Getting back, though, to the point behind the simplifications of FIG. 43, FIG. 44 shows one embodiment form of utilizing previously disclosed node-motion measurements alongside range-clumping methods, together producing a fuller picture of solutions which are consistent across time as well as space. The general principle here is that specifically relative to omnipath-induced distortions, those very same distortions produce differing geometric consequences when applied directly to space coordinates directly (as in clumping), versus how they affect dx, dy (dz) measurements as mediated through the use of “coarse direction vectors,” a topic covered at length in the related disclosures.

Specifically within the FIG. 44, our gnome knows that the correct position is moving along the trajectory by label 720. Note 730 points to a dynamic Doppler solution obtained over, for example, a 10 second period, while label 732 indicates how some sub-group of nodes is producing a clump solution generally matching this correct solution, while another sub-set of nodes being greatly affected by omnipath distortion is producing a tempting candidate clumping solution following the track near label 734. As noted in FIG. 44 and its text, the correct clump version track better matches the independent Doppler track, lending strong evidence that the sub-group tracking the correct position is indeed the right choice.

As further noted in the text lines of FIG. 44, it is of course the case that the Doppler-esque measurements are also affected by omnipath distortion. Thus the phrase in the above paragraph “better matches” is a central issue, where a variety of mathematical criteria can be used to determine what exactly this means, with the headliner always seeming to be a least-squares fitting of each “extracted Doppler track” from the spatial-clump solutions, against the independently measured Doppler track. Median-like measures of fit are even better, with details of how to do this left to textbooks and standard data fitting art.

A useful point behind FIGS. 43 and 44 combined, along with this supporting text, is that dynamics within a mobile network of nodes can be fundamental to smoking out omnipath distortions on individual pseudo-range measurements. It is believed that the non-linear nature of two-dimensional space and three-dimensional space is a contributor to these approaches, in that phenomena which may have largely linear behavior (i.e. individual range-lines) in isolation, wind up having non-linear and differentiating behavior once combined in a higher dimensional space and especially in situations where there is a diversity of geometric perspectives. This whole area is highly related to the very familiar “dilution of precision” topic within GPS-based positioning and other multilaterated measurement systems. Applicant suggests borrowing heavily and often from these established prior art measurement approaches and methods of determining the error bars within solutions, turning these methods into further means of using dynamics in a mobile network to sleuth, isolate and mitigate omnipath-induced distortions.

Automated Delay-Map Generation: Further Details

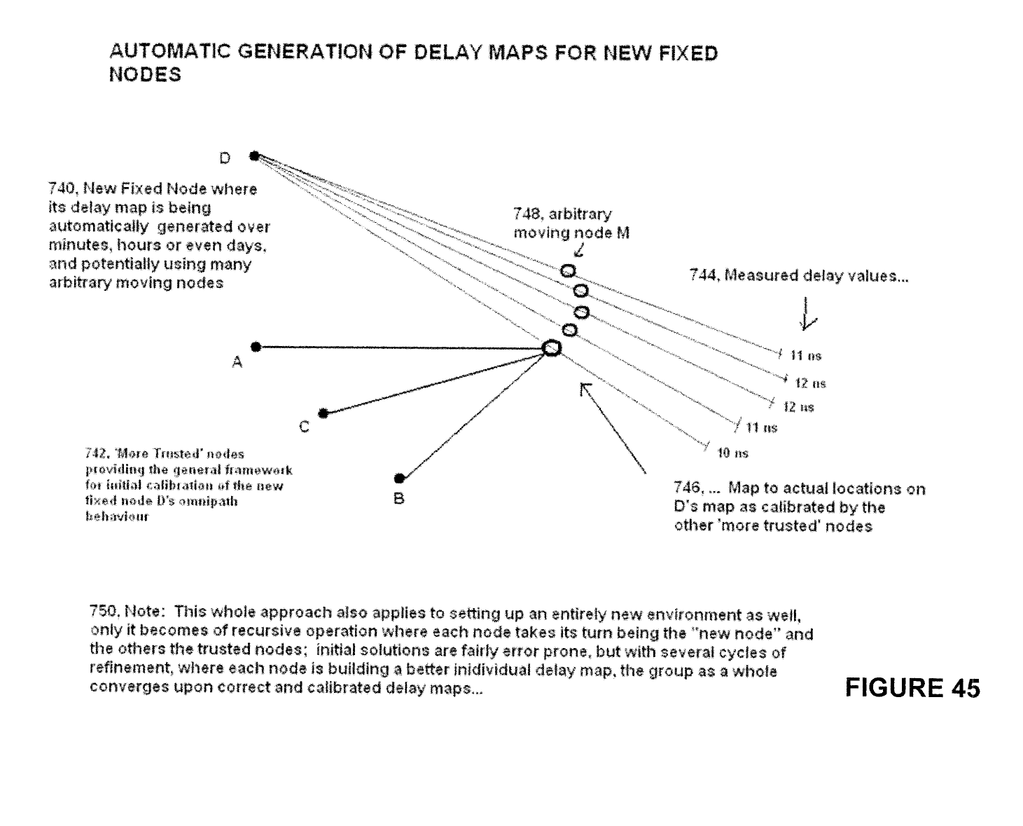

Earlier in this disclosure the topic of mapping known or at least somewhat stable delay characteristics of a given fixed node can be used to create correction factors on individual range-values as a final spatial solution is converged upon. Now that a few more specific approaches to generating solutions has been discussed and some of their omnipath-induced behaviors elucidated, FIG. 45 further illustrates how such maps can be either automatically generated, as is mainly discussed in and around FIG. 45, or certainly as a calibration routine during set-up of a network, where either the system itself has to figure out (by itself with no help from a technician) what these delay maps are for each and every fixed node, or, a system can be assisted by a technician periodically inputting “ground truth” data as is very common in positioning prior art.

In FIG. 45, we find a new fixed node D, labeled 740, hypothetically joining into an existing group of fixed nodes A, B and C, labeled 742, but perhaps representing more than just three nodes. The task at hand would be to automatically generate the delay map for the new node D, using either a) random moving nodes that happen to come and go in the operative vicinity of the group at large, or b) a pro-active technician-driven calibration motion of some moving node M, labeled 748. In either case, the existing nodes in the network presumably have already been one way or another calibrated to some margin of error appropriate to the application, often in the one or few meter tolerance range, and these collective nodes become a kind of “trusted” nodes as noted by label 742. As these trusted nodes produce spatial solutions as they normally do, the specific range values measured by node D at recorded, 744, and duly associated to the actual map of the vicinity as noted by 746.

Those practiced in the art of positioning systems can appreciate that, in the situation where omnipath delays or other forms of delays are not “outrageous and out of control” to put it in vernacular, one has the opportunity to set up a “convergent solution” approach to generating delay maps even in situations where all fixed nodes are new, i.e., a Zulutime fixed network group is being set-up for the first time. Note 750 summarizes this possibility, where various cocktails of solution methods can be employed, most definitely including lower-bound clumping and dynamic/static separations, but any number more as well, where (N−1) fixed nodes produce interim spatial solutions and the Nth node's measured range value is compared to the N−1 answer. A very crude initial estimate is formed for the delay map of node N, and this same procedure is cycled through all fixed nodes in the network. Mathematicians will note that this is simply tracking the deviation of each node from the average of all others. Producing crude first-stage delay maps can then be used (generally with what is called a “damping factor” applied to delay-corrections) to partially correct for a next iteration of solutions. For networks where omnipath distortions are not hopeless, many indoor situations, even rather complicated situations, will find a useable convergence to delay maps that, certainly, further more involved calibration steps can refine. This self-calibration approach can at least noticeably reduce out-of-the-box error bars for a newly set-up network.

Omnipath Symmetries and Asymmetries

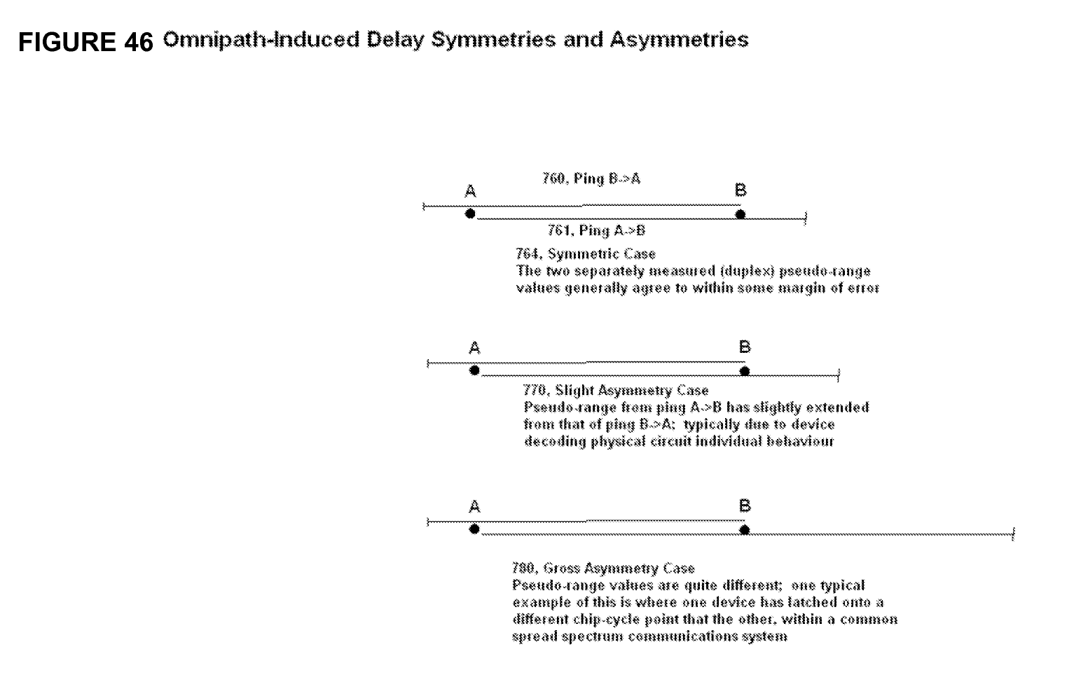

FIG. 46 attempts to elucidate an important practical consideration in dealing with measurement and mitigation of real-world omnipath-induced delays, as opposed to those more nicely behaved versions sitting on various white boards in classrooms and conference rooms. The real-world asymmetries involved with omnipath are somewhat arbitrarily categorized into three buckets: a) 764, the effectively symmetric bucket, as defined by some given margin of error tolerance, typically in the sub-nanosecond realm; b) 770, the “slight” but nevertheless measurable and meaningful bucket wherein the effect can either be exploited, and/or, the effect can be measured and mitigated; and c) 780, the egregious asymmetric variety where, largely based on the differences in individual behaviors of transceivers, there are times when there is tens or hundreds of nanosecond differences in the measured pseudo-range between two nodes, depending on which node is the sender and which the receiver in a duplex situation. (Labels 760 and 761 point out the individual monoplex pseudo-range values that correspond to the two directions of message travel).

The note 790 begins with a critically important phrase: “ . . . running on Zulutime.”

Back to this disclosures central mantra: remove timing from the problem and the problem greatly simplifies. Here is one clear instance where the intuitive notion of each and every ping generating a pseudo-range value becomes manifest. As such, it can be clearly scene that symmetries and asymmetries of pseudo-range values can be directly measured, once all nodes are “running on Zulutime.” At the deeper error-bar level, residual timing errors are of course still making their way into actual measurements, but their probable magnitudes can be easily estimated and in almost all practical applications, brought to a sufficiently low level that they become dwarfed by larger error sources, with the operative one of this section being omnipath distortions.

Accepting this approach leads directly to the conclusion that measuring and exploiting asymmetries in duplex pseudo-range values is readily achievable.

One of the exploitations has to do with the third case 780, of egregious asymmetric omnipath-induced distortions. In spread-spectrum based networks in particular, but in any communication system where there is a systematic binning of signal values into “chip rate” oriented logical discrete values (which includes virtually all modern communication systems, even very recent ones such as OFDM and/or MIMO), an interesting (and annoying) situation can occur where a multitude of paths can contribute to a received RF signal at an antenna which when demodulated into the lower bandwidth logical structures, can exhibit abrupt phase shifts between binning an incoming signal into one particular “phase” of the binning logic (“the chip rate” in classic spread spectrum) and some adjacent phase of the binning. For systems running at relative low chip rates, say 10 mega-chips per second or lower, this phase shifting can abruptly shift “code-phase” based arrival count-stamp procedures from one value to another one a full chip later (or sometimes sooner, if restoring from a delayed state). This shifting is one of the primary drawbacks of code-phase count-stamping approaches, where waveform-based approaches in general have many tools available to whisk away this pesky fly. But in much of current communication systems where the sheer sophistication of count-stamping has not been economically driven into low level RF designs, this shifting can become a fundamental omnipath-induced delay. In the 780 case of FIG. 46, when in fact only one of a duplex pair of nodes goes into a slip state and the other doesn't, the ability to identify to offending node is quite straightforward. Thereafter, an implementer of the disclosed embodiments is free to deal with the flagged value as they see fit: remove it; correct for the shift and use it; weight it appropriately; whatever best serves empirically-oriented best group-wide behaviors and collective error bars.

Knowledge of the existence of this cycle-slip behavior can also certainly inform previously-described and hereafter-described specific solution approaches, along with their interim tasks of identifying individual behaviors of resultant range values.

Minimum-Delay Range-Line Logic: 3 or 4 of N

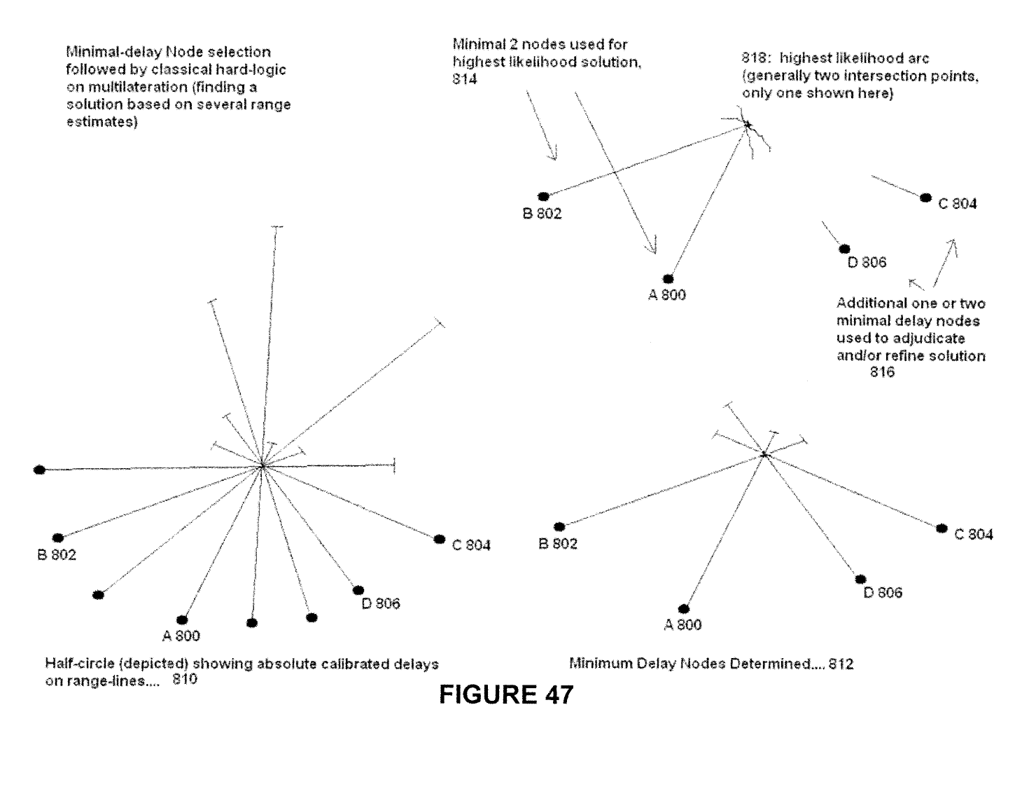

FIG. 47 depicts another utilized embodiment of range-value based omnipath distortion mitigation. Harkening back to FIG. 42 and the associated text discussing the approaches that can be taken to separately measure or estimate innate device delays from omnipath-induced delays, the notion of overall group average delay and the deviations about that overall group average delay of any given node about the group average was outlined in the related disclosures, where it was shown that a rank-ordering of probable delays can be performed. This rank ordering of delays is abstractly represented in FIG. 47, label 810, using only a half-circle of fixed nodes for graphic clarity purposes; depicted is a notional additional delay beyond the light-time delay, effectively representing the unknown but rankable amounts of delays in a given measurement (rankable via the average of the overall group). Here it is seen that nodes A through D have been estimated to be “the shorter” of all delays, and then to the right of the first group, these four chosen are individually displayed 812.

The figure above the 812 sub-group is further refined, wherein some unknown global delay parameter can be gradually subtracted (or ignored, with subsequent minor residual error consequences) until one of the two arc-intersection points is found representing a very classic two-point lateration of a solution point in two dimensional space. The nodes C and D can then provide possible adjudication on choosing among two points, or can be input into a weighted least-bound clumping routine, where the minimal delay choosing operation has simply pre-filtered highly probably nodes with clearly higher omnipath-induced delay values.

Omnipath/Multipath Identification in Explicitly Noisier Networks

Much of the previous disclosure concentrates on core principles where the notoriously noisy conditions of many commercial systems are implicitly treated as Gaussian processes affecting end solutions in standard-art manners. The following sections and its two figures attempt to be more explicit in their operations within rather noisy situations, at the same time presenting further variants on the identification and subsequent mitigation of omnipath distortions.

Multipath Link Detection

After clock and device delay parameters have been established, a residual error term for the ranging estimate between the mobile node(s) and all other nodes it is in communication with can be computed. Typically there are two ranging estimates per communication link, one for each of the two duplex paths. The ranging estimate takes into account all previously estimated parameters including: distance between the nodes, clock rate differences between the nodes, and path delay.

Each group of measurements for the residual error contains N terms, where both clock parameters and mobile position are presumed quasi-stationary. If there is an abrupt change from LOS to a multi-path obscured path, we might expect a corresponding increase in residual error. Owing to the very high noise environment with respect to measuring position, the increase in residual error would only be observed on average.

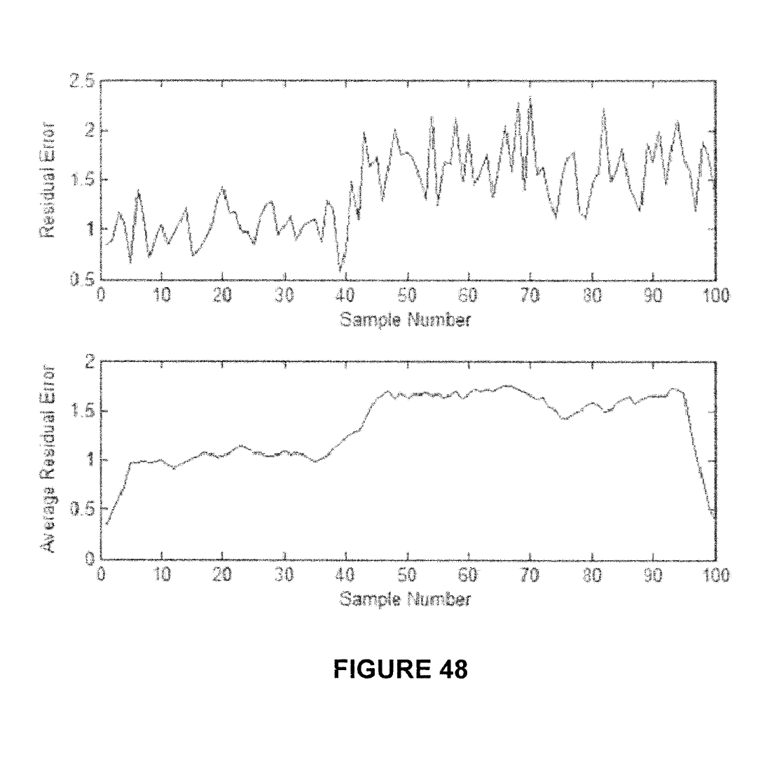

FIG. 48 illustrates an upper subplot that shows raw residual error by sample number (squared error). The bottom subplot in FIG. 48 is a moving average of the same.

The upper subplot in FIG. 48 depicts an example scenario where during the course of the previous N=100 measurements multipath has set in at around the 40^{th} measurement. Taking a moving average of the residual error highlights the transition point (lower subplot).

The other nodes that are in communication with the fixed node would show a much more gradual increase in residual error. The error increases because in general the mobile node is expected to move from its previous position. The contrast provides a means for detecting a link with multipath.

A second method for assessing whether a multipath link is present is the leaving-one-out approach. In this method, one would solve for the new position of the mobile M separate times, where for each solution a different one of the M nodes the mobile node is in communication with is left out. If there is multipath present on one of the links, the solution may bounce around to accommodate the link with multipath whenever it is included in the calculation. Moreover, when the multipath link is left out of the calculation the solution should be consistent with previous solutions. Alternatively, it may be desirable to use a small group version of this method. In this case small subgroups of the M nodes are used to determine position in the usual fashion. Any subgroup containing the node with multipath should exhibit a bias in the solution.

A third way to determine whether multi-path is present and to measure its delay is to include explicit delay terms for it in the matrix equation. However, it is advisable to do this in a way that does not increase the relative number of unknowns. By way of repetition: over the course of multiple harmonic blocks clock solutions are calculated and mobile position is estimated. Treating these parameters as knowns and generating a new system of equations that singles out the unknown multipath delay(s) leads to an overdetermined system of equations. Focusing only on links with the mobile over the course of N harmonic blocks of data, there are 2N equations and one unknown per duplex link. In an example scenario where exactly one duplex link has multipath, solving for the unknowns in this manner should lead to exactly one parameter of appreciable size.

Multipath Link Estimation

Upon determination that one of the links contains multipath, the first step is to estimate its associated delay. In a first multipath example, this is done by leaving the multipath link out of the emplacement calculation to measure the mobile's new position, pₖ, and reconstructing the residual error for the multipath afflicted link, excluding the estimate of mobile position in the calculation. The residual is an estimate of the path delay, which includes transmission of a ping from the fixed node, reflection of the ping off a strong reflector, and reception of the ping at the mobile node's antenna. Assuming duplex communication, the same is true of the reverse link. This step can be refined by only using data from after the transition region labeled in FIG. 48. Data prior to this point in time does not have a multipath delay.

The type of multipath present on the link should fit into one of the following three categories: (a) LOS path with contribution from one or more strong reflectors. Delay would be dependent upon reflected signal phase, etc. This might vary significantly as the position of the mobile changes. If highly variable the MP simply becomes part of the system noise that is best dealt with via averaging or outright rejection. If not highly variable, then it is advisable to model and remove the delay in the residual calculation. (b) Blocked LOS with a single strong reflector. (c) Blocked LOS with multiple reflections.

In a second multipath example, may be estimated by focusing on case b and assuming that there are M fixed nodes and one mobile node. Only one of the M nodes has blocked LOS with the mobile node. As in the first multipath example, the second multipath example includes leaving the multipath link out of the emplacement calculation to measure the mobile's new position, pₖ, and reconstructing the residual error for the multipath afflicted link, excluding the estimate of mobile position in the calculation. These steps are performed over one or more blocks to obtain consecutive estimates of mobile position and path delay.

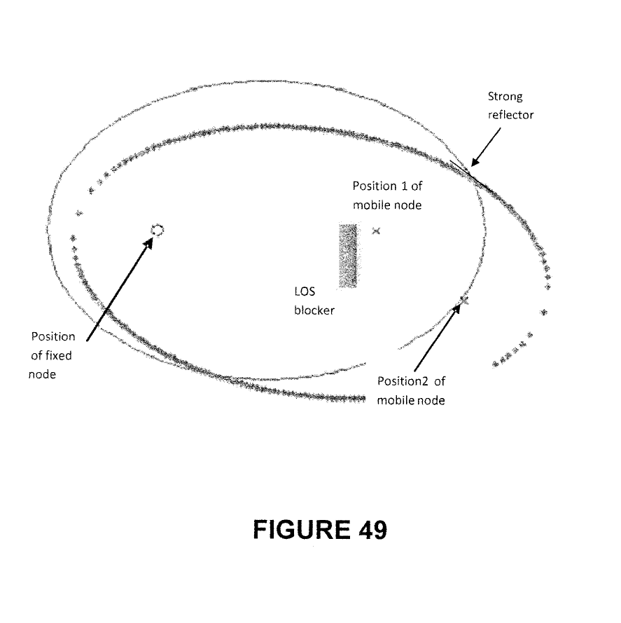

The second multipath example also includes creating an ellipse of possible strong reflection locations for the just estimated total path delay, during which the mobile moves from point A to point B. This step is repeated for another discrete solution time to create another ellipse. Then, an intersection point of the ellipses is used as an estimate of the location of the strong reflector. Using this location, the method includes calculating the distance from the strong reflector to the fixed node afflicted by multipath, d_{f}. FIG. 49 illustrates an example of this for two consecutive mobile position estimates.

The second multipath example further includes re-introducing the offending node to the emplacement calculation, and modifying the solution for mobile position to use the bounce-path for the multipath node rather than the line-of-site path. A ping that is transmitted from the fixed node is received by the mobile node (rx−tx) seconds later, which is modeled as the total path delay plus instrument delay. Given a series of measurements, (rx−tx)ₖ over a block of time, k, construct an estimate of the distance from the mobile to the strong reflector at solution time k.

d_{k,fwd}=avg(rx−tx)ₖ−delᵢₙₛₜᵣ−d^{f}+N, (32)

where delᵢₙₛₜᵣ is the instrument delay, N represents a generic system noise term, and the subscript “fwd” denotes that this is the forward path. There is a corresponding expression for the case where the mobile node is the transmitter and the fixed node the receiver. In this case the subscript on the distance term would be “rev.”

Dropping the subscript for solution time k, the method includes finding a unique mobile position that minimizes sum(2*d(mobilepos,m)−d_{m,fwd}−d_{m,rev})ₘ over all M non-mobile nodes in the system, where d(mobilepos,m) is the distance from the candidate mobile position to node m. For the case of the multipath afflicted node, d_{m,f} and d_{m,r} have the form shown in equation 32. For all other cases, the form is the same except that the d_{f} term is set to zero. The procedure for minimization can be done in a variety of ways, one example of which is gradient descent. The reader is referred to the related disclosure for details.

In FIG. 49, the line-of-sight (LOS) is blocked between a fixed node, “o,” and a mobile node “x.” Presence of a strong reflector allows communications to take place. Given estimates of the path delay, construct ellipses of possible locations of the strong reflector over consecutive mobile positions.

Implementation Example of Topographic Oozing

The following example uses the term “topographic oozing” to describe fluid, layered redundant group association dynamics. The very word “topographic” could be either replaced or supplemented with the similar term “topologic,” in that generic network nodes often use this latter term to describe specific configurations of active node linqs, very often ignoring the “geometric” aspects of those linqs.

Example implementations of topographic oozing are provided to illustrate further details on how the principles disclosed herein can be applied on current technology RF devices. As Dedicated Short-Range Communications (DSRC) devices may be much harder to come by (at least for the engineering details desired) than 802.11 “WiFi” devices, 802.11 devices are temporarily described for the example implementations, trying in the process to show how DSRC devices can be built to do the same operations. The example switches the baseline usage example from an urban core to the interior of a retail shopping store having similar challenges of mobile devices randomly moving through a large array of fixed nodes. Here to, it is shown how the same basic implementation details can readily apply to urban traffic cores as well as suburban roadways and intersections.

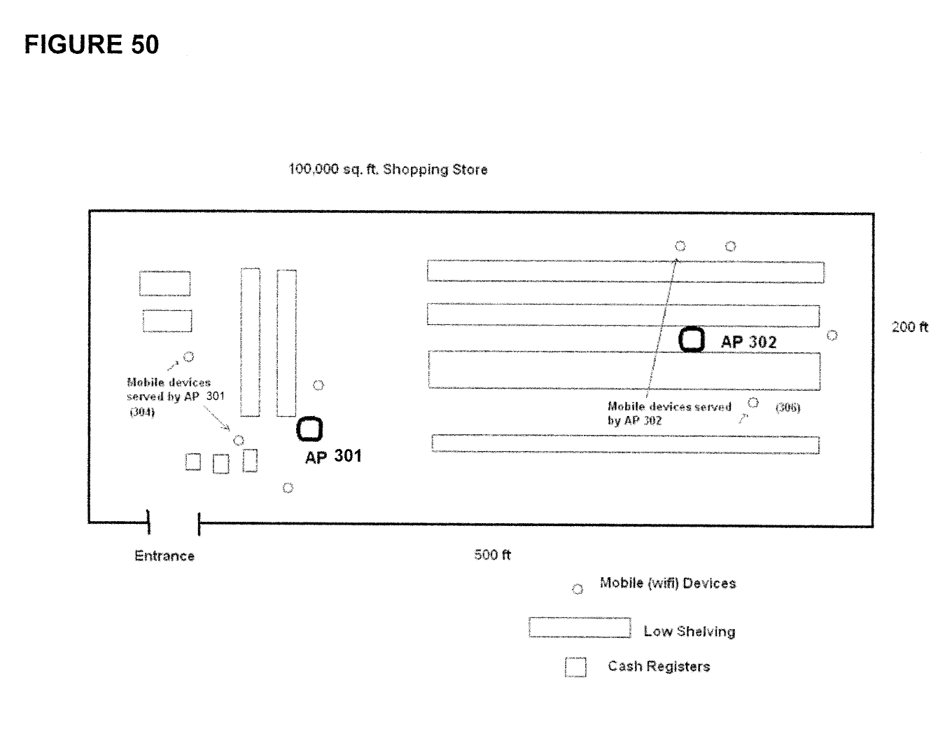

FIG. 50 is a schematic diagram illustrating an example embodiment within a medium sized shopping store. In this example, the shopping store is about 100,000 square feet, or 500 feet by 200 feet in its two dimensions. The store has two 802.11 access points (APs) labeled 301 and 302 in FIG. 50. The APs 301, 302 presumably service, e.g., store personnel as well as customers in any and all of their WiFi service needs. Many stores of this size would typically have more than two APs. But, for the simplicity of describing how topographic oozing can be implemented, this disclosure will keep it to just two APs. The AP 301 may generally service users (e.g., the user's WiFi or mobile devices 304) near the front of the store, and the AP 302 may service users (e.g., mobile devices 306) wandering toward the back of the store. This example adds a “complication” that these two APs 301, 302 service their associated devices 304, 306 using different WiFi channels. For example, AP 301 uses channel “3” and AP 302 uses channel “7”. This servicing of different devices by different channels is common in WiFi implementations and it is included in this example to show that topographic oozing can also easily function in this multi-channel setting as well.

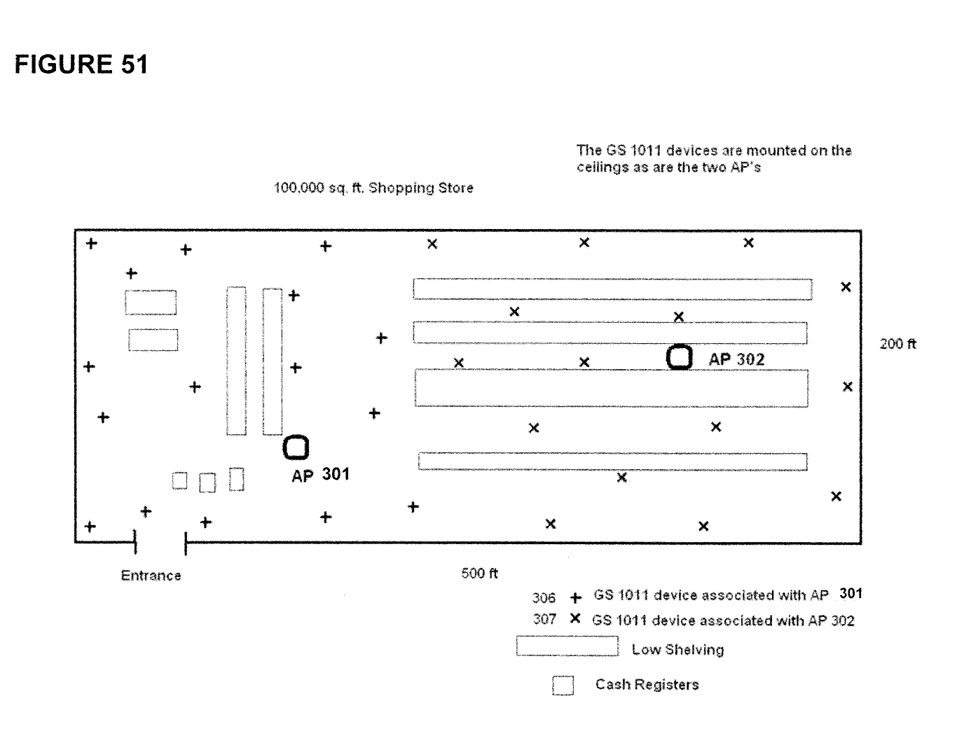

FIG. 51 is a schematic diagram illustrating effectively the same store layout as that shown in FIG. 50, but with a total of 30 additional WiFi devices, collectively labeled 306 (illustrated by “+” symbols) and 307 (illustrated by “x” symbols) (the two separate numbers explained below), strewn throughout the store. In this example, the new 802.11 devices 306, 307 are attached to the ceiling and are powered either by Ethernet drops or by 5 volt power lines. The company Gainspan makes a typical low cost device called the GS 1011, which may be used in certain embodiments. A property of these devices is that they have two processing units, one largely dedicated to WiFi communications and the other being a general purpose ARM processor capable of performing the steps described below.

Each installed GS 1011 is within range of at least one of the APs 301, 302. (Here again, normally there may be more than two APs, but this implementation example uses just two APs for explication purposes; if “range” becomes an issue for a particular application, then the number of APs may be increased, e.g., to three or four or many more for very large stores.)

Before describing how a given mobile device, and eventually many mobile devices, can communicate with the depicted devices of FIG. 51, subsequently having their position solutions continuously tracked (through the topographic ooze), it is instructive to first describe how the 30 GS 1011 devices associate and communicate with the APs 301, 302.

Presumably, an information technology (IT) professional has installed the two APs 301, 302 as is typical for APs servicing a given area intended for many client WiFi devices. This example assumes that these two APs have been so installed and they operate according to very normal AP standards and methods.

Similarly, an IT professional or a trained installation technician may mount the 30 GS 1011's and ensure that they are properly powered and “booted up”. They do not necessarily need to be on the ceiling, though this is useful in certain embodiments. Two additional operations take place on each of the GS 1011 devices during this physical mounting and powering step. Once powered, the GS 1011 devices are instructed to act like a normal WiFi client, contacting and communicating with and through one or both APs 301, 302. The other step is that the individual doing the physical installation, or some assistant thereto, logs the actual location of where he/she has installed the given individual device, e.g., relative to a store map. The manner of this logging has many variants, with one method being logging in with a smartphone application indicating the ID number of the GS 1011 device, its IP address, and its store location, usually indicated in aisle numbers and post numbers. Later on, an additional program transfers the logged locations into physical coordinates relative to the 500 by 200 foot dimensions of the physical store, usually including the height of the GS 1011 (above the floor) as well. The accuracy goals of the entire system may require that one should log the locations to slightly better than the position accuracy desired for device tracking, where this is currently roughly a meter or so.

As each GS 1011 device powers up and communicates with an AP, it can perform a variety of provisioning tasks. One task includes contacting some “installation” or set-up IP address in order to fetch further instructions, if any. Or, it may just query a “Zulutime Web Service” and announce it is a new participant. All 30 GS 1011 devices are thus installed, powered up and tested, where any faulty devices (usually none) are immediately flagged and replaced. It is recommended, but not required, that each GS 1011 node chooses one of the other of the APs to be its primary association AP and to choose the channel of that AP as the primary channel that it “listens to” for other WiFi traffic, as will be described further below.

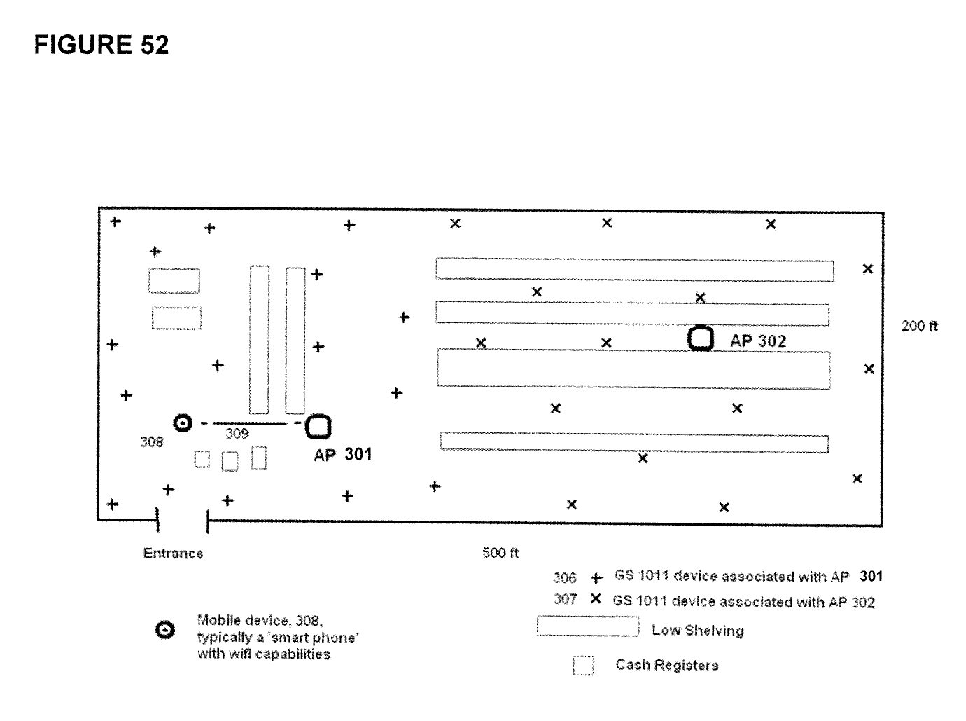

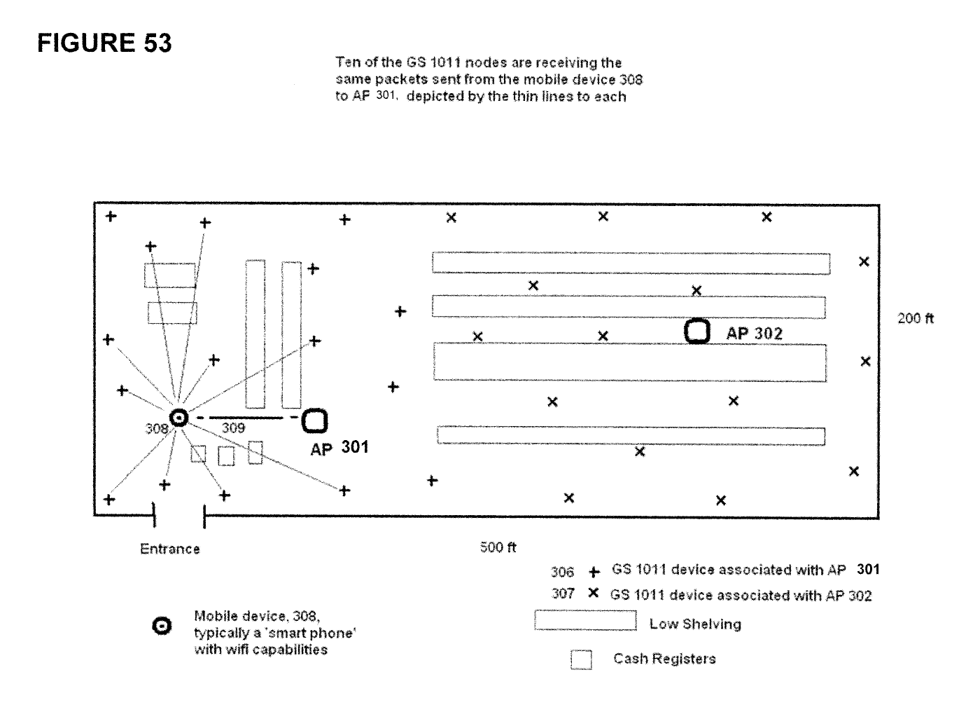

A function of the GS 1011 devices is to listen for transmitted WiFi packets from any and all random mobile WiFi devices that establish a WiFi session with the primary AP that it (the GS 1011 device) is associated with. For example, FIG. 52 is a schematic diagram illustrating the shopping store of FIG. 51 with a newly introduced mobile WiFi device 308 somewhere near the entrance of the store. This device 308 establishes its own “normal” duplex packet communication session with the AP 301, represented by the thick line 309 between the device 308 and the AP 301. In doing this normal operation, most if not all of the other GS 1011 devices associated with AP 301 also “hear” or receive the packets coming from the mobile device 308. FIG. 53 is a schematic diagram illustrating a packet transmitted from newly introduced mobile WiFi device 308 shown in FIG. 52 according to one embodiment. FIG. 53 isolates the situation further, showing the hypothetical transmitted packet from mobile device 308 being received by ten GS 1011 devices and also the AP 301. Note that there are more than ten GS 1011 devices associated with AP 301 but not all of them heard the transmitted packet depicted.

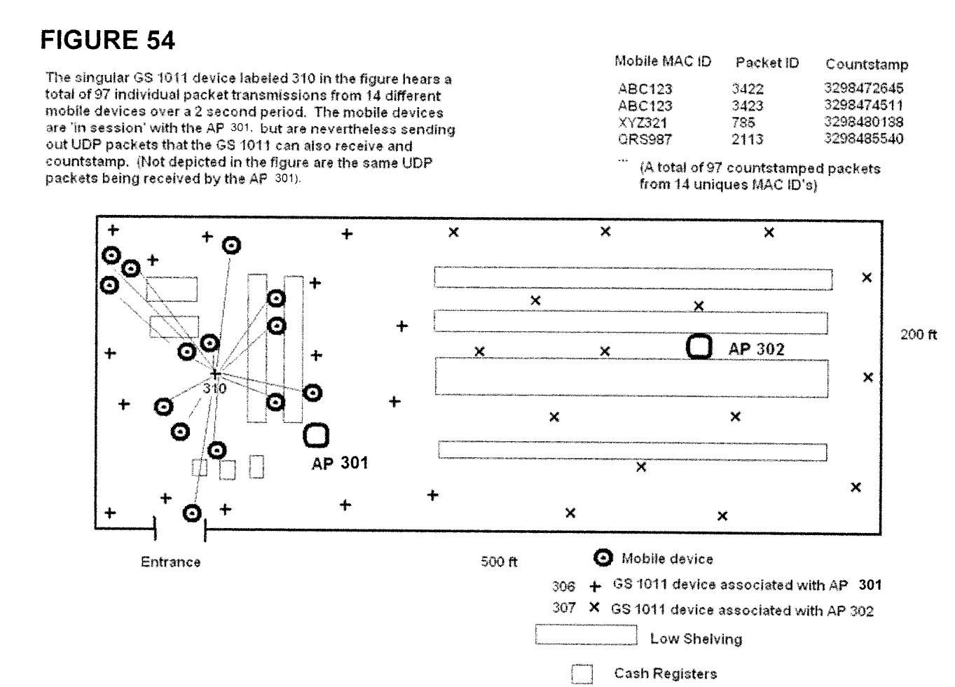

FIG. 54 is a schematic diagram illustrating a more typical but more complicated situation, according to certain embodiments, where there are now dozens of mobile devices in the store all transmitting packets every now and then. Some mobile devices are smartphones of customers, others might be I-Pads® used by store personnel. Depicted in FIG. 54 is the isolated GS 1011 node labeled 310, where it happens to have received and countstamped a total of 97 packets from 14 different mobile devices over a 2 second period. FIG. 54 calls out user datagram protocol (UDP) packets in particular, a popular choice for generic WiFi communications, but it need not be only such packets. The node 310 records all of these events as depicted in the associated numeric spreadsheet in FIG. 54 and puts these (or compressed) values directly into a “pung packet” that is transmitted to the IP address given to the node during set-up. If the node is on an Ethernet connection, it will use this channel to ship the pung data. If it is a stand-alone wireless node, it will utilize its association with one of the two APs to gain quick access to the WiFi channel and send the pung data.

The pung packets from the GS 1011 nodes are thus sending their data to some specified IP address (in this example referred to as a Zulutime Web Service), where data processing of the type explained in other sections of this disclosure track clock drifts between the various GS 1011 nodes, remove such drifts from the countstamp data, compute multipath-distorted pseudo-range values, and thereafter calculate optimal positions for the mobile devices using multipath mitigation methods describe in the related disclosures. Even without using multipath mitigation methods, standard techniques exist to compute positions based on, typically, three or more pseudo-ranges. There may be larger relatively larger error bars on the calculated positions in the case where multipath is ignored.

This is the point where this disclosure can more explicitly turn back to the detailed implementation of topographic ooze.

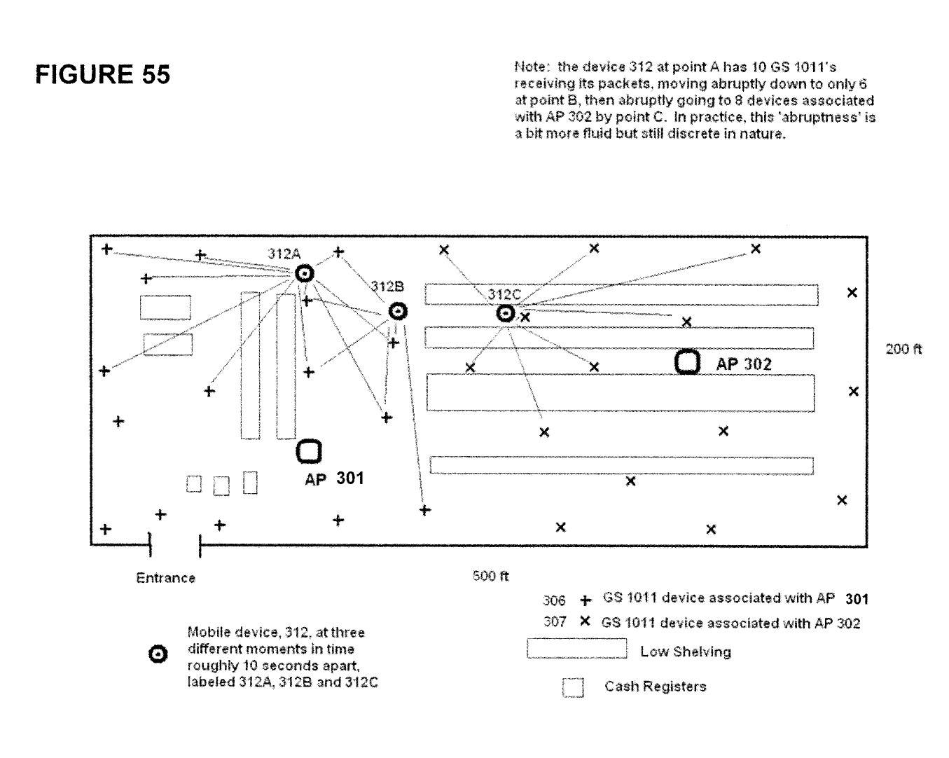

FIG. 55 is a schematic diagram illustrating three instances in time of a single mobile device 312 (shown at different points in time as 312A, 312B, and 312C) as it moves among different areas of the store according to one embodiment. As shown in FIG. 55, the mobile device 312 is labeled 312A at a first location where it is associated with AP 301. The mobile device 312 then moves to an area of the store where it is labeled 312C and where it has re-associated with AP 302; the interim state immediately prior to AP switching is depicted as 312B. The position solutions smoothly track not only as different GS 1011 devices variously receive packets from this mobile device 312, but also how those solutions bridge the gap as the mobile device switches from AP 301 to AP 302.

In this example, it is assumed that a person with a mobile smartphone is walking along at about 5 feet per second, then the person takes approximately 20 seconds to walk about 100 feet between location of 312A and the location of 312C. To keep things simple, this example assumes that only the three “linq states” exist during this 20 second period. The first linq state is graphically indicated by 312A where again 10 GS 1011 nodes receive packets from mobile device 312 over six seconds. The second linq state is indicated by 312B where 6 GS 1011 nodes, still associated with AP 301, receive packets over the next seven seconds from mobile device 312. Then, over a very short period, e.g., one quarter of one second, the mobile device 312 re-associates with AP 302 and the third linq state is indicated by 312C where a total of 8 GS 1011 devices (devices that are associated with AP 302), receive and countstamp packets from mobile device 312 over the remaining 6 seconds of our original 20 second stretch.

The details of the topographic ooze take place at the Zulutime Web Service (ZWS) and the individual GS1011 nodes in the store need not concern themselves with anything other than dutifully transmitting the node and packet IDs of the packets they hear along with the countstamp of when they heard each packet.

The ZWS, on the other hand, is continuously monitoring for exactly how many GS1011 devices are “hearing” any given active mobile node. While the number of linqs grows and shrinks on a second by second basis, clock solutions and position solutions can nevertheless be smoothly tracked and determined. Thus, when the linq state moves from 312A to 312B, several of the listening nodes remain the same and these solution techniques may be used in the transition from 312A to 312B. At the juncture where the mobile device 312 re-associates with AP 302, however, a near-split-second switch now occurs between one set of GS 1011 devices on one channel (that of AP 301) and another set on another channel (that of AP 302).

In this instance, the ZWS had been previously aware of the different channels employed by the various GS 1011 nodes during their set-up and registration process. The ZWS is expecting such abrupt changes to occur in terms of which GS 1011 devices are listening to which mobile devices. In this case, the ID (typically MAC address in the WiFi case) of the same mobile device 312 becomes the continuity factor in stitching the previous positional solutions of 312A and 312B with the newly calculated positional solutions of 312C. In practice, there may be an annoying gap of two or three seconds whereby the solution set of 312C is trying to accumulate sufficient pung data to form a solution, but even here classic Kalman filtering techniques familiar to GPS receiver designers can help bridge the smoothness-and-accuracy-of-solution gap.

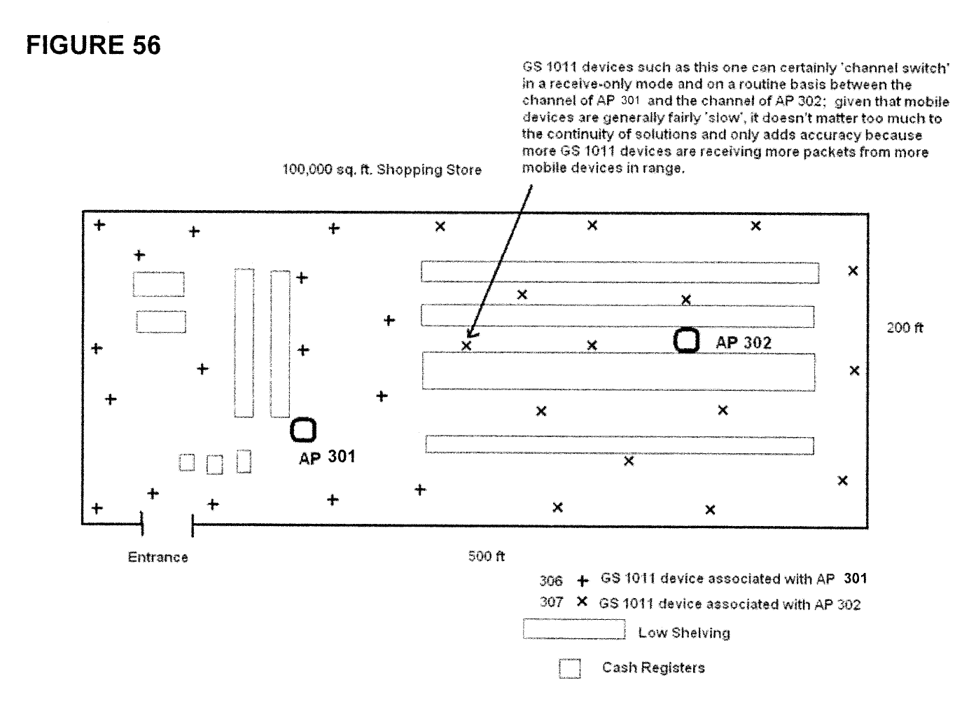

FIG. 56 is a schematic diagram illustrating an advanced variant, according to one embodiment, on the baseline description for the examples shown in FIGS. 50, 51, 52, 53, 54, and 55. FIG. 56 depicts the routine “channel hopping” that GS 1011 devices can perform, especially those devices lying in the middle zone between AP 301 and AP 302. The idea is rather simple: Hop back and forth in “receive only” mode between the channel of AP 301 and the channel of AP 302, and still accumulate the IDs and countstamps of all the packets you hear. The nodes package the data up into pung packets just as before, and are free to use whatever is the most convenient channel to transmit their pung packets to a selected IP address. Since mobile devices are generally relatively slow in terms of moving through “zones of coverage,” the continuity of positional solutions usually is greatly enhanced by this channel switching rather than harmed.

Another advanced variant on the descriptions of FIGS. 50, 51, 52, 53, 54, 55, and 56 is where the GS 1011 devices “go out of their way” to not only countstamp their own outgoing WiFi packets (countstamped tx events), but to send out such packets on a regular basis, e.g., two to three short packets every three to five seconds. In this approach, the GS 1011 packets are themselves putting out “calibrated WiFi traffic” (through their own countstamping of the outgoing packets) such that other GS 1011 devices can also receive these types of packets. The related disclosures go to lengths to describe the additional benefits of countstamping outgoing packets as well as only incoming packets (from the mobile devices). The additional transmit-countstamp values are of course loaded up into standard pung packets for transmission back to a chosen IP address, often the ZWS.

### CONCLUSION

As stated in the introductory material of this disclosure, omnipath distortions are generally not something amenable to being “solved”, per se, but are eminently capable of being sleuthed, exploited and ultimately mitigated inside all but the most horrifically complicated EM environments. This disclosure has outlined a wide variety of approaches to mitigating these effects, where in this conclusion we also reiterate the concept of the cocktail glass, itself, and the various cocktails that can go into that cocktail glass: The glass itself remains the very framework of communicating and cooperating nodes, sharing information and enabling the capability of sharing one singular “Zulutime,” thereby eliminating timing as an issue in the omnipath problem, at least to some acceptable error floor criteria. Having removed timing from the problem, a wide variety of specific cocktail ingredients show up on the bartender's shelf, where elements in isolation or many elements in combination can be utilized in order to mitigate omnipath-induced distortions, mixed in ways that adapt to the given application and the given environment within which nodes find themselves.

It will be understood to those having skill in the art that many changes may be made to the details of the above-described embodiments without departing from the underlying principles of the invention. The scope of the present invention should, therefore, be determined only by the following claims.

1. A method of determining a location of a mobile device in a network, the network including a plurality of fixed nodes, the method comprising:
receiving, at the plurality of fixed nodes, receive messages transmitted from the mobile communication device, wherein each of the plurality of fixed nodes generates a receive count stamp for each receive message corresponding to a local counter value at the receipt of the receive message;
at each of the plurality of fixed nodes, processing the receive count stamps to calculate a set of pseudo-ranges between the respective fixed node and the mobile device;
measuring multipath delay included within the set of pseudo-ranges;
based on the measurement, removing the multipath delay from the set of pseudo-ranges to determine a range estimate between the mobile device and each of the fixed nodes; and
based on the range estimates, calculating a location of the mobile device.

2. The method of claim 1, further comprising sending and receiving messages between the plurality of fixed nodes, wherein each of the fixed nodes generates local receive count stamps based on the messages received from the other fixed nodes.

3. A method for multipath mitigation and evaluation within a network comprising a plurality of nodes, the method comprising:
receiving, at a plurality of first nodes, receive messages transmitted from a second node, wherein each of the plurality of first nodes generates a receive count stamp for each receive message corresponding to a local counter value at the receipt of the receive message; and
processing the receive count stamps to determine range errors in at least one of an x-axis direction, a y-axis direction, and a z-axis direction with respect to a distance between at least one of the first nodes and the second node.
